(19) United States
(12) Patent Application Publication
(10) Pub. No.: US 2016/0154673 A1
(43) Pub. Date: Jun. 2, 2016

(54) METHODS, SYSTEMS, AND COMPUTER PROGRAM PRODUCTS FOR PROVIDING A MINIMALLY COMPLETE OPERATING ENVIRONMENT

(71) Applicant: SITTING MAN, LLC, Raleigh, NC (US)

(72) Inventor: Robert Paul Morris, Raleigh, NC (US)

(73) Assignee: SITTING MAN, LLC, Raleigh, NC (US)

(21) Appl. No.: 14/807,831

(22) Filed: Jul. 23, 2015

Related U.S. Application Data
(60) Provisional application No. 62/027,897, filed on Jul. 23, 2014.
(60) Provisional application No. 62/065,601, filed on Oct. 17, 2014.
(60) Provisional application No. 62/088,693, filed on Dec. 8, 2014.
(60) Provisional application No. 62/092,483, filed on Dec. 16, 2014.
(60) Provisional application No. 62/097,580, filed on Dec. 29, 2014.
(60) Provisional application No. 62/107,300, filed on Jan. 23, 2015.
(60) Provisional application No. 62/180,602, filed on Jun. 16, 2015.

(51) Int. Cl. G06F 9/46

(52) U.S. Cl. CPC G06F 9/46

(57) ABSTRACT

A system, method, and computer program product are provided. In operation, a first representation of first source code written in a first programming language is identified. Additionally, at least one of a first measure of cost for performing at least one instruction specified in the first source code by a first operating environment and a second measure of cost for performing the at least one instruction by a second operating environment is determined. Further, based on at least one of the first measure and the second measure, one of the first operating environment and the second operating environment to perform the at least one instruction is selected.

### RELATED APPLICATIONS

This application claims priority to U.S. Provisional Application No. 62/027,897, filed Jul. 23, 2014, titled “METHODS, SYSTEMS, AND COMPUTER PROGRAM PRODUCTS FOR PROVIDING A MINIMALLY COMPLETE OPERATING ENVIRONMENT,” U.S. Provisional Application No. 62/065,601, filed Oct. 17, 2014, titled “METHODS, SYSTEMS, AND COMPUTER PROGRAM PRODUCTS FOR INTEGRATED WEB BROWSING,” U.S. Provisional Application No. 62/088,693, filed Dec. 8, 2014, titled “METHODS, SYSTEMS, AND COMPUTER PROGRAM PRODUCTS FOR REPORTING INPUT EVENTS FOR OUTPUT BASED ON A MARKUP ELEMENT,” U.S. Provisional Application No. 62/092,483, filed Dec. 16, 2014, titled “METHODS, SYSTEMS, AND COMPUTER PROGRAM PRODUCTS FOR ACCESSING DATA, OPERATIONS, AND/OR SERVICES RELATED TO AN OUTPUT,” U.S. Provisional Application No. 62/097,580, filed Dec. 29, 2014, titled “METHODS, SYSTEMS, AND COMPUTER PROGRAM PRODUCTS FOR INTEGRATING PROCESSING OF DATA EXCHANGED VIA A NETWORK,” U.S. Provisional Application No. 62/107,300, filed Jan. 23, 2015, titled “METHODS, SYSTEMS, AND COMPUTER PROGRAM PRODUCTS FOR INTEGRATING USER INTERFACES,” and U.S. Provisional Application No. 62/180,602, filed Jun. 16, 2015, titled “METHODS, SYSTEMS, AND COMPUTER PROGRAM PRODUCTS FOR MANAGING MEMORY ACCORDING TO MULTIPLE ACCESS MODELS,” all of which are herein incorporated by reference.

### BRIEF DESCRIPTION OF THE DRAWINGS

Objects and advantages of the present invention will become apparent to those skilled in the art upon reading this description in conjunction with the accompanying drawings, and in which:

FIG. 1 is a block diagram illustrating an exemplary hardware device included in and/or otherwise providing an operating environment in which the subject matter may be implemented;

FIG. 2A is a block diagram illustrating an operating environment that may include logic for performing one or more of the methods described in the present disclosure;

FIG. 2B is a block diagram illustrating an operating environment that may include logic for performing one or more of the methods described in the present disclosure;

FIG. 2C is a block diagram illustrating an operating environment that may include logic for performing one or more of the methods described in the present disclosure;

FIG. 2D is a block diagram illustrating an operating environment that may include logic for performing one or more of the methods described in the present disclosure;

FIG. 3 is a block diagram illustrating an arrangement of components that may include logic for performing one or more of the methods described in the present disclosure;

FIG. 4 is a block diagram illustrating an arrangement of components that may include logic for performing one or more of the methods described in the present disclosure;

FIG. 5 is a network diagram illustrating an exemplary system according to another aspect of the subject matter described in the present disclosure;

FIG. 6 is a network diagram illustrating an exemplary system according to another aspect of the subject matter described in the present disclosure;

FIG. 7 is a network diagram illustrating an exemplary system according to another aspect of the subject matter described in the present disclosure;

FIG. 8 is a network diagram illustrating an exemplary system according to another aspect of the subject matter described in the present disclosure;

FIG. 9 is a diagram illustrating a method according to another aspect of the subject matter described in the present disclosure;

FIG. 10 is a block diagram illustrating logic that may be executed in an operating environment in performing one or more of the methods described in the present disclosure;

FIG. 11 is a block diagram illustrating an operating environment that may include logic for performing one or more of the methods described in the present disclosure;

FIG. 12 is a diagram illustrating a method according to another aspect of the subject matter described in the present disclosure;

FIG. 13 is a diagram illustrating a method according to another aspect of the subject matter described in the present disclosure;

FIG. 14 is a diagram illustrating a method according to another aspect of the subject matter described in the present disclosure;

FIG. 15 illustrates source code according to another aspect of the subject matter described in the present disclosure;

FIG. 16 illustrates exemplary metadata for a particular address entity specified in source code written in a programming language.

FIG. 17 is a diagram illustrating a method according to another aspect of the subject matter described in the present disclosure;

FIG. 18 is a block diagram illustrating logic that may be executed in an operating environment in performing one or more of the methods described in the present disclosure;

FIG. 19 is a block diagram illustrating an operating environment that may include logic for performing one or more of the methods described in the present disclosure;

FIG. 20 illustrates source code according to another aspect of the subject matter described in the present disclosure;

FIG. 21 is a diagram illustrating a method according to another aspect of the subject matter described in the present disclosure;

FIG. 22 illustrates metadata for source code according to another aspect of the subject matter described in the present disclosure;

FIG. 23 is a diagram illustrating a method according to another aspect of the subject matter described in the present disclosure;

FIG. 24 is a block diagram illustrating logic that may be executed in an operating environment in performing one or more of the methods described in the present disclosure;

FIG. 25 is a block diagram illustrating an operating environment that may include logic for performing one or more of the methods described in the present disclosure;

FIG. 26 is a diagram illustrating a method according to another aspect of the subject matter described in the present disclosure;

FIG. 27 illustrates source code according to another aspect of the subject matter described in the present disclosure;

FIG. 28 is a diagram illustrating a method according to another aspect of the subject matter described in the present disclosure;

FIG. 29 is a block diagram illustrating logic that may be executed in an operating environment in performing one or more of the methods described in the present disclosure;

FIG. 30 is a block diagram illustrating an operating environment that may include logic for performing one or more of the methods described in the present disclosure;

FIG. 31 is a diagram illustrating a method according to another aspect of the subject matter described in the present disclosure;

FIG. 32 illustrates source code according to another aspect of the subject matter described in the present disclosure;

FIG. 33 illustrates metadata for source code according to another aspect of the subject matter described in the present disclosure;

FIG. 34 is a diagram illustrating a method according to another aspect of the subject matter described in the present disclosure;

FIG. 35 is a block diagram illustrating logic that may be executed in an operating environment in performing one or more of the methods described in the present disclosure;

FIG. 36 is a block diagram illustrating an operating environment that may include logic for performing one or more of the methods described in the present disclosure;

FIG. 37 is a diagram illustrating a method according to another aspect of the subject matter described in the present disclosure;

FIG. 38 illustrates an OER profile for an application according to an aspect of the subject matter described in the present disclosure.

FIG. 39 illustrates an OER profile for an operating environment according to an aspect of the subject matter described in the present disclosure.

FIG. 40 is a diagram illustrating a method according to another aspect of the subject matter described in the present disclosure;

FIG. 41 is a block diagram illustrating logic that may be executed in an operating environment in performing one or more of the methods described in the present disclosure;

FIG. 42 is a block diagram illustrating an operating environment that may include logic for performing one or more of the methods described in the present disclosure;

FIG. 43 is a diagram illustrating a method according to another aspect of the subject matter described in the present disclosure;

FIG. 44 illustrates an OER profile for an application according to an aspect of the subject matter described in the present disclosure;

FIG. 45A illustrates an OER profile for an operating environments according to an aspect of the subject matter described in the present disclosure;

FIG. 45B illustrates an OER profile for an operating environments according to an aspect of the subject matter described in the present disclosure;

FIG. 46 is a diagram illustrating a method according to another aspect of the subject matter described in the present disclosure;

FIG. 47 is a block diagram illustrating logic that may be executed in an operating environment in performing one or more of the methods described in the present disclosure;

FIG. 48 is a block diagram illustrating an operating environment that may include logic for performing one or more of the methods described in the present disclosure;

FIG. 49 is a diagram illustrating a method according to another aspect of the subject matter described in the present disclosure;

FIG. 50 is a diagram illustrating a method according to another aspect of the subject matter described in the present disclosure;

FIG. 51 is a block diagram illustrating logic that may be executed in an operating environment in performing one or more of the methods described in the present disclosure;

FIG. 52 is a block diagram illustrating an operating environment that may include logic for performing one or more of the methods described in the present disclosure;

FIG. 53 is a diagram illustrating a method according to another aspect of the subject matter described in the present disclosure;

FIG. 54 is a diagram illustrating a method according to another aspect of the subject matter described in the present disclosure;

FIG. 55 is a diagram illustrating a method according to another aspect of the subject matter described in the present disclosure;

FIG. 56 is a block diagram illustrating logic that may be executed in an operating environment in performing one or more of the methods described in the present disclosure;

FIG. 57 is a block diagram illustrating an operating environment that may include logic for performing one or more of the methods described in the present disclosure;

FIG. 58 is a diagram illustrating a method according to another aspect of the subject matter described in the present disclosure;

FIG. 59 illustrates an OER profile for an application according to an aspect of the subject matter described in the present disclosure;

FIG. 60A illustrates an OER profile for an operating environments according to an aspect of the subject matter described in the present disclosure;

FIG. 60B illustrates an OER profile for an operating environments according to an aspect of the subject matter described in the present disclosure;

FIG. 61 is a diagram illustrating a method according to another aspect of the subject matter described in the present disclosure;

FIG. 62 is a block diagram illustrating logic that may be executed in an operating environment in performing one or more of the methods described in the present disclosure;

FIG. 63 is a block diagram illustrating an operating environment that may include logic for performing one or more of the methods described in the present disclosure;

FIG. 64 illustrates exemplary source code according to the subject matter described in the present disclosure;

FIG. 65 illustrates exemplary source code according to the subject matter described in the present disclosure;

FIG. 66 illustrates exemplary source code according to the subject matter described in the present disclosure;

FIG. 67 is a diagram illustrating a method according to another aspect of the subject matter described in the present disclosure;

FIG. 68 is a block diagram illustrating an operating environment that may include logic for performing one or more of the methods described in the present disclosure;

FIG. 69 is a diagram illustrating a method according to another aspect of the subject matter described in the present disclosure;

FIG. 70 is a block diagram illustrating logic that may be executed in an operating environment in performing one or more of the methods described in the present disclosure;

FIG. 71 is a block diagram illustrating an operating environment that may include logic for performing one or more of the methods described in the present disclosure;

FIG. 72 is a diagram illustrating a method according to another aspect of the subject matter described in the present disclosure;

FIG. 73 illustrates an exemplary operating environment manifest according to an aspect of the subject matter described in the present disclosure;

FIG. 74 illustrates an exemplary operating environment manifest according to an aspect of the subject matter described in the present disclosure;

FIG. 75 is a diagram illustrating a method according to another aspect of the subject matter described in the present disclosure;

FIG. 76 is a block diagram illustrating logic that may be executed in an operating environment in performing one or more of the methods described in the present disclosure;

FIG. 77 is a block diagram illustrating an operating environment that may include logic for performing one or more of the methods described in the present disclosure;

FIG. 78 is a diagram illustrating a method according to another aspect of the subject matter described in the present disclosure;

FIG. 79 illustrates an exemplary operating environment manifest according to an aspect of the subject matter described in the present disclosure;

FIG. 80 illustrates an exemplary operating environment manifest according to an aspect of the subject matter described in the present disclosure;

FIG. 81 is a diagram illustrating a method according to another aspect of the subject matter described in the present disclosure;

FIG. 82 is a block diagram illustrating logic that may be executed in an operating environment in performing one or more of the methods described in the present disclosure;

FIG. 83 is a diagram illustrating a method according to another aspect of the subject matter described in the present disclosure;

FIG. 84 is a block diagram illustrating logic that may be executed in an operating environment in performing one or more of the methods described in the present disclosure;

FIG. 85 is a diagram illustrating a method according to another aspect of the subject matter described in the present disclosure;

FIG. 86 is a diagram illustrating a method according to another aspect of the subject matter described in the present disclosure;

FIG. 87 is a block diagram illustrating logic that may be executed in an operating environment in performing one or more of the methods described in the present disclosure;

FIG. 88 is a diagram illustrating a method according to another aspect of the subject matter described in the present disclosure; and

FIG. 89 is a block diagram illustrating logic that may be executed in an operating environment in performing one or more of the methods described in the present disclosure.

### DETAILED DESCRIPTION

One or more aspects of the present disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the present disclosure. It may be evident, however, to one skilled in the art, that one or more aspects of the present disclosure may be practiced with a lesser degree of these specific details. In other instances, well-known structures and devices are shown in block diagram form in order to facilitate describing one or more aspects of the present disclosure.

The descriptions and annexed drawings set forth certain illustrative aspects and implementations of the present disclosure. These are indicative of but a few of the various ways in which one or more aspects of the present disclosure may be employed. The other aspects, advantages, and novel features of the present disclosure will become apparent from the detailed description included in the present disclosure when considered in conjunction with the annexed drawings. It is to be understood that other arrangements and/or designs may be utilized and structural and functional modifications may be made without departing from the scope of the subject matter disclosed in the present disclosure.

The subject matter of the present disclosure is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that the acts and operation described in the present disclosure may also be implemented in hardware.

To facilitate an understanding of the subject matter of the present disclosure, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description in the present disclosure of any sequence of actions is not intended to imply that the specific order described for performing that sequence must be followed.

Moreover, the methods described in the present disclosure may be embodied in instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing data that may be accessed via an instruction execution machine as executable instructions of a software component. The data may be stored in one or more forms including an electronic, magnetic, optical, and electromagnetic form, such that the instruction execution machine, system, apparatus, or device may read (or fetch) the data from the computer readable medium and execute the instructions represented to carry out the described methods. By way of example, and not limitation, computer readable media may comprise a non-transitory computer storage medium and/or a communication medium.

Non-transitory computer storage media includes volatile and nonvolatile, removable and non-removable media implemented in any method or technology for storage of information such as computer readable instructions, data structures, software components or other data. Computer storage media includes, but is not limited to, Random Access Memory (RAM), Read Only Memory (ROM); Electrically Erasable Programmable Read Only Memory (EEPROM); flash memory or other memory technology; portable computer diskette; Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by an operating environment.

Communication media typically embodies data representing computer readable instructions, data structures, software components, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Thus, the subject matter described in the present disclosure may be embodied in many different forms, and all such forms are contemplated to be within the scope of what is claimed. It will be understood that various details may be changed without departing from the scope of the claimed subject matter.

The methods described in the present disclosure are illustrated embodied in various arrangements and operating in various operating environments or portions thereof that are suitable for the respective arrangements. The architectures, operating environments, and arrangements of logic and/or components illustrated in the drawings and described in the present disclosure are not exhaustive The methods, of course, may be carried out via any suitable arrangement whether illustrated in a drawing of the present disclosure or not. Logic realized in any of the various arrangements may operate in any operating environment suitable for the respective arrangements. A realized arrangement may include and/or emulate hardware, code, and/or data. Illustrative information is provided above regarding various optional arrangements and features with which the subject matter may or may not be implemented, per the desires of the user. It should be strongly noted that such illustrative information is set forth for illustrative purposes and should not be construed as limiting in any manner. Any of the aspects identified by the illustrative information may be optionally incorporated with or without the exclusion of any other of the aspects.

With respect to all publications, patent applications, patents, and other references mentioned in the present disclosure; the present disclosure, including definitions, will control in case of conflict.

### TERMS

Unless otherwise defined, all technical and scientific terms used in the present disclosure have the same meaning as commonly understood by one of ordinary skill in the art to which the present disclosure belongs. Although methods, components, and devices similar or equivalent to those described in the present disclosure can be used in the practice or testing of the subject matter described in the present disclosure, suitable methods, components, and devices are described below.

The use of the terms “a” and “a” and “the” and similar referents in the context of describing the subject matter (particularly in the context of the following claims) are to be construed to cover both the singular and the plural, unless otherwise indicated in the present disclosure or clearly contradicted by context. The use of any and all examples, or exemplary language (e.g., “such as”) provided in the present disclosure, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The use of “including”, “comprising”, “having”, and variations thereof are meant to encompass the items listed thereafter and equivalents thereof as well as additional items and equivalents thereof. Terms used to describe interoperation and/or coupling between components are intended to include both direct and indirect interoperation and/or coupling, unless otherwise indicated. Exemplary terms used in describing interoperation and/or coupling include “mounted,” “connected,” “attached,” “coupled,” “communicatively coupled,” “operatively coupled,” “invoked”, “called”, “provided to”, “received from”, “identified to”, “interoperated” and similar terms and their variants.

As used in the present disclosure, any reference to an entity “in” an association is equivalent to describing the entity as “included in and/or identified by” the association, unless explicitly indicated otherwise.

An “operating environment”, as used in the present disclosure, is an arrangement of hardware and/or software that may be further modified, transformed, and/or otherwise configured to include and/or otherwise host an arrangement of components to perform a method of the subject matter described in the present disclosure. An operating environment includes or is provided by one or more devices that include one or more processors to execute instruction(s) included in logic in such an arrangement. At least some of the logic may be a translation of source code written in a programming language. The operating environment is said, in the present disclosure, to be the operating environment “of” the device and/or devices. A device may be a virtual device realized in in one or more actual devices.

As used in the present disclosure a “processor” is an instruction execution machine, apparatus, or device. A processor may include one or more electrical, optical, and/or mechanical components that operate in interpreting and executing logic, typically generated from code written in a programming language. Exemplary processors include one or more microprocessors, digital signal processors (DSPs), graphics processing units, application-specific integrated circuits (ASICs), optical or photonic processors, and/or field programmable gate arrays (FPGAs). A processor in an operating environment may be a virtual processor emulated by one or more hardware processors.

As used in the present disclosure the term “operating environment resource” (OER) with respect to a particular operating environment refers any entity in to the operating environment that includes data, logic, and/or hardware that is accessed, directly and/or indirectly, in executing an instruction encoded in logic in the operating environment. An OER may include a physical entity and/or logical entity. An OER may be encoded in and/or otherwise may be realized in a physical entity and/or in a virtual entity that is an emulation of a physical entity and/or an emulation of another logical entity that is encoded and/or otherwise realized directly and/or indirectly in a physical entity. For example, first logic in a first executable entity that provides a programming interface and/or is otherwise capable of communicating directly and/or indirectly with second logic in a second executable entity may be an OER with respect to the second executable entity. The first logic may have one or more OERs within a particular operating environment with respect to itself. Exemplary OERs include a processor, a memory manager, a memory model, a scheduler, a process, a thread, an executable maintained in a library, a data store, a data storage medium, particular data, user data, authorization data, authentication data, a stack, a heap, a queue, an interprocess communication mechanism (e.g. a stream, a pipe, an interrupt, etc.), a synchronization mechanism (e.g. a lock, a semaphore, an ordered list, etc.), an output device, an input device, a networking device, a device driver, a network protocol, a link and/or reference, a linker, a loader, a compiler, an interpreter, a sensor, an address space, an addressable space, an invocation mechanism, a memory mapper, a security model and/or a security manager, a GPS client and/or server, a web server, a browser, a container (such as a LINUX container), a virtual machine, a framework (such as a MESOS framework and/or an OMEGA framework), schedulers, timers, clocks, code segments, data segments, various memory models, disks, file systems, files, directories, boot code, shutdown code, a cache, a buffer, a processor register, a log, a tracing mechanism, a registry, a network protocol layer, a network adapter, a line card, a kernel, a security ring, a policy, a policy manager, encryption hardware and/or software, routing/forwarding/relaying mechanisms, data bases of various types, communications agents (e.g. email, instant messaging, voice, etc.), distributed file systems, distributed memory mechanisms, shared memory mechanisms, broadcast mechanisms, displays, graphics hardware, signals, pipes, streams, sockets, physical memory, virtual memory, virtual file systems, command line interfaces, and code and/or data (e.g. system libraries). OERs may be accessed for process management, thread management, memory management, input/output device management, virtual machines, kernels, storage management, security management, network management, user interface management, data storage, data exchange via a network, presenting output, detecting input, operatively coupling to a peripheral device and/or a peer device, providing power, generating heat, dissipating heat, and the like.

The term “operating environment resource set” (OER Set) for one more instructions that are executable by a processor, as used in the present disclosure, refers to the set of OERs that are accessed by an operating environment in an executing of the one or more instructions. The term “operating environment resource container” (OER Container) for the one or more instructions, as used in the present disclosure, refers to the set of OERs identified and/or otherwise referenced by the one or more instructions that are accessed by a processor, in the operating environment, that executes the one more instruction. An OER Container, is thus, included in an OER Set.

Whether an OER is included in an OER Container and/or an OER Set for an executing of an executable entity may depend on the particular one or more instructions executed during the executing. Whether an instruction is executed in a particular executing may be determined and/or otherwise configured during the executing of the executable entity, prior to loading an instruction in the addressable entity into a processor address space for the executing, during a translating of source code and/or a translation the source code of which the executable entity is a translation.

A “virtual operating environment” (VOE) operates in another operating environment. Linux and Windows virtual machines are examples of VOEs. The term “virtual machine” (VM) as used in the present disclosure refers to a software implementation that includes an emulation of a physical machine (e.g., a computer). A VM that includes an emulation of a processor is an operating environment provided by a host operating environment where the host operating environment includes a processor realized in hardware. Virtual machines provide hardware virtualization. Another category of VOE is referred to, in the present disclosure, as a “process virtual environment” (PVE). A PVE includes a single computing process. A JAVA virtual machine is an example of a process virtual environment. PVEs are typically tied to particular programming languages. Still another exemplary type of VOE is a “container operating environment” (COE). As used in the present disclosure a COE refers to a partition of a host operating environment that isolates an executing of an executable entity from other partitions. For example, a single physical server may be partitioned into multiple small partitions that each execute logic for respective web servers. To an executable entity, such as a web server, operating in a partition (COE) the partition appears to be an operating environment. COE's are referred to in other contexts outside the present disclosure as virtual environments (VE), virtual private servers (VPS), guests, zones, containers (e.g. Linux containers), etc.

The term “minimally-complete operating environment” (MOE), as used in the present disclosure, refers to an operating environment that in the context of one or more other operating environments and at least one operation specified in source code written in a programming languages is a) capable of performing the at least one operation by executing an executable translation of the source code based on one or more OERs accessed by the operating environment in the performing and b) has a minimum measure associated with the performing in a group (two or more) of measures each associated with a performing of the at least one operation by a respective operating environment in a group (two or more) of operating environments that includes the MOE. Each of the measures associated with a respective performing by an operating environment is determined according to a metric based on one or more the OERs. An operation may be performed by one operating environment by executing a translation including one or more instructions translated from the source code. The same operation may be performed by another operating environment by executing a different translation including one or more instructions translated from the source code. For example, one operating environment may perform the operation by executing instructions translated from the source code for an INTEL processor and the other operating environment may perform the operation by executing instructions translated form the source code for an ARM processor.

For a particular operation, an MOE in a group of COEs may be determined based on a metric for measuring power accessed (e.g. an OER) in performing the operation by each of the COEs. The MOE may be selected based on least power accessed according to a specified metric. In another aspect, an MOE may be determined based on a metric measuring time. The metric may be based on time to perform the operation by respective operating environments in a group of two or more. The MOE may be determined based on a least time or a preferred duration for performing the operation. Metrics for determining MOEs may be based on OERs in OER Sets or may be based on OERs in OER Containers.

The terms “network node” and “node” in the present disclosure both refer to a device having a network interface component capable of operatively coupling the device to a network. Further, the terms “device” and “node” in the context of providing and/or otherwise being included in an operating environment refer respectively, unless clearly indicated otherwise, one or more devices and nodes.

The user-detectable outputs of a user interface are generically referred to in the present disclosure as “user interface elements” or abbreviated as “UI elements”. More specifically, visual outputs of a user interface are referred to in the present disclosure as “visual interface elements”. A visual interface element may be a visual output of a graphical user interface (GUI). Exemplary visual interface elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application interface may include one or more of the elements listed. Those skilled in the art will understand that this list is not exhaustive. The terms “visual representation”, “visual output”, and “visual interface element” are used interchangeably in the present disclosure. Other types of UI elements include audio outputs referred to as “audio interface elements”, tactile outputs referred to as “tactile interface elements”, and the like.

A “user interface (UI) element handler” component, as the term is used in the present disclosure, refers to logic that operates to send information to present a user-detectable representation of a processed entity by an output device, such as a display. A “processed entity” is an object, such as a variable or file, included in and/or otherwise operated on by a hardware component via an instruction included in the logic of an executable component. The user-detectable representation is presented based on the sent information. The information sent to present the user detectable representation of the processed entity by the output device is referred to in the present disclosure as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a browser or more generally a user agent from a remote application provider may include HTML, ECMAScript, and/or byte code to present one or more UI elements included in a user interface of the remote application. Components that send presentation information include visual interface element handler components, audio interface element handler components, tactile interface element handler components, and the like.

A representation of a processed entity may be stored and/or otherwise maintained in a presentation space. As used in the present disclosure, the term “presentation space” refers to a storage region allocated and/or otherwise provided to store and/or otherwise represent presentation information, which may include audio, visual, tactile, and/or other sensory data for presentation by and/or on an output device. For example, a memory buffer to store an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

A computer program may include one or more software components. As used in the present disclosure, the term “software component” refers to any data representation that may be and/or may be translated into logic that may be stored in a memory and accessed by a processor to execute in an operating environment. A software component may optionally include associated data that does not represent a logic executable by a processor. Software component representations include machine code object code, byte code, and source code. Object code includes a set of instructions and/or data elements that either are prepared to link prior to loading or are loaded into an operating environment. When in an operating environment, object code may include references resolved by a linker and/or may include one or more unresolved references. The context in which this term is used will make clear the state of the object code when it is relevant. A software component may include one or more software components. As used in the present disclosure, the terms “application”, and “service” may be realized in one or more software components accessible to a processor via a data storage medium and/or may be realized in one or more hardware components.

Software components include instructions executed by a processor. The instructions may be executed in a computing context referred to as a “process”. A process may include one or more “threads”. A “thread” includes a one or more instructions executed by a processor in a computing sub-context of a process. The terms “thread” and “process” may be used interchangeably in the present disclosure when a process includes only one thread.

A “programming language” is defined for expressing data and operations by a programmer for performing by executing instructions by a processor in an operating environment. The instructions are translated from source code that expresses the data and operation in the programming language. A programming language is defined and/or otherwise specified by an explicit and/or implicit schema that identifies one or more formatting rules and/or that identifies a vocabulary for determining whether an instance of source code is valid according to the programming language. A programming language defines the semantics or meaning of source code written in the programming language with respect to an operating environment in which a translation of the source code is executed. Source code written in a programming language may be translated into a “representation language”. As used in the present disclosure, a “representation language” is defined and/or otherwise specified by an explicit and/or implicit schema that identifies at least one of a syntax and a vocabulary for a target translation of source code that maintains the functional semantics expressed in the source language translated. Note that some programming languages may serve as representation languages.

Exemplary types of programming languages for writing and/or otherwise expressing source code include array languages, object-oriented languages, aspect-oriented languages, assembler languages, command line interface languages, functional languages, list-based languages, procedural languages, reflective languages, scripting languages, and stack-based languages. Exemplary programming languages include C, C#, C++, FORTRAN, COBOL, LISP, FP, JAVA®, APL, PL/I, ADA, Smalltalk, Prolog, BASIC, ALGOL, ECMAScript, BASH, and various assembler languages.

Exemplary types of representation languages include object code languages, byte code languages, machine code languages, programming languages, and various other translations of source code.

A “compiler”, also referred to as a “translator”, as used in the present disclosure is a component or an arrangement of components that includes logic that when executed translates source code written in a programming language or a translation of the source code into a target translation of the source code expressed according to a representation language. A translator may translate a first translation of source code into a second translation of source code. A translation received as input to a translator is referred to in the present disclosure as a “source translation” or an “input translation” and is said to be expressed in a “source language”. A translation generated by a translator is referred to in the present disclosure as a “target translation” or an “output translation” and is said to be expressed in a “target language”. The term “source code” as used in the present disclosure refers to computer code written in a programming language. For example, source code is often written by a programmer as an original work.

The terms “compiling” and “translating” are used interchangeably in the present disclosure. Both terms refer to the operation of a compiler or translator in translating source code and/or a translation of source code into a target translation. Linkers and loaders may operate as translators as the term “translator” is used in the present disclosure.

Some source code includes one or more macros written in a macro language. Macro languages are not programming languages and are thus preprocessed rather than “compiled” or “translated” as the terms are defined in the present disclosure.

As used in the present disclosure, an “addressable entity” is a portion of a program, specifiable in a programming language in source code. An addressable entity is addressable by a processor in a program component translated from the source code when loaded into a processor memory in a compatible operating environment. Examples of addressable entities include variables, constants, functions, subroutines, procedures, modules, methods, classes, objects, code blocks, and labeled instructions. A code block includes one or more instructions in a given scope specified in a programming language. An addressable entity may include a value.

Addressable entities may be written in and/or translated to a number of different programming languages and/or representation languages. An addressable entity may be specified in and/or translated into source code, object code, machine code, byte code, and/or any intermediate language for processing by an interpreter, compiler, linker, loader, or analogous tool.

As used in the present disclosure, the phrase “translated from” includes direct translations and indirect translations. That is, a second translation, which is generated from a first translation translated from particular source code, is translated from the particular source code as the phrase “translated from” is used in the present disclosure.

As used in the present disclosure, the term “network protocol” refers to a set of rules, conventions, and/or schemas that govern how nodes exchange information over a network. The set may define, for example, a convention and/or a data structure.

A metric defines a unit of measure. For example, an “inch” is a unit of measure for measuring length. A “kilowatt-hour” (kWh) is a unit of measurement in a metric for measuring an amount of energy. Instead of or in addition to measuring an amount a metric may measure a rate. “Kilowatts per hour” (kWh/h) is energy or power metric for measuring a rate of energy used. A “measure” is a result of a particular measuring or measurement process. For example, 3 inches is a measure according to the length metric for inches, and 1000 kWh is a measure of an energy metric identifying an amount of energy. As used in the present disclosure, a “measure of a cost” refers to a result of a measuring process for determining the cost according to a specified metric. Measuring may include estimating a measurement.

As used in the present disclosure, a “performance cost”, is a cost for performing an instruction and/or operation in an operating environment. The instruction and/or operation is specified in source code and performed by executing a translation of the source by the operating environment. A cost may be expressed as a measure which is a result of a measuring and/or estimating process, based on a metric.

### Operating Environments

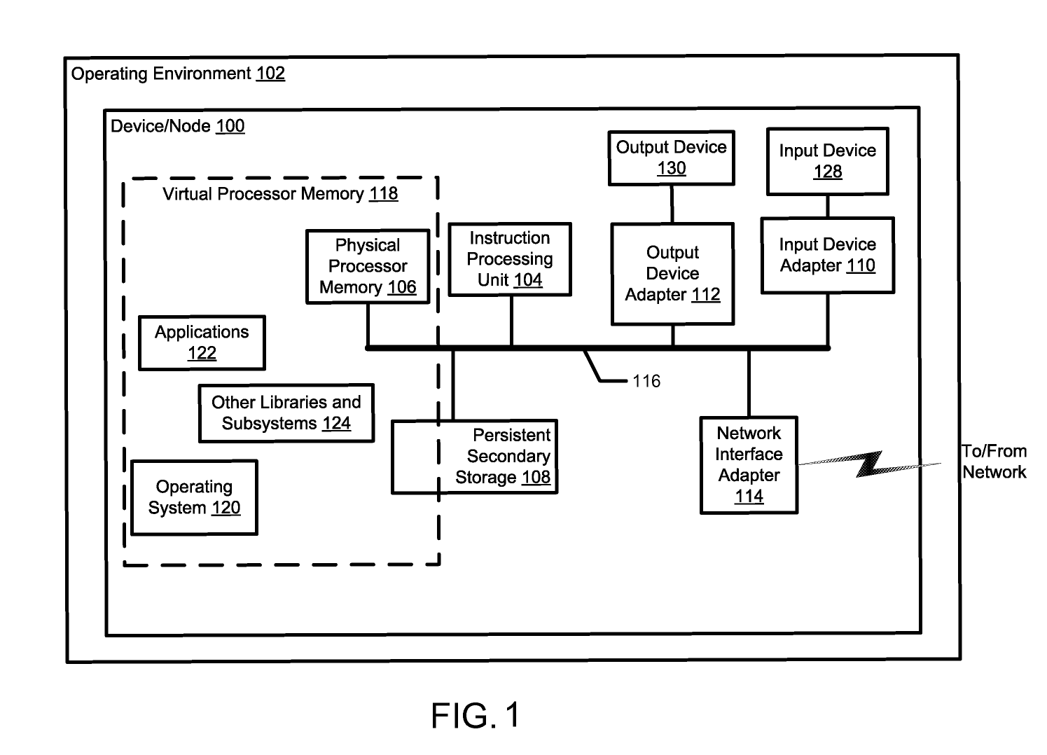

An exemplary device included in an operating environment that may be programmed, adapted, modified, and/or otherwise configured according to the subject matter of the present disclosure is illustrated in FIG. 1. FIG. 1 illustrates a hardware device 100 included in an operating environment 102. FIG. 1 illustrates that operating environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a touch adapter, a keyboard adapter, and/or a mouse adapter; an output device adapter 112, such as a display and/or an audio adapter to present information to a user; a network interface component, illustrated by a network interface adapter 114, to communicate via a network such as a LAN and/or WAN; and a mechanism that operatively couples elements 104-114, illustrated as a bus 116. Elements 104-114 may be operatively coupled by various means. Bus 116 may comprise any type of bus architecture, including a memory bus, a peripheral bus, a local bus, a mesh fabric, and/or a switching fabric.

Processor 104 may access instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of an instruction and/or may be identified by a register and/or other portion of processor 104.

An address space including addresses that identify locations in a virtual processor memory is referred to as a “virtual memory address space”; its addresses are referred to as “virtual memory addresses”; and its processor memory is referred to as a “virtual processor memory” or “virtual memory”. The term “processor memory” may refer to physical processor memory, such as processor memory 106, and/or may refer to virtual processor memory, such as virtual processor memory 118, depending on the context in which the term is used.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. Both physical processor memory 106 and virtual processor memory 118 are processor memories, as defined above.

Physical processor memory 106 may include various types of memory technologies. Exemplary memory technologies include static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Ferroelectric RAM (FRAM), RAMBUS DRAM (RDRAM) Direct DRAM (DRDRAM), and/or XDR™ DRAM. Physical processor memory 106 may include volatile memory as illustrated in the previous sentence and/or may include non-volatile memory such as non-volatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated computer readable media provide volatile and/or nonvolatile storage for representations of computer-executable instructions, data structures, software components, and other data. The computer readable instructions may be loaded into a processor memory as instructions executable by a processor.

Operating environment 102 may include logic in software components stored in persistent secondary storage 108, in remote storage accessible via a network, and/or in a processor memory. FIG. 1 illustrates operating environment 102 including an operating system 120, one or more applications 122, and other software components and/or data components illustrated by other libraries and subsystems 124. In an aspect, some or all software components may be stored in locations accessible to processor 104 in a shared memory address space shared more than one thread and/or process of operating environment 102. The logic and data in software components accessed via the shared memory address space may be stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Operating environment 102 may receive user-provided information via one or more input devices illustrated by an input device 128. Input device 128 provides input information to other components in operating environment 102 via input device adapter 110. Operating environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in operating environment 102 may be included in device 100 as FIG. 1 illustrates or may be external (not shown) to device 100. Operating environment 102 may include one or more internal and/or external input devices. External input devices may be connected to device 100 via corresponding data interfaces such as a serial port, a parallel port, and/or a universal serial bus (USB) port. Input device adapter 110 may receive input and provide a representation to bus 116 to be received by processor 104, physical processor memory 106, and/or other components included in operating environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of operating environment 102 to one or more users. In some architectures, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred in the present disclosure to as “sensory input” with respect to the user.

A device included in and/or otherwise providing an operating environment may operate in a networked environment interoperating with one or more other devices via one or more network interface components. FIG. 1 illustrates network interface adapter (NIA) 114 as a network interface component included in operating environment 102 to operatively couple device 100 to a network. A network interface component includes a network interface hardware (NIH) component and optionally a network interface software (NIS) component. Exemplary network interface components include network interface controllers, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., CDMA, AMPS, TDMA, CDMA, GSM, GPRS UMTS, and/or PCS network).

Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, mesh networks, and/or personal area networks (PANs). Exemplary networks also include intranets and internets such as the Internet.

Exemplary devices included in and/or otherwise providing suitable operating environments that may be adapted, programmed, and/or otherwise modified according to the subject matter include a workstation, a desktop computer, a laptop or notebook computer, a server, a handheld computer, a smartphone, a mobile telephone or other portable telecommunication device, a media playing device, a gaming system, a tablet computer, a portable electronic device, a handheld electronic device, a multiprocessor device, a distributed system, a consumer electronic device, a router, a switch, a bridge, a network server, or any other type and/or form of computing, telecommunications, network, and/or media device that is suitable to perform the subject matter described in the present disclosure. Those skilled in the art will understand that the components illustrated in FIG. 1 are exemplary and may vary by particular operating environment. An operating environment may be and/or may include a virtual operating environment including software components operating in a host operating environment.

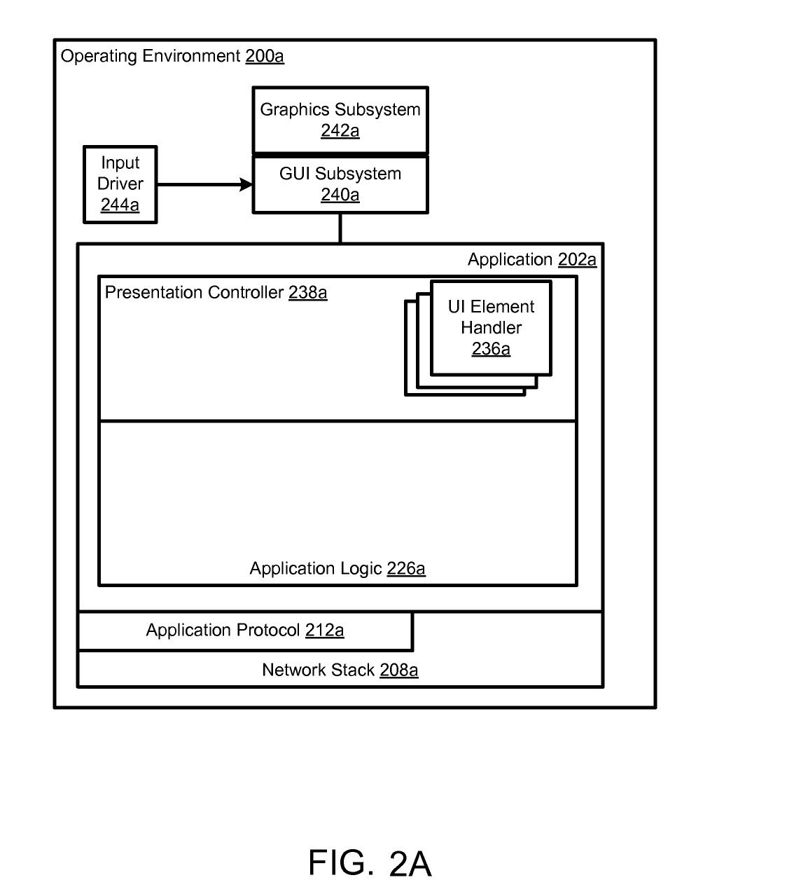

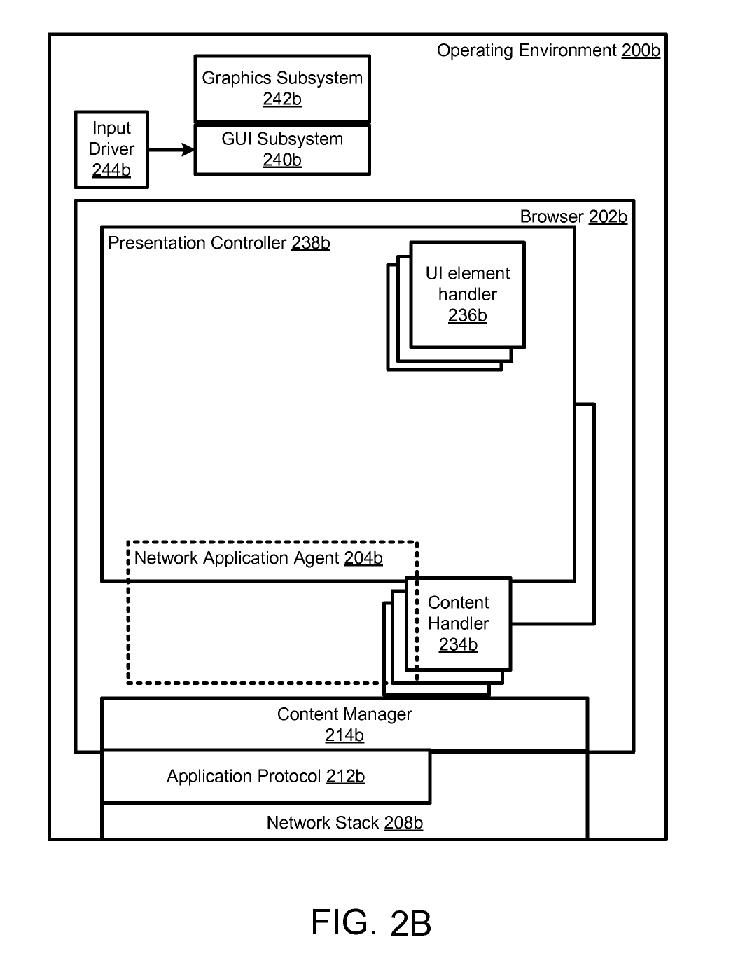

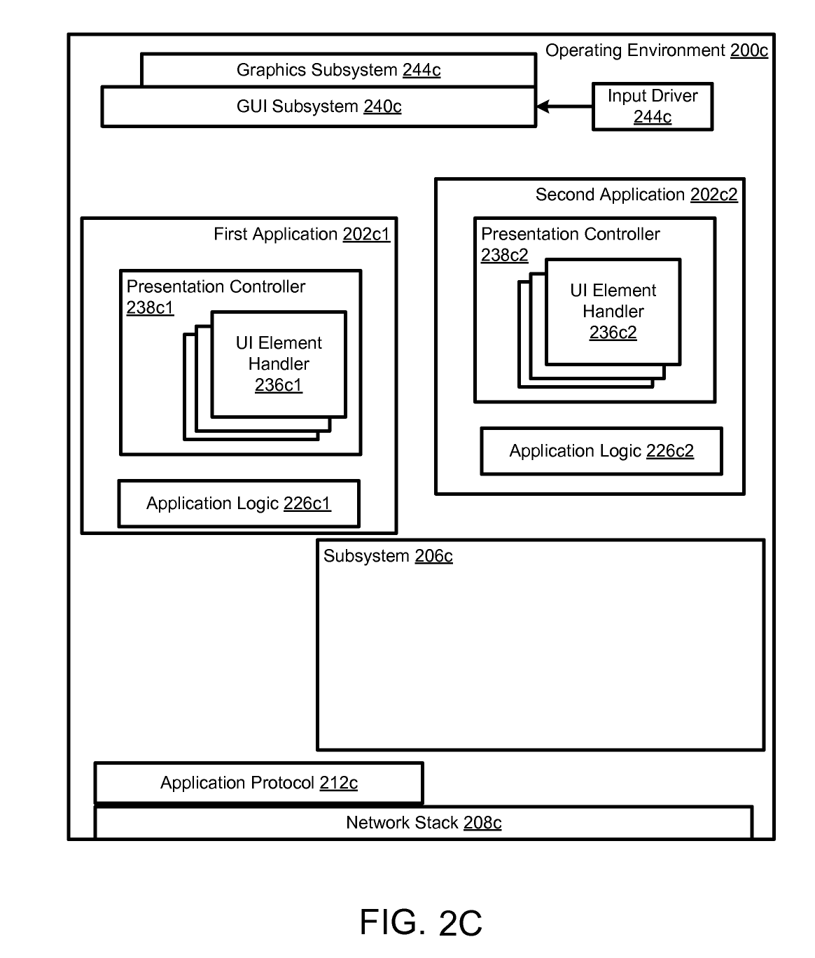

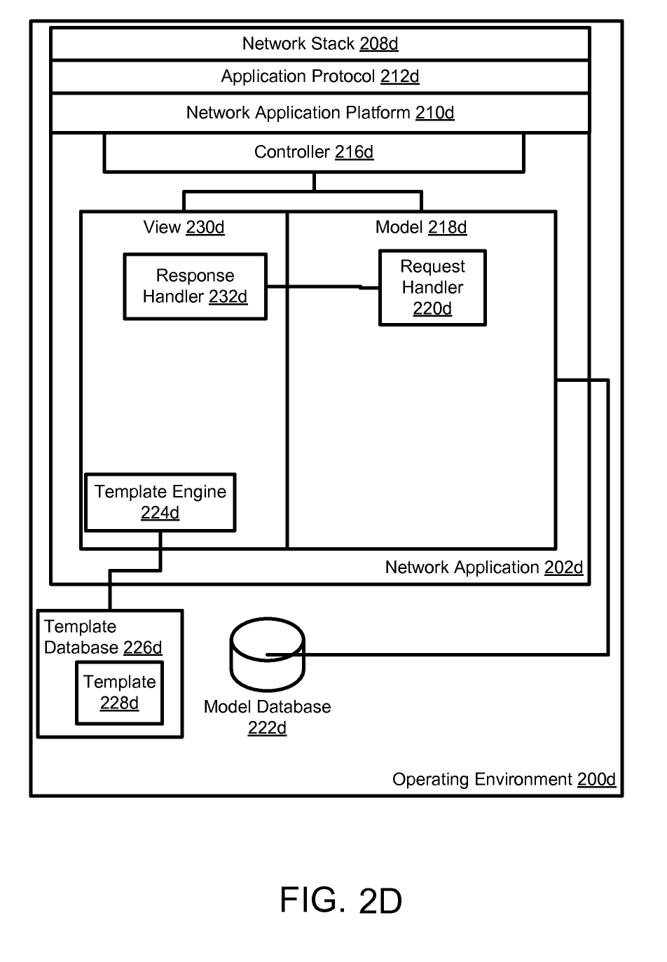

FIGS. 2A-D include additional block diagrams illustrating hardware, code, and/or data components of various operating environments 200 including or otherwise provided by one or more devices and/or nodes that may include logic to perform the various methods described in the present disclosure. FIGS. 2A-D each illustrate different adaptations and/or emulations of hardware, code, and/or data that in operation and/or as a result of processing performs one or more methods described in the present disclosure. A node of an operating environment 200 may be operatively coupled to network via a network interface, such as network interface adapter. Alternatively or additionally, an adaptation of an operating environment 200 may include and/or may otherwise be provided by a device that is not operatively coupled to a network. A node may operate as a server device. A server device may be a part of and/or otherwise may be included in an operating environment 200 as illustrated in operating environment 200d in FIG. 2D. The server device may be operatively coupled to the network via a network interface included in operating environment 200d.

FIG. 2A illustrates operating environment 200a hosting application 202A which may include an arrangement of hardware, code, and/or data that may be modified to include logic that performs one or more methods described in the present disclosure. In an aspect, application 202a may include a virtual machine, such as JAVA virtual machine providing an operating environment for code generated from JAVA source code. FIG. 2B illustrates operating environment 200b hosting browser 202b which may include code and/or data that may be modified to include logic that performs one or more methods described in the present disclosure. Such logic may operate at least partially in a network application agent 204b received from a remote application provider, such as network application 202d in FIG. 2D. Browser 202b and operating environment 200b may provide at least part of an operating environment for a network application agent 204b that may be received via a network from a network application including hardware, code, and/or data processed in a remote operating environment. FIG. 2C illustrates that an arrangement of hardware, code, and/or data that may be modified to include logic that performs one or more methods described in the present disclosure and that may operate and/or otherwise to be processed in and/or as a subsystem 206c of operating environment 200c. FIG. 2D illustrates operating environment 200d that may host one or more network applications, such as a web service, illustrated by network application 202d that may include an arrangement of hardware, code, and data that may be modified to include logic that performs one or more methods described in the present disclosure.

The various arrangements of hardware, code, and/or data, as well as their adaptations and analogs described in the present disclosure, are not exhaustive. For example, those skilled in the art will see based on the description in the present disclosure that arrangements of hardware, code, and/or data for performing the methods described in the present disclosure may be at least partially included in an application and at least partially external to the application. Further, arrangements for performing the methods described in the present disclosure may be distributed across more than one node and/or operating environment. For example, such an arrangement may operate at least partially in browser 202b in FIG. 2B and at least partially in operating environment 200d in and/or external to network application 202d in FIG. 2D.

FIGS. 2A-D illustrate adaptations of network stacks 208 that may send and/or receive messages over a network via network interface hardware and/or code. Network application platform 210d in FIG. 2D provides services to one or more network applications. In various aspects, network application platform 210d may include and/or interoperate with a web server. FIG. 2D also illustrates network application platform 210d may interoperate with network stack 208d. Network stacks 208 may support the same protocol suite, such as TCP/IP, or may communicate via a network gateway or other protocol translation device and/or service. For example, browser 202b in FIG. 2B and network application platform 210 in FIG. 2D may interoperate via their respective network stacks: network stack 208b and network stack 208d.

FIGS. 2A-D respectively illustrate applications 202 that may communicate via one or more application layer protocols 212. FIGS. 2A-D respectively illustrate application protocol hardware, code, and/or data for communicating via one or more application layer protocols. Exemplary application protocols include hypertext transfer protocol (HTTP) and instant messaging and presence (XMPP-IM) protocol. Matching protocols enabling applications 202 to communicate via a network are not required, if communication is via a protocol gateway or other protocol translator.

In FIG. 2B, browser 202b may receive some or all of network application agent 204b in one or more messages sent from a network application, such as network application 202d via network application platform 210d, a network stack 208, a network interface component, and optionally one or more application protocols 212. In FIG. 2B, browser 202b includes content manager 214b. Content manager 214b includes and/or emulates hardware, code, and/or data that may interoperate with one or more of application protocol(s) 212b and/or network stack 208b to receive the message or messages including some or all of network application agent 204b.

Network application agent 204b may include a web page for presenting a user interface for network application 202d. The web page may include and/or reference data represented in one or more formats including HTML and/or other markup language, ECMAScript or other scripting language, byte code, image data, audio data, and/or machine code.

In an example, in response to a request received from browser 202b in FIG. 2B operating in a first node, a controller 216d in FIG. 2D includes and/or emulates hardware, code, and/or data operating and/or processed in a second node that may invoke model subsystem 218d to perform request-specific processing. Model subsystem 218d may include any number of request handlers 220d that include and/or emulate hardware, code, and/or data that in operation and/or when processed dynamically generate data and/or retrieve data from model database 222d based on the request. Controller 216d may further invoke template engine 224d that includes and/or emulates hardware, code, and/or data that during operation and/or processing identifies one or more templates and/or static data elements included in generating a user interface that represents a response to the received request. FIG. 2D illustrates template database 226d including exemplary template 228d. FIG. 2D illustrates template engine 224d in view subsystem 230d. A response handler 232d includes and/or emulates hardware, code, and/or data that during operation and/or when processed returns responses to processed requests in a presentation format suitable for a client, such as browser 202b. View subsystem 230d may include one or more response handlers for various responses that differ in some way. A response handler 232d may provide the presentation data to controller 216d to send to browser 202b in response to the request received from browser 202b. Some or all of network application agent 204b may be sent to browser 202b via network application platform 210d as described above.

While the example above describes sending some or all of network application agent 204b in response to a request, network application 202d additionally or alternatively may send some or all of a network application agent to browser 202b via one or more asynchronous messages. In an aspect, an asynchronous message may be sent in response to a change detected by network application 202d. Publish-subscribe protocols, such as the presence protocol specified by XMPP-IM, are exemplary protocols for sending messages asynchronously.

The one or more messages including information representing some or all of network application agent 204b in FIG. 2B may be received by content manager 214b via one or more of application protocol(s) 212b and network stack 208b as described above. In FIG. 2B, browser 202b includes one or more content handlers 234b that include and/or emulate hardware, code, and/or data that during operation and/or when processed transforms and/or otherwise processes received data according to its data type, typically identified by a MIME-type identifier. Exemplary content handlers 234b include a text/html content handler for processing HTML documents; an application/xmpp-xml content handler for processing XMPP streams including presence tuples, instant messages, and publish-subscribe data as defined by various XMPP specifications; one or more video content handler for processing video streams of various types; and still image data content handler for processing various images types. A content handler 234b processes received data and may provide a representation of the processed data to one or more user interface (UI) element handlers 236b.

UI element handler(s) 236 are illustrated in presentation controller 238 in FIG. 2A-C. A presentation controller 238 may include and/or emulate hardware, code, and/or data that during operation and/or during processing manages the visual, audio, and/or other types of output of its including application 202 as well as receive and route detected user and other inputs to and extensions of its including application 202. With respect to FIG. 2B, a UI element handler 236b in various aspects may be adapted to operate at least partially in a content handler 234b such as a text/html content handler and/or a script content handler hardware, code, and/or data component. Additionally or alternatively, a UI element handler 236 in an operating environment 200 may operate in and/or as an extension of its including application 202. For example, a plug-in may provide a virtual machine, for a UI element handler received as a script and/or byte code, that may operate as an extension in application 202 and/or external to and interoperating with application 202.

An application 202 may present data to a user via one or more presentation spaces associated with one or more output devices, such as display. In some aspects, a user interface element may provide one or more presentation spaces for presenting a user interface of multiple applications interoperating and/or for presenting user interfaces of respective applications. For example, a user interface element may be presented via interoperation of browser 202b, network application agent 204b, and network application 202d illustrated in FIG. 2B and FIG. 2D. Browser 202b may operate in a first node, and network application 202d may operate in a second node. Network application agent 204b may be provided to the first node by the second node via the network, as described above.

Various UI elements of applications 202 described above may be presented via one or more UI element handlers 238 in FIGS. 2A-D. In FIGS. 2A-D, UI element handler(s) 238 of one or more applications 202 may include and/or emulate hardware, code, and/or data that in operation and/or as a result of processing sends presentation information representing a visual interface element to a GUI subsystem 242. A GUI subsystem 240 may include and/or emulate hardware, code, and/or data in operation and/or as a result of processing may instruct a corresponding graphics subsystem 242 to draw the visual interface element in a region of presentation space of a display device, based on presentation information received from a corresponding UI element handler 236.

Input may be received corresponding to a UI element via an input driver 244 illustrated in FIGS. 2A-C in various adaptations. For example, a user may move a mouse and/or a finger to move a pointer presented in display presentation space over a user interface element presented representing an operation in a tool bar. A user may provide an input detected by the mouse and/or a touchscreen. The detected input may be received by a GUI subsystem 240 via an input driver 244 as an operation or command indicator based on the association of the shared location of the pointer and the user interface element representing the operation in the display presentation space.

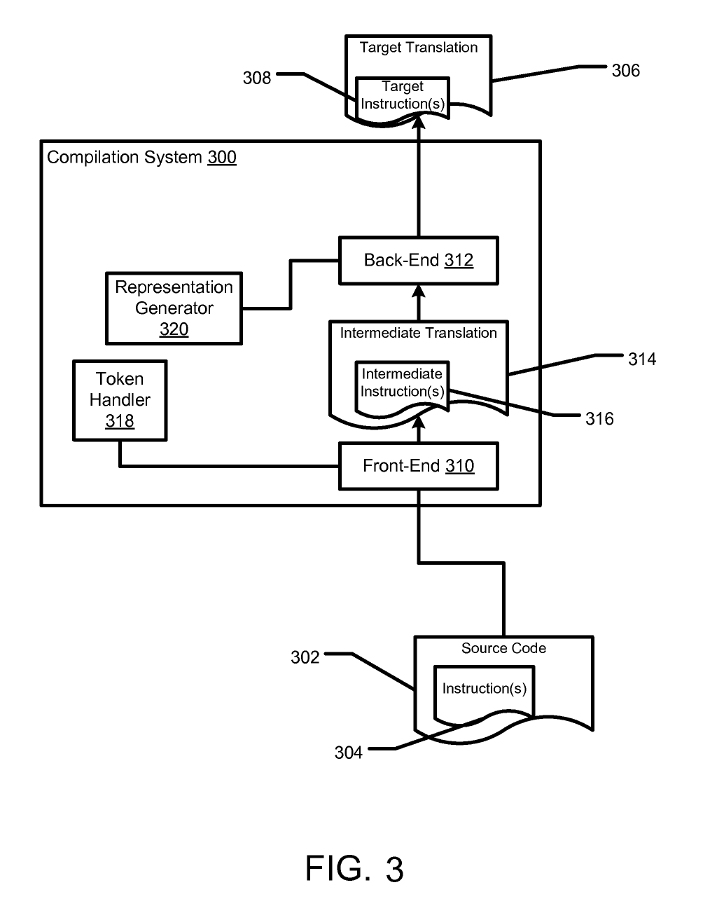

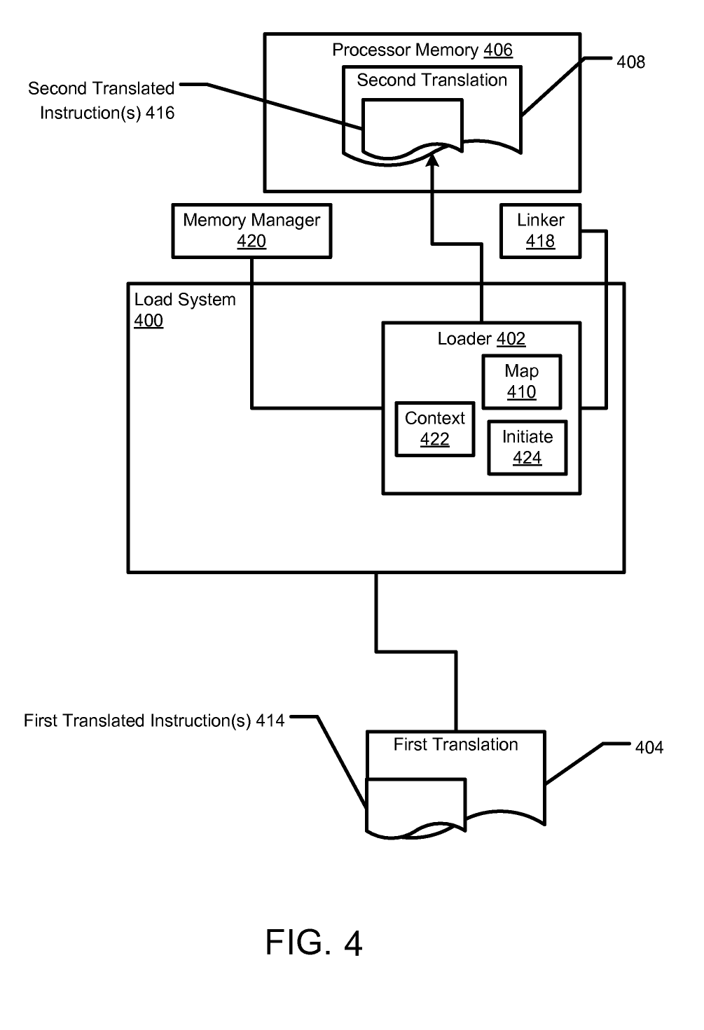

FIGS. 3-4 illustrate exemplary components, applications, and subsystems that may be adapted to include logic to perform one or more of the methods of the subject matter described in the present disclosure. The arrangements in FIGS. 3-4 may operate in any one or more of the operating environments. FIG. 3 illustrates an exemplary application and/or system illustrated by compilation system 300 for translating and/or otherwise transforming source code 302 including one or more instructions 304 written in a programming language into a target translation 306 that includes a translation of the one more instructions 304 illustrated by target instructions 308. An instruction written in a programming language may be specified by a statement, an expression, and definition, and/or other programming construct of the particular programming language in which the instruction is expressed. Compilation system 300 may be modified to include logic that performs one or more of the methods described in the present disclosure as described in more detail below.

FIG. 3 illustrates front-end component 310 included in compilation system 300. Logic in front-end 310 may instruct a processor to access source code 302 from a data store, from a user via an input device, and/or via a network to store in a processor memory for translation. Front-end 310 may receive source code 302 from a variety of types of data stores storing data in various types of data storage media. Source code 302 may accessed from a memory in local data store, for example. Source code 302 includes source code written in a programming language specifying one more instructions 304 and may include other instructions that may or may not be translated in target translation 306. In an aspect, front-end 310 may receive source code 302 stored in a file accessible via a file system. The file system may access a data storage medium or media in a local data store via a data storage media driver.

In various aspects, components in compilation system 300 may make one or more passes over source code 302 and/or translations of source code produced during the translating of source code 302 to target translation 306. Whether a compilation system 300 operates in a single pass or in multiple passes depends on the requirements of a programming language and decisions of those who build the compilation system.

Compilation system 300 illustrates a compiler or translator structured to operate in phases or layers. FIG. 3 illustrates back-end component 312 included in compilation system 300 to perform one or more phases in addition to the phase(s) performed by front-end 310. One or more middle-end components may be included in and/or otherwise accessed by compilation system 300 to perform optional operations such as various optimizations. A phase, when performed, may produce an intermediate translation of source code 302, which includes a translation of instruction(s). The division of phases and thus the component structure of a compilation system may vary according to the requirements of a programming language and decisions of those who build the compilation system.

Front-end 310 may determine whether source code 302 is valid according to the programming language of source code 302. Front-end 310 may verify that source code 302 is syntactically and/or semantically correct according to the specification of the programming language. Front-end 310 may generate an intermediate translation, illustrated by intermediate translation 314, of source code 302. Instruction(s) 304 may be translated to one or more instructions in intermediate translation 314, illustrated by intermediate instruction(s) 316.

Front-end 310 may build an internal representation of source code 302, such as a parse tree, and generate intermediate translation 314 and a symbol table (not shown) based on the internal representation. A symbol table may identify some or all symbolically identifiable entities defined in and/or translated from source code 302. A symbol table may include metadata about the identified entities such as data type metadata, location metadata, and/or scope metadata. The metadata that is maintained may depend on a programming language, a builder of a particular compilation system, and/or a user of a particular compilation system.

One or more middle-end components (not shown) may process intermediate translation 314 and/or another translation generated from intermediate translation 314. Whether a middle-end component is included in the translating of source code 302 to target translation 306 may be configurable by a user.

Back-end 312 may translate intermediate translation 314 and/or a translation generated from intermediate translation 314 into target translation 306. A target translation may include assembler code, byte code, machine code, and/or any data representation that is translatable into a machine code translation of source code 302. In FIG. 3 target translation 306 includes target instruction(s) 308 translated from intermediate instruction(s) 316, directly and/or indirectly.

Compilation system 300 may generate target translation 306 for translating to a machine code translation that is executable in the operating environment that includes compilation subsystem 300 and that may also be executable in an architecturally equivalent operating environment. Compilation system 300 may generate target translation 306 for translating to a machine code translation executable in one or more operating environments that are architecturally dissimilar from the operating environment of compilation subsystem 300. For example, operating environments that include a processor based on a common or shared processor arrangement may be considered architecturally equivalent. Dissimilar operating environments may include processors based on different processor architectures.

An interpreted language may be compiled and a compiled language may be interpreted. For example, source code written in languages that are considered to be interpreted languages such as BASIC and ECMAScript may be compiled. Further, a compiled language, such as C, may be interpretable. Those skilled in the art understand that the distinction between compiling and interpreting is based on when and where a translation process occurs. Interpreters and compilers are both translators. Just-in-time (JIT) compilers and byte code interpreters are evidence supporting the previous statement as they blur the apparent distinctions between interpreters and compilers. The scope of the subject matter described in the present disclosure includes translation of source code by interpreters and includes interpretable programming languages as translatable languages.

In FIG. 3, front-end 310 may invoke token handler component 318 for building a parse tree, a syntax tree, a symbol table, and/or for otherwise identifying metadata based on source code 302. A parse tree includes an ordered tree or hierarchy of nodes representing the syntactic structure of some or all source code statements in source code, such as source code 302. The syntactic structure may be based on a formal grammar or schema included in a specification and/or definition of a programming language in which the source code is represented. A syntax tree represents a tree or hierarchy of the syntactic structure of source code 302 according to the programming language.

A symbol table may identify some or all addressable entities defined in and/or generated from source code 302. A symbol table may include metadata about the addressable entities such as data type metadata, location metadata, and/or scope metadata. Metadata that is maintained may depend on the programming language of source code 302, a programmer writing source code 302, and/or a designer and/or builder of compilation system 300.

Token handler 318 may generate and/or otherwise process some or all of a parse tree, a syntax tree, a symbol table, and/or other suitable representation of the source code 302 to detect an indicator that an addressable entity may be modified from a translation of source code 302. Token handler 318, in one aspect, may scan one or more statements, declarations, and/or definitions in source code 302 to detect instruction(s) 304.

In FIG. 3, back-end component 312 may interoperate with a representation generator component 320 to generate a first translation of source code 302. The first translation is illustrated by target translation 306. Any translation whether internal to compilation system 300 and/or stored external to compilation system is a translation and is a target translation from the perspective of a particular component and/or phase included in translating source code 302 to target translation 306.

A translation is a target translation when it is the output of a translator. A translation is source code and/or a source translation when it is translated by a translator to another translation. Source code and a target translation of the source code may be at least partially represented in the same language. Similarly, a source translation and a target translation of the source code may be at least partially represented in the same language. For example, an object code translation of a source code component may include machine code. An executable translation, of the object code, stored in a processor memory may also include machine code. The language of the object code as a whole may be considered to be a different language from the language of the executable code in the processor memory as the syntax and rules may differ. For example, unresolved references may be allowed by the rules of an object code language, but not allowed by the rules of an executable language even though both may include machine code portions that are identical.

In an aspect, front-end 310 may interoperate with an adaptation and/or analog of a representation generator component to generate intermediate translation 314. A middle-end component (not shown) may generate another intermediate translation. Target translation 306 may include a translation of some or all of the source code as assembler, a high-level programming language, byte code, unlinked object code, and/or linked object code. Target translation 306 may include a relocatable machine code translation, a position independent translation, and/or an unrelocatable machine code translation.

FIG. 4 illustrates a load system 400 as another exemplary application and/or system that may be modified to include logic that performs one or more of the methods described in the present disclosure as described in more detail below. A load system 400 includes logic for loading a program component translated from source code into a processor memory of an operating environment for accessing by a processor to execute one or more instructions translated from the source code, such as machine code instructions included in the machine code translation of the source code. In loading a program component, load subsystem 400 translates a program component into an executable translation of the program component. For example, loading a byte code translation of a source code component includes translating the byte code translation into machine code instructions. Loading an object code translation includes translating the object code, which may include machine code, into a machine code translation in an address space of a processor for executing.

FIG. 4 illustrates loader component 402 in loader system 400. Loader 402, in an aspect, receives a first translation 404 generated from source code written in a programming language. The first translation is generated by a compilation or translation system such as compilation system 300 in FIG. 3 described above. The first translation 404 may be any target translation described above, an analog, and/or an equivalent.

Loader 402, in various aspects, may access a first translation from a variety of types of data stores that store data in various types of data storage media. Loader 402 may receive first translation 404 stored, for example, in a file accessible via a file system. The file system may access a data storage medium or media in a local data store via data storage media driver.

In various aspects, a loader system may be included in an operating system in an operating environment, may be part of an application and/or component in an operating environment, and/or may operate in an operating environment that does not include an operating system. Loader system 400 is included in loading programs into a processor memory 406 of an operating environment. Processor memory 406 is defined by an address space of a processor in the operating environment. When loaded into a processor memory and/or mapped into a processor memory, a loaded program component is accessible to the processor for accessing one or more machine code instructions in the loaded program and executing by the processor.

First translation 404 may include machine code that is executable by the processor when translated into an executable translation in an address space defining processor memory 406 of the processor. In another aspect, first translation 404 may include intermediate code, such as byte code, that is translated into machine code for loading. Loader system 400 may be included in translating intermediate code. One or more components of a compilation system, such as compilation system 300 in FIG. 3, may be invoked to perform at least part of the translation of first translation 404 into a second translation 408. Second translation 408, in an aspect, is illustrated in processor memory 406. Second translation 408 may be a machine code translation executable by a processor in the operating environment. In another aspect, second translation 408 may be translatable into an executable machine code translation. Loader system 400 may include and/or otherwise interoperate with a compilation system.

Translating first translation 404 may include copying machine code in first translation 404 in an object code translation of source code into second translation 408 in processor memory 406. In another aspect, some or all of second translation 408 may not be a machine code translation, but may rather be translatable into a machine code translation storable in a processor memory for executing.

A processor in an operating environment may have an address space defining a virtual processor memory. Loader system 400 may map at least some machine code in a machine code translation stored in persistent storage into the virtual processor memory without copying the machine code from its current location in an address space of the persistent storage. FIG. 4 illustrates map component 410 in loader 402 that includes logic that provides mapping information to a memory manager component 412. Memory manager 412 may page and/or otherwise copy portions of the machine code in an executable second translation 408 into a physical processor memory based on the mapping information as required for access by the processor. Translating may include resolving unresolved references if any, adding heap and stack space, and initializing processor registers for the executable translation. A memory mapped file is an example of data that may be mapped into a virtual processor memory.

Translating a first translation into a second translation may include translating one or more first translated instruction(s) 414 into one or more second translated instructions 416. For example a byte code translation of an instruction in source code may be translated to a machine code translation of the source code instruction. Symbolic reference may be detected and resolved a linker component 418. Loading and linking may be performed as separate processes or may be performed in a single computing process.

Generating second translation 408 by loader 402 may include loading or copying machine code in first translation 404 into an existing processor memory. In another aspect, loader system 400 may allocate and/or identify a new address space of a processor in an operating environment. The address space includes addresses that define a new processor memory into which the machine code translation or a portion thereof may be loaded and/or into which the machine code translation or a portion thereof may be mapped. First translation 402 may include information, for example in a header, specifying a size and/or amount of memory needed for loading. Loader system 400 may interoperate with a memory manager component 420 to allocate addresses in the address space defining one or more segments in the processor memory. Loader system 400 may read and/or generate machine code for second translation 408 from first translation 402. Loader 402 may store the machine code in the one or more segments of processor memory 406 defined by the addresses allocated from the address space.

Translating first translation 402 into second translation 408 may include writing zeroes or some other specified data into unused and/or uninitialized portions of the one or more segments in the processor memory. Loader 402 and/or memory manager 420 may perform some or all of this operation. For programs that operate according to a stack-based execution model, translating first translation 402 into second translation 408 may include creating one or more stack segments in processor memory 406 by allocating addresses from the address space to define the regions in processor memory 406 for one or more stack segments. Loader 402 and/or memory manager 420 may perform some or all of this aspect of translation.

FIG. 4 illustrates context component 422 in loader 402. Context component 422 may set and store one or more program inputs and/or other run-time information configured for the machine code translation loaded into the processor memory. Translating may include establishing a process context. Context component 422 may configure a process context in which second translation 408 is accessed by a processor of an operating environment. FIG. 4 illustrates initiate component 424 for starting execution. Initiate component 424 may configure a processor to access a machine code instruction in the machine code translation.

When loading by memory mapping, loader 402 may create segments by allocating addresses from an address space as described above. Loader 402 may map machine code in first translation 404 into the one or more segments of processor memory 406 defined by the allocated addresses. This may include mapping portions of first translation 404 into pages and setting permissions for read-only, copy-on-write, or other permission suitable for a page and/or a segment.

Various arrangements set forth in the present disclosure may be implemented utilizing hardware, software, or any desired combination thereof. For that matter, any type of logic may be utilized which is capable of performing the methods and operations described in the present disclosure.

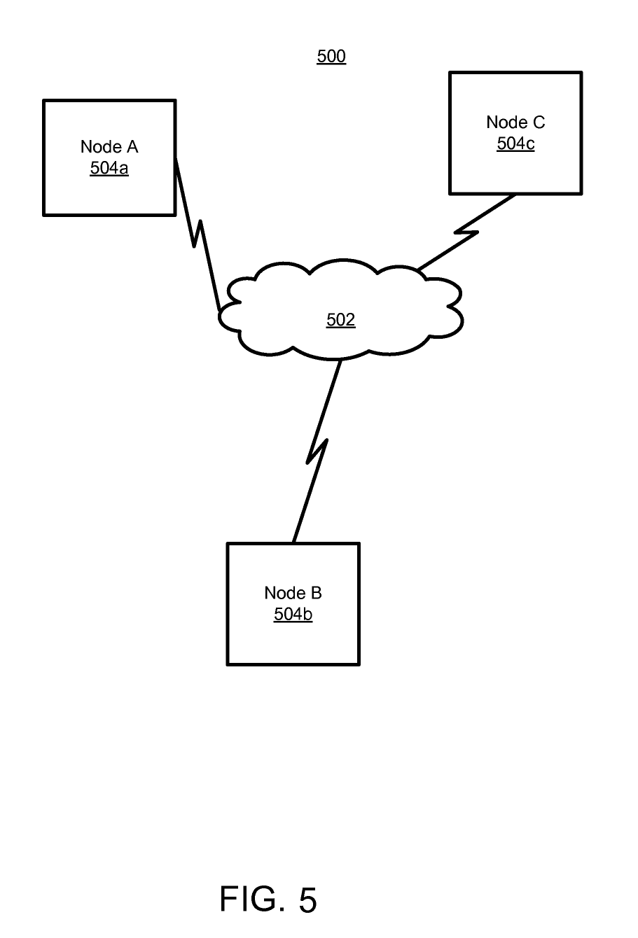

FIG. 5 shows an exemplary system 500. As illustrated, the system 500 may include one or more networks 502. In the context of the system 500, the network(s) 502 may each take any form including but not limited to a local area network (LAN), a wireless network, a wide area network (WAN) such as the Internet, peer-to-peer network, etc. An operating environment, such as any of those described in the present disclosure, may include and/or may be provided by a network node, such as a node 504 of FIG. 5. Code, hardware, and/or other resources for performing any one or more of the methods described in the present disclosure may be included in an operating environment of a node 504.

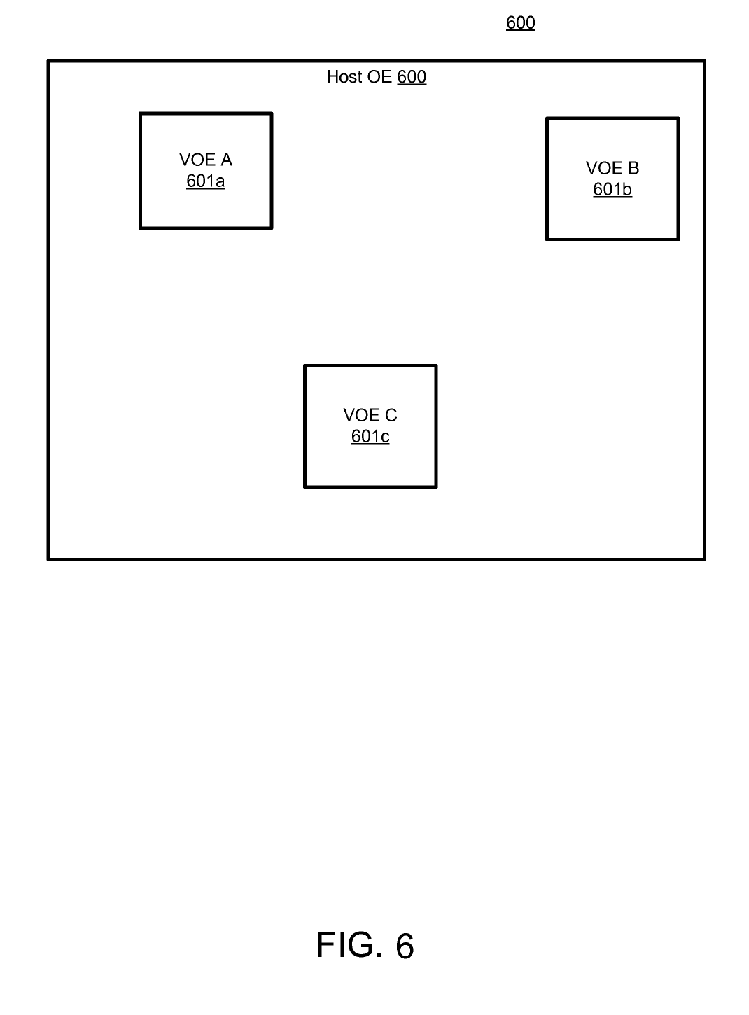

FIG. 6 shows another exemplary system. As illustrated the system may include a host operating environment (Host OE) 600 that may host one or more other virtual operating environments (VOE) 601 such as a virtual machine and/or a process operating environments (defined above), such as a Linux container. A VOE may virtualize software and/or hardware OERs of an operating system, a device, and/or other computing platform. In various aspects, code, hardware, and/or other OERs for performing any one or more of the methods described in the present disclosure may be included in an operating environment that is not virtual, such as host operating environment 600, and/or may be included in one more VOEs 601.

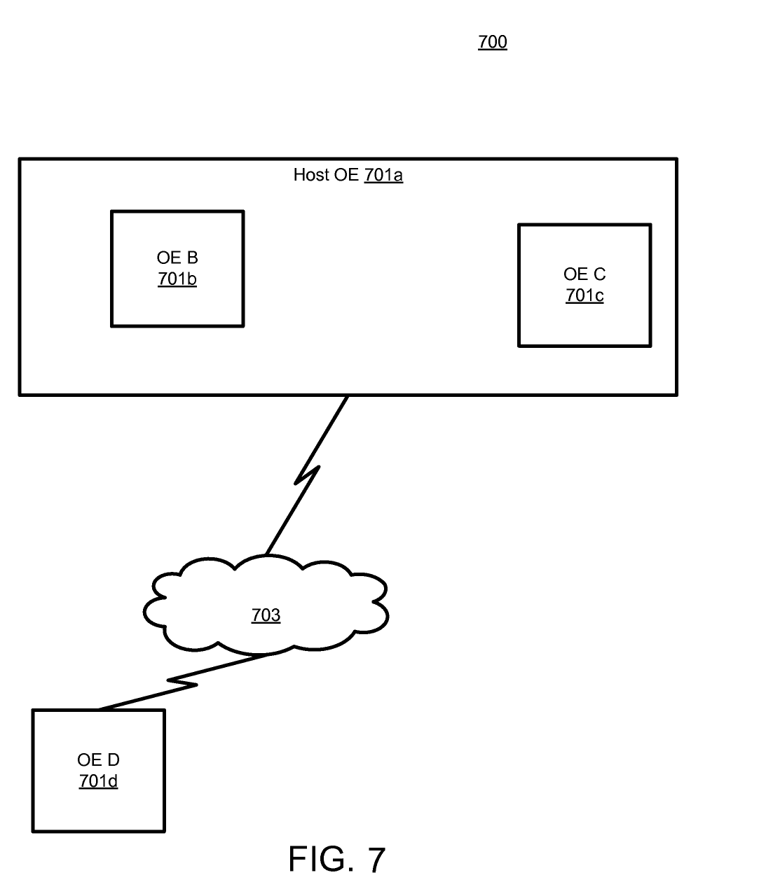

FIG. 7 shows yet another exemplary system 700. Code, hardware, and/or other OERs for performing any one or more of the methods described in the present disclosure may be included in any one or more operating environments 701 illustrated in FIG. 7. FIG. 7 shows that one or more operating environments 701 may be communicatively coupled to each other via a network 703. One or more operating environments, may operate as host operating environments as illustrated by host OE 701a. Host OE 701a may include OE B 701b and/or OE C 701c as virtual operating environments. In another aspect, host OE 702a may be a distributed operating environment that includes OE B 701b and OE C 701c that each respectively include their own hardware and that communicate via a network and/or other communications medium. Any one or more of operating environments 701a-c may interoperate with an operating environment of a remote node, illustrated by OE D 701d via network 703. In various aspects, code, hardware, and/or other OERs for performing any one or more of the methods described in the present disclosure may be included in one or more operating environments 701 of FIG. 7.

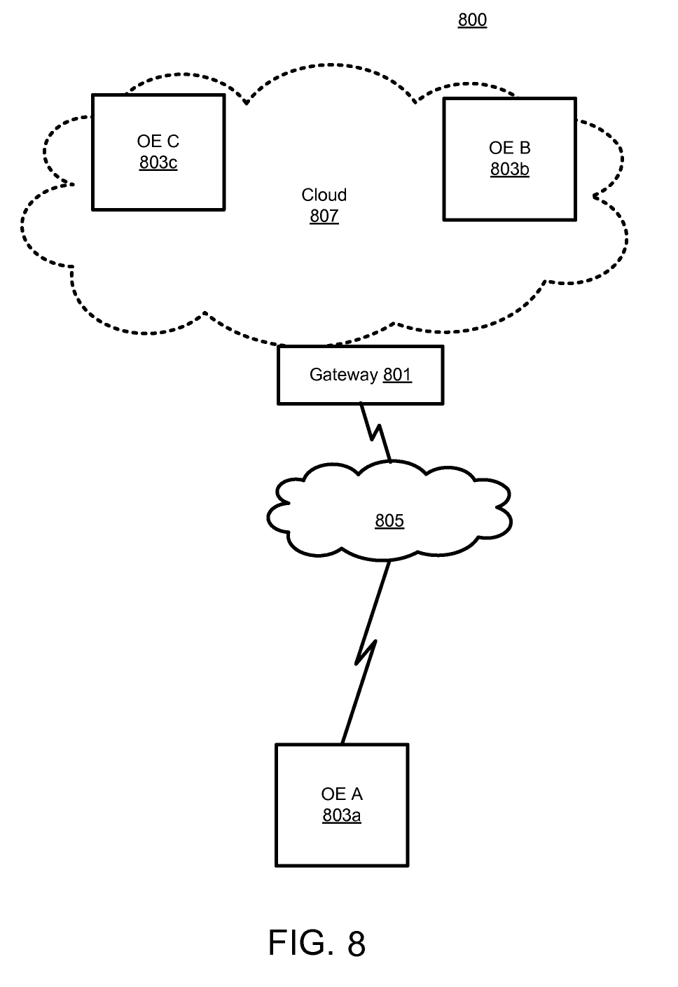

FIG. 8 shows still another system 800. Methods described in the present disclosure may be performed by code, hardware, and other OERs in an operating environment of gateway node 801. Note that gateway 801 is communicatively coupled to a node of OE A 803a via network 805. Gateway 801 is communicatively coupled to OE B 801b and OE C 801c via cloud system 807.

Suitable operating environments for the various methods described in the present disclosure may include and/or may be provided by a network node. Suitable operating environments include host operating environments and virtual operating environment. Suitable operating environments may include more than one node such as an operating environment of a cloud. Some or all of the code, hardware, and/or other OERs included in performing any one or more of the methods described in the present disclosure may be adapted to operate in a number of operating environments. In an aspect, logic of such code may operate as a stand-alone application or may be included in and/or otherwise integrated with another application and/or software system. For example, various methods described in the present disclosure may operate in and/or may otherwise interoperate with a logic translator such a source code editor, compiler, linker, loader, and/or other programming tool. A compiler, linker, loader, and/or other programming tool may each operate as standalone applications or may be integrated and/or included in a hosting application, framework, and/or software platform.

### Methods, Systems, and Operation

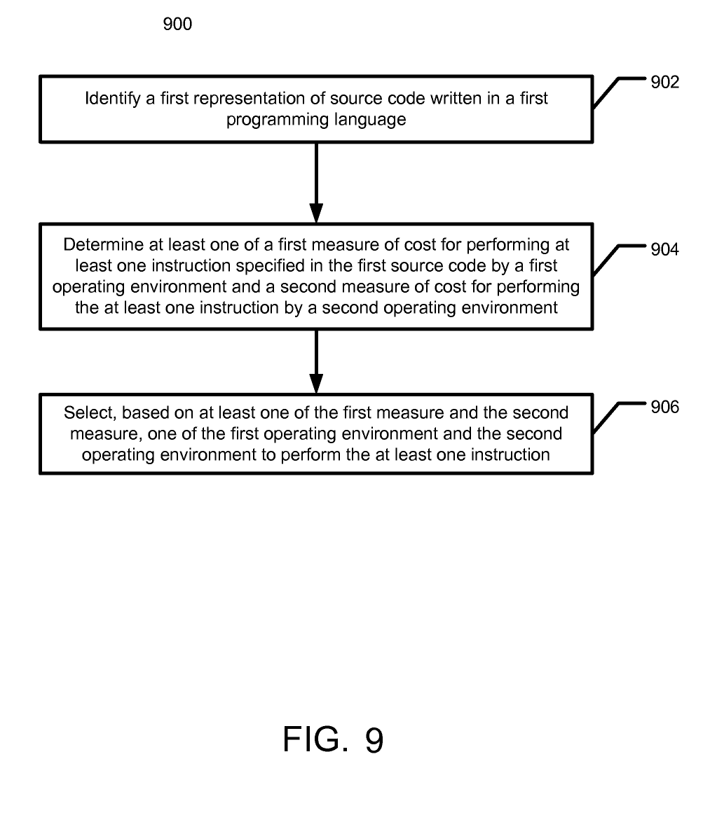

FIG. 9 shows method 900. Method 900 includes identifying a first representation of first source code written in a first programming language. See block 902. Method 900 additionally includes determining at least one of a first measure of cost for performing at least one instruction specified in the first source code by a first operating environment and a second measure of cost for performing the at least one instruction by a second operating environment. See block 904. Also, method 900 includes selecting, based on at least one of the first measure and the second measure, one of the first operating environment and the second operating environment to perform the at least one instruction. See block 906.

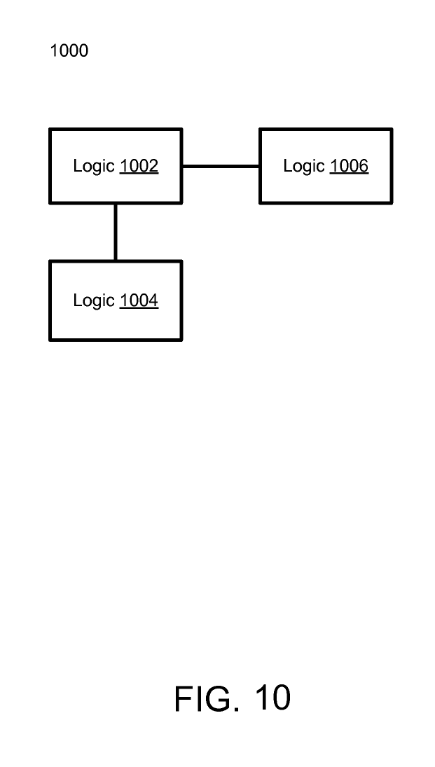

As an option, method 900 may be implemented based on an arrangement 1000 of logic illustrated in FIG. 10, which illustrates logic 1002 that is included in identifying a first representation of first source code written in a first programming language. According to the arrangement 1000, logic 1004 is included in determining at least one of a first measure of cost for performing at least one instruction specified in the first source code by a first operating environment and a second measure of cost for performing the at least one instruction by a second operating environment. Additionally, the arrangement 1000 may include logic 1006 that is included in selecting, based on at least one of the first measure and the second measure, one of the first operating environment and the second operating environment to perform the at least one instruction.

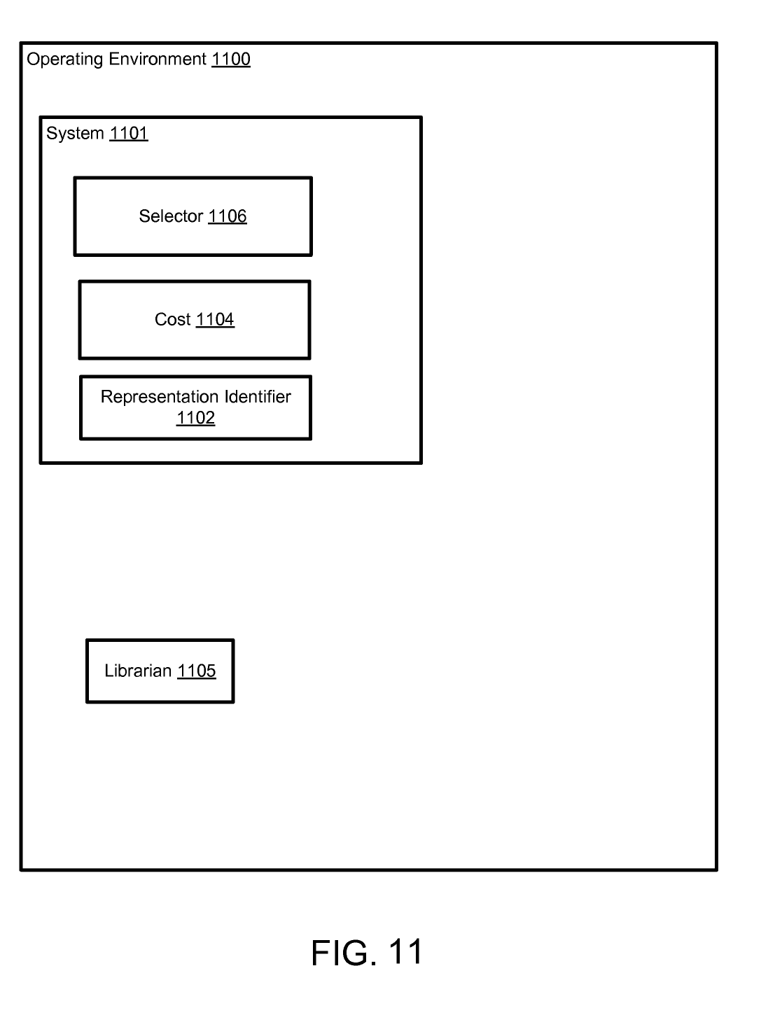

FIG. 11 illustrates an operating environment 1100 that includes logic and/or analogs of logic illustrated in FIG. 10 for performing the method 900 of FIG. 9. Such logic may be included in logic of a system 1101. System 1101, as illustrated, may be a system that operates to generate, select, modify, configure, assemble, and/or otherwise identify, for a given representation of source code written in a programming language, an operating environment to perform an executing of one or more instructions specified in the source code. Various systems analogous to system 1101 are described in the present disclosure that perform one or more of the methods described in the present disclosure that include logic included in performing various methods described herein.

A representation of source code may be a file or other data entity that includes the source and/or includes a translation of the source code such as an object code translation. A representation of source code may be an identifier of the source code and/or a translation of the source code. For example, a file name for an assembler language translation of source code written in another programming language is a representation of the source code as well as a representation of the assembler language translation. Metadata such as an application provisioning profile may be and/or may otherwise provide a representation of source code of the application to be provisioned.

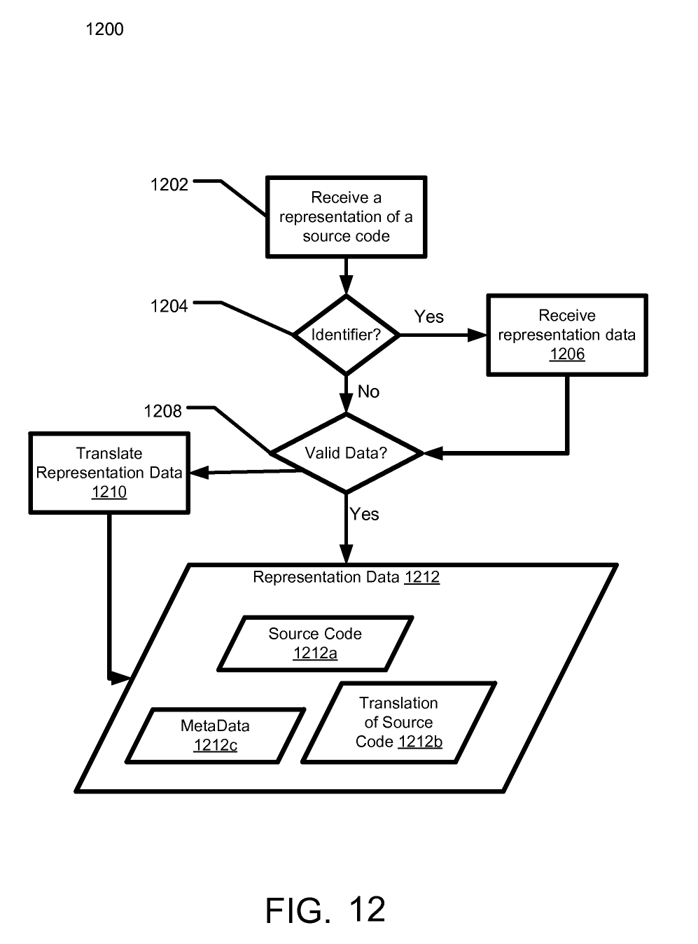

Logic 1002 may be included in a representation identifier component 1102 that when executed identifies a representation of a source code file, component, module, and/or code block. Logic 1002 may provide and/or may otherwise interoperate with an output device to provide a user interface to interact with a user that identifies the representation via an input device, such as a keyboard. Logic 1002 may receive a representation via a command line interface, via a configuration file, via a message received via a network, and/or via a programming interface that allows a representation to be received via interoperation with another process, application, and/or other logic translated from other source code. FIG. 12 illustrates one example of a method 1200 that may be performed in performing the method 900 illustrated in FIG. 9. Block 1202 illustrates an operation that includes receiving data that is representation of source code. The representation may be in any of various suitable forms. Block 1204 illustrates an operation that determines whether the representation is an identifier for accessing one or more of the source code, a translation of the source code, and/or metadata or whether the representation includes one or more of the source code, the translation, and/or the metadata. If the received representation is an identifier, such as a URL or a file name, the operation of block 1206 may be performed to receive and/or otherwise access the data representation (e. g. the source code, the translation, and/or the metadata). Once a data representation is accessed, block 1208 illustrates that an operation that determines whether the data representation is valid for processing. Validity may be determined based on a schema for one or more of the source code, the translation, and the metadata; where a schema identifies one more rules defining valid format(s) and/or a valid vocabulary for part or all of the data representation. If the data representation is not valid, an operation of block 1210 may be performed to translate and/or otherwise correct invalidities to produce representation data 1212. The data representation 1212 may include one or more of the source code 1212a, one or more translations of the source code 1212b, and/or associated metadata 1212c.

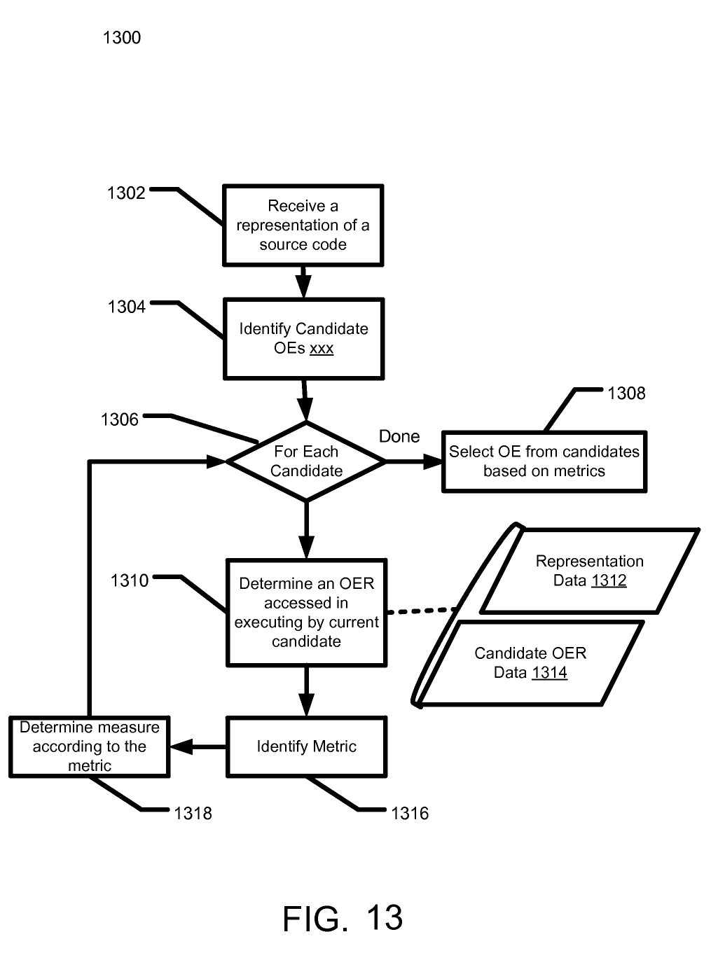

Logic 1004 may be included in a cost component 1104 that may be executed to determine a first measure of cost for performing one or more instructions specified in the first source code by a first operating environment and/or a second measure of cost for performing the one or more instructions by a second operating environment. The one or more instructions may be specified by a line of one or more lines of code or a portion thereof in the source code. The one or more lines may be included in an addressable entity such as function, method, class, aspect, and/or other code block. The one or more instructions may be specified by a data declaration that when translated by a compiler, for example, is translated to one or more instructions that allocate memory for a declared addressable entity or that perform an operation such as serializing access to the declared addressable entity as specified by a key word in the declaration. In one aspect, cost component 1104 may access and/or otherwise receive operating environment information that identifies one or more performance costs for accessing and/or otherwise utilizing OERs included in and/or includable in a particular operating environment that are accessed in performing the one or more instructions. FIG. 13 illustrates one example of a method 1300 that may be included in performing the method illustrated in FIG. 9. Block 1302 illustrates an operation that receives and/or otherwise accesses a representation that may be identified, for example, by logic that performs the method of FIG. 12 that is included in a representation identifier component 1102. Some or all of the method in FIG. 13 may be performed by logic included in a cost component 1104. An operation illustrated in block 1304 may be performed by logic that operates in cost component and/or in librarian component 1105 to identify multiple candidate operating environments. A candidate may be identified based on its accessibility, availability, compatibility with the instruction(s) and/or operation(s) specified in the source code, a user, and/or a security policy—to name just a few examples. In another aspect, candidate operating environments may be prespecified such as in a fixed list or set of records in a data base. The operation of block 1306 may be performed by logic that identifies a current candidate operating environment to evaluate in iterating through the candidate operating environments. The operation of block 1310 may be performed by logic that determines and/or otherwise identifies an OER accessed by the current candidate operating environment in executing an instruction and/or operation specified in the source code of the representation. In an aspect, cost component 1104 including logic for performing the operation of block 1310 may interoperate with logic that analyzes representation data 1312 to identify a reference and/or other access to an OER, such as an OER in an OER Container, for the instruction(s) and/or operation. Additional logic may be included in and/or invoked by cost component 1104 that maps a reference, an instruction, and/or a specified operation to an OER in the current candidate operating environment. The mapping may be performed based on data from the current candidate operating environment, illustrated by candidate OER data 1314, that may be processed in operating environment 1100, processed by the candidate operating environment in response to an exchange with operating environment 1100, and/or that may be processed by another operating environment such as an operating environment that includes a data store that contains a provisioning profile, registry whether dynamic or static, an installable and/or otherwise executable image, and/or other metadata for the current candidate operating environment and optionally other candidate operating environments. The operation of block 1316 may be performed by logic that, in one aspect, identifies a metric for determining a performance cost (as defined above) for the current operating environment. The metric may be the same metric for all candidate operating environments or may differ. Block 1318 illustrates the method in FIG. 13 includes determining a measure according to the metric based on the determination made by performing the operation of block 1310. Once iteration through the candidate operating environments completes, block 1308 illustrates the an operation that may be performed by logic that selects an operating environment from the candidate operating environments as described in more detail below.

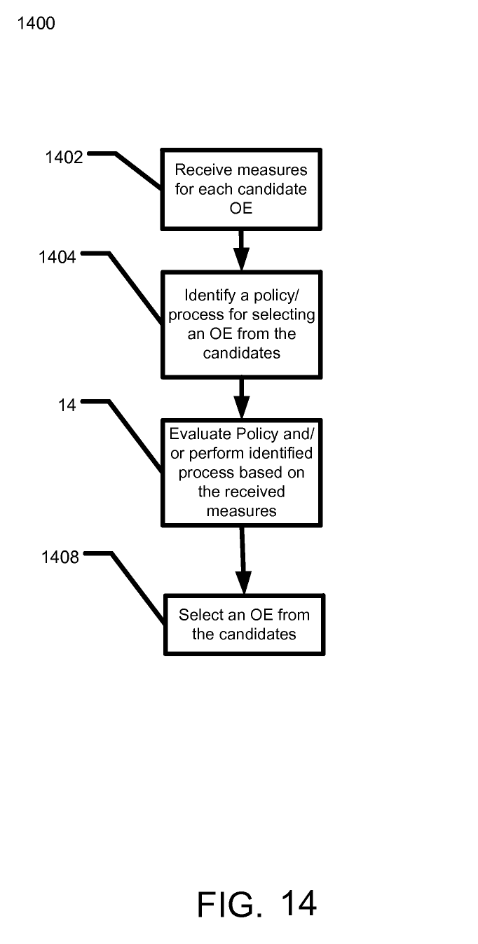

Logic in cost component 1104 may interoperate with logic 1006 in a selector component 1106 that selects and/or matches an operating environment with the one or more instructions to be performed. Logic 1006 may select the operating environment from a number of operating environments based on one or more performance costs associated with OERs required and/or otherwise desired to perform the one or more instructions and/or operations or that may optionally be accessed in performing the one or more instructions and/or operations. FIG. 14 illustrates one example of a method 1400 that may be included in performing the method illustrated in FIG. 9. Block 1402 illustrates the method in FIG. 14 may be performed by logic that receives measures for more than one candidate operating environment. A policy may be retrieved from a storage location in a memory and/or a logic for carrying out a process may be identified for performing the selecting. See block 1404. The identified policy may be evaluated and/or an identified process may be performed to identify an operating environment from candidate operating environments based on the measures associated with each candidate operating environment. See block 1406. An operating environment may be selected as result of performing block 1406. See block 1408.

In response to selecting the operating environment, selector 1106 may send a message via a network and/or may otherwise communicate, directly and/or indirectly, the same and/or a different representation of the source code to the selected operating environment allowing the selected operating environment to perform the one or more instructions and/or operations. For example, selector 1106 may send a provisioning profile identifying an application that includes a translation of the one or more instructions and/or operations to be performed. The application may be a byte code translation of Java source code that specifies the one or more instructions, an object code translation of C language source code, or ECMAScript source code to be translated and/or mapped to machine code by the selected operating environment to perform the one or more specified instructions and/or operations.

For example, cost component 1106 may include logic that identifies a first operating environment that includes a processor that according to a metric for heat generates more heat than a processor in a second operating environment. System 1101 may receive and/or may otherwise identify a first measure for the first operating environment via information received from the first operating environment and/or received indirectly from an operating environment of another node. The first operating environment may be included in operating environment 1100, may share some or all of the same hardware as operating environment 1100, or may include and/or may otherwise be provided by different hardware, such as a different node The first measure and/or the metric for determining the first measure may be specific to the one or more instructions of the source code of the representation identified by representation identifier 1102. The first measure and/or the metric may be more non-specific, relatively speaking. For example, the metric may result in an average temperature of the processor executing over a specified time period whether executing the one or more instructions specified in the particular source code or executing translations of other source code including similar and/or different instructions.

Selector 1106, shown in FIG. 11, may separately or together with one or more other components include logic, such as logic 1006, that during operation is included in determining that a selection criterion, based on a cost for performing the one or more instructions specified in source code, is met. In an aspect, librarian component 1105 may identify one or more candidates, including a first operating environment, to perform the one or more instructions. Selector 1106 may access a selection criterion to determine which, if any, of the candidates meet the criterion. For example, a criterion may be based on a cost of loading an object code translation of a code library accessed in performing the one or more instructions. Each candidate may have metadata that identifies a load cost, which may be measured in time to load, a measure of power and/or energy used in loading, and/or a measure of risk associated with a provider of the respective candidates. One or more candidates may meet the criterion. Metadata may be stored in a data store, as illustrated by operating environment data store 1107. Operating environment data store 1107 may be included in a persistent memory, such as a disk drive, and/or in a processor memory. Selector 1106 may order the candidates, select a best match, and/or determine a candidate to perform the operation in any other suitable manner.

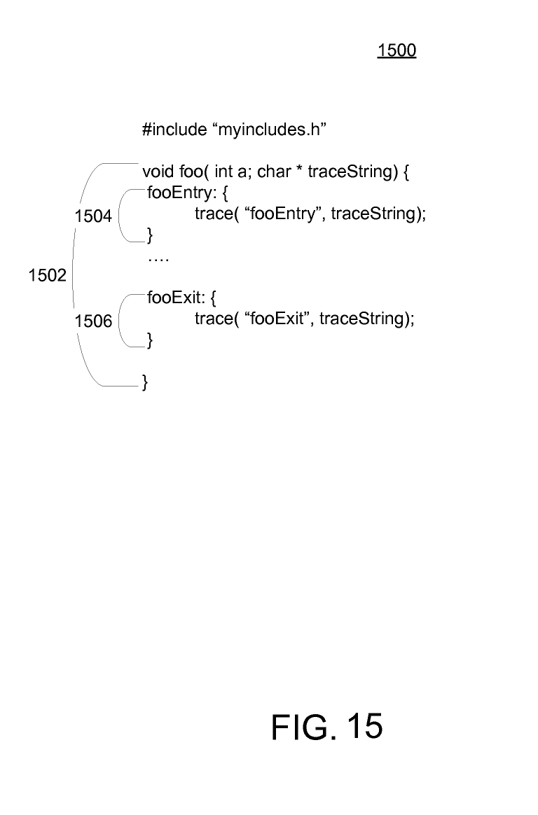

Source code 1500, illustrated in FIG. 15, includes programming language instructions in a specified addressable entity “foo” 1502 in code block 1504 to write an entry into a trace log when addressable entity “foo( )” 1502 is invoked and in a code block 1506 executed just prior to the end of an invocation of “foo( )” 1502 to write another entry to the trace log. Cost logic 1004 and/or an analog included in a cost component 1104 may receive and/or otherwise determine that a cost for writing trace entries to a log in a first operating environment includes a cost of transmitting a log entry via a network to store in a database stored on a hard drive. Cost component 1104 may determine that a transmit time for sending trace entry data via a network for logging exceeds a threshold specified in a policy record. As a result, selector 1106 identifies a second operating environment to perform the instructions specified by code block 1504 and code block 1506. Cost component 1104 may receive profile information for the second operating environment that indicates writing a trace entry incurs a cost for storing trace data to a local data storage device included in a second operating environment. In an aspect, selector component 1106 may select the second operating environment based on a policy that is specified to avoid a data transfer cost via the network. A different policy may be specified that results in a different selected operating environment.

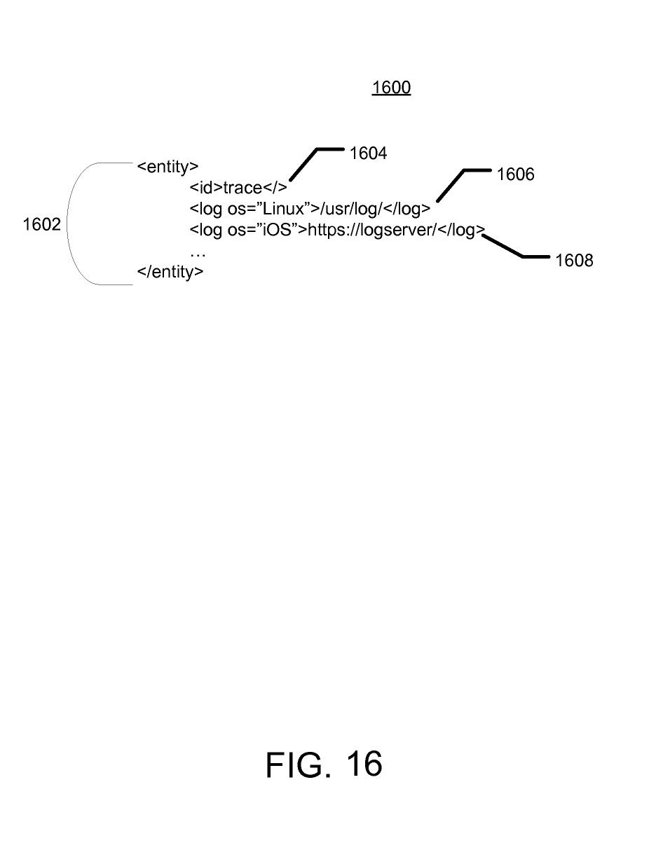

FIG. 16 illustrates metadata 1600 for addressable entity “foo”” 1502. Metadata 1600 includes an entity element 1602 for “trace” 1502 as indicated by an <id> element 1604 that includes the identifier “trace”. The entity element 1602 may be in a larger document for an application, program, and/or software arrangement that is generated from source code that includes code for the trace addressable entity. In another aspect, the trace addressable entity may be included in a library that is accessed by a number of applications. Accordingly, the entity element 1602 may be included in a library that includes metadata for shared addressable entities. In an aspect, a cost component 1104 may include logic that selects from a set of operating environments. The set may include an operating environment that includes a LINUX operating system and an operating environment that includes and iOS operating system. A cost measure may be determined based on a cost metric that is identified based on a storage location of a trace log for a particular operating environment or type of operating environment. A “log” element 1606 identifies a trace log location that is local to an operating environment that includes a LINUX operating system and a “log” element 1608 identifies a location remote from an operating system that includes an iOS operating system. A cost for executing one or more instructions specified by code block 1504 and code block 1506 in each type of operating environment may be determined based on this information.

A system, such as system 1101, may include logic to access and process metadata for a particular source code module, a translation of the source code, a candidate operating environment for performing the one or more instructions specified in the source code, a particular component or type of component in one or more candidate operating environments, and/or metadata for any entity included in determining a measure of cost for performing the one or more instructions and/or operations in a candidate operating environment. For example, metadata may be specific to a legal entity, a region of a network, a time, a day, a geographic region, a user, and a security attribute—to name some examples,

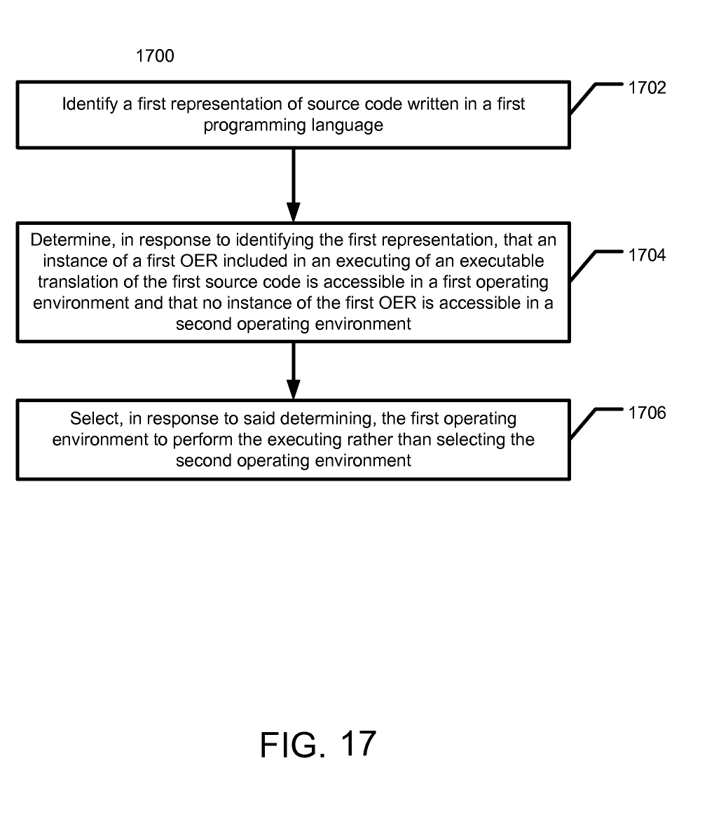

FIG. 17 shows method 1700. Method 1700 includes identifying a first representation of source code written in a first programming language. See block 1702. Additionally, method 1700 includes determining, in response to identifying the first representation, that an instance of a first OER included in an executing of an executable translation of the first source code is accessible in a first operating environment and that no instance of the first OER is accessible in a second operating environment. See block 1704. Also, the method 1700 includes selecting, in response to said determining, the first operating environment to perform the executing rather than selecting the second operating environment. See block 1706

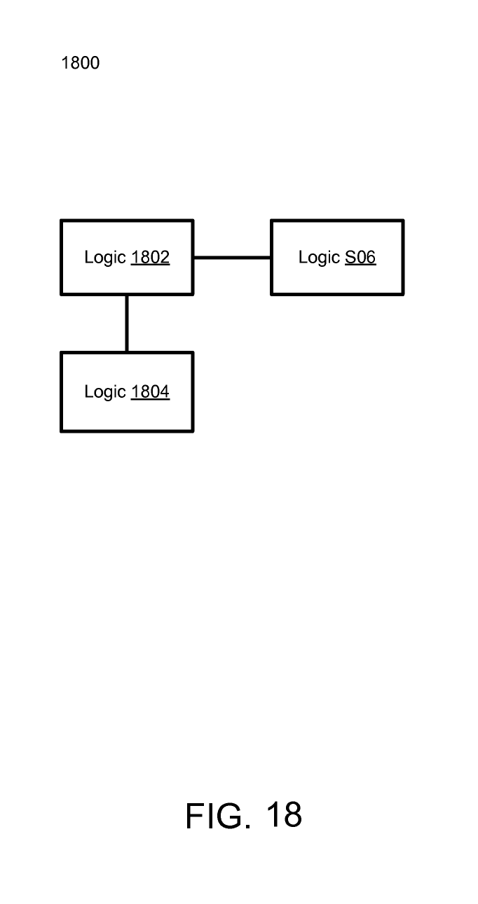

As an option, method 1700 may be implemented based on an arrangement 1800 of logic illustrated in FIG. 18, which illustrates logic 1802 that is included in identifying a first representation of source code written in a first programming language. In the arrangement 1800, logic 1804 may be included in determining, in response to identifying the first representation, that an instance of a first OER included in an executing of an executable translation of the first source code is accessible in a first operating environment and that no instance of the first OER is accessible in a second operating environment Additionally, the arrangement 1800 may include logic 1806 that is included in selecting, in response to said determining, the first operating environment to perform the executing rather than selecting the second operating environment.

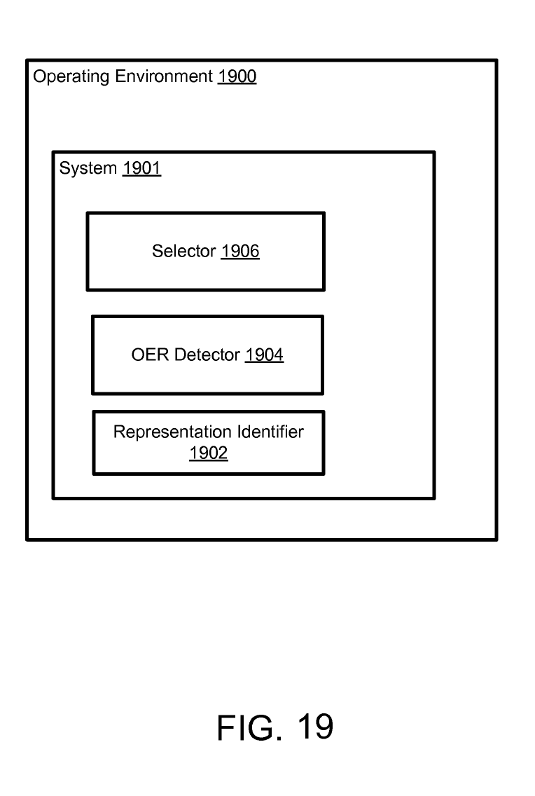

FIG. 19 illustrates an operating environment 1900 that includes logic and/or analogs of logic for performing the method of FIG. 17. Such logic may be included in logic for a system 1901. System 1901 in an aspect may process source code, a translation of the source code, and/or metadata included in and/or otherwise provided with source code and/or a translation of the source code to select a suitable operating environment for performing an operation specified by one or more instructions specified in the source code. A symbol table is an example of metadata suitable for identifying OERs of an operating environment that are included in performing one or more instructions specified in source code. A symbol table may include entries for OERs that directly and/or indirectly identify an output device, an input device, a network device, a device driver, a graphics component and/or subsystem, a network protocol, a peripheral device, a protocol for communicating with a peripheral device, a user interface metaphor, a user interface element, a data store, a file system, a database, an authentication capability, an authorization capability, a data manipulation operation such a copy or delete, a backup component, and the like. Operating environment OERs may be identified, for example, by name, by a schema for exchanging data, by a capability, by a performance attribute, and/or by a type or category—to name a few examples.

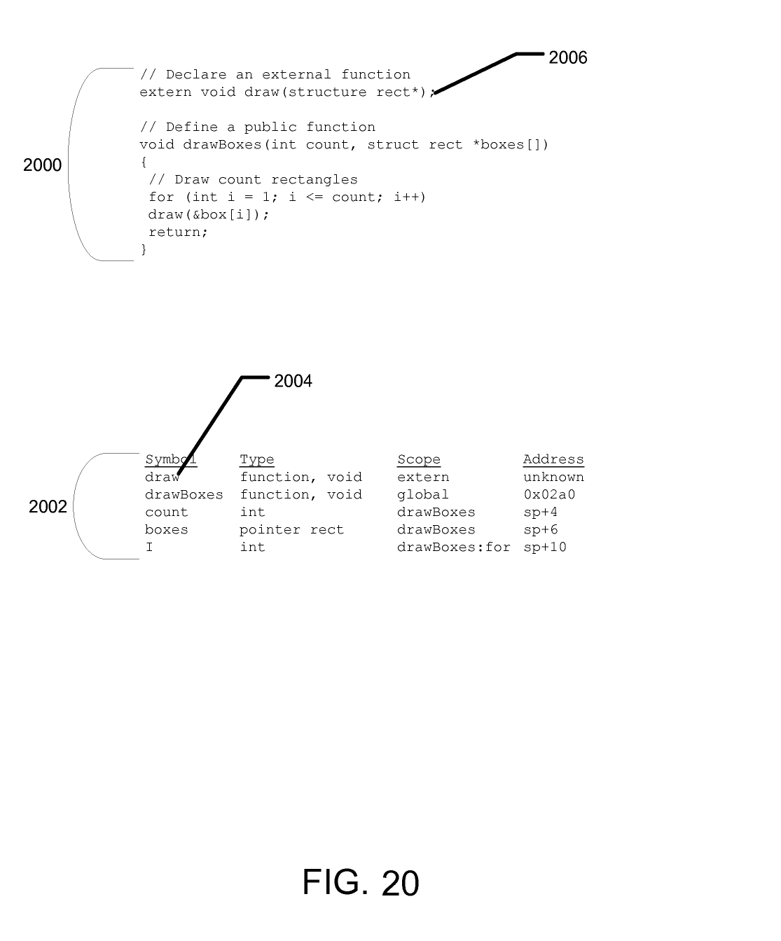

Embodiments of logic for identifying a representation of source code written in a programming language, where the source code specifies an instruction and/or an operation are described above with further alternatives and additional aspects described in various other locations below. Logic 1802 may embody any of the various arrangements, described in the present disclosure, and/or analogs of the various arrangements that operate to identify a representation of source code. In an aspect, representation identifier 1902 may include logic that identifies a symbol table as a representation of source code. The symbol table may be in and/or otherwise associated with a translation of the source code. In an aspect, a translator may include logic that generates a symbol table and/or otherwise identifies references that may be included in generating a symbol table as described in more detail below. For example, representation identifier 1902 may receive a name of a file including a translation of source code, such as illustrated by source code 2000 in FIG. 20. The translation may include object code generated by a compiler. The compiler may provide a symbol table in the file with the object and/or as separate associated data. FIG. 20 illustrates one possible symbol table 2002 that may be generated from source code 2000

Logic 1804 and/or an analog may be included in an OER detector component 1904 in FIG. 19. When executed the logic included in OER detector 1904 may determine, for an operating environment, whether an identified OER is accessed by the operating environment in executing an executable translation of an instruction specified in the source code. In one aspect, OER detector 1904 may access and/or may otherwise receive operating environment information that identifies one or more OERs included in and/or includable in a particular operating environment. For example, OER detector may access a registry, such a MICROSOFT WINDOWS registry, to identify one or more types of input devices in a particular operating environment. In FIG. 20, symbol table 2002 includes a “draw” symbol row 2004 generated based on statement 2006 in source code 2000. Statement 2006 and symbol row 2004 identify an external symbol that an executable translation of source code 2000 is linked to in order to send presentation data to a presentation space of an operating environment executing the executable translation.

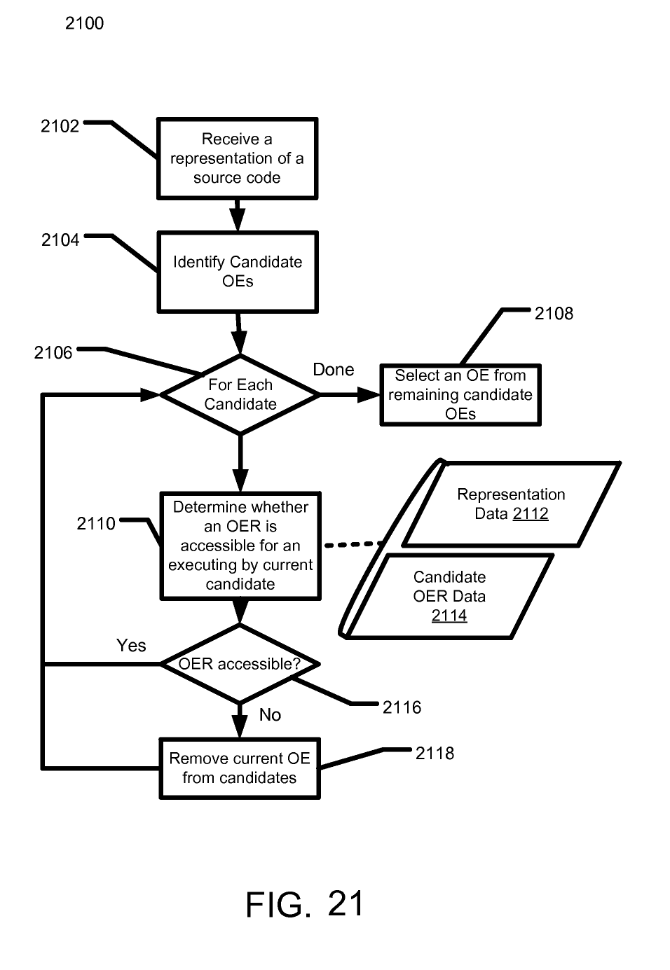

FIG. 21 illustrates one example of a method 2100 that may be included in performing the method illustrated in FIG. 17. The method of FIG. 21 includes receiving and/or otherwise accessing a representation, identified for example via interoperation with logic in representation identifier 1902. See block 2102. Logic to perform the method in FIG. 21 may be included in OER detector 1904. The operation of block 2104 may be performed the logic that may operate in OER detector 1904 and/or a network directory or librarian component (not shown) to identify multiple candidate operating environments. A candidate may be identified as described elsewhere in the present disclosure. The method of FIG. 21 also include identifying a current candidate operating environment to evaluate in iterating through the candidate operating environments. See block 2106. Block 2110 illustrates that the method 2100 may additionally include determining and/or otherwise identifying an OER included in executing an instruction and/or performing an operation specified in the source code is accessible to the current candidate operating environment. In an aspect, such logic may analyze representation data 2112 to identify a reference and/or other access to an OER, such as an OER in an OER Container, for the instruction(s) and/or operation. Additional logic may be included in and/or invoked by OER detector 1904 that maps a reference, an instruction, and/or a specified operation to an OER needed to execute the instruction and/or operation by the current candidate operating environment. Block 2110 may be performed by logic that processes metadata for the current candidate operating environment that identifies OERs that are accessible to the current candidate operating environment. Alternatively or additionally, such data may be maintained in the current candidate operating environment and a request to determine whether an OER is accessible may be sent by logic performing the operation in block 2110. Logic that determines whether an OER is accessible may be processed in operating environment 1900, processed by a candidate operating environment in response to an exchange with operating environment 1900, and/or may be processed by another operating environment such as an operating environment that includes a data store that contains a provisioning profile, registry whether dynamic or static, an installable and/or otherwise executable image, and/or other metadata for the current candidate operating environment and optionally other candidate operating environments. Block 2116 may be performed by logic that, in one aspect, receives a determination as to whether an OER for performing a specified instruction and/or operation is accessible to a current candidate operating environment. When the OER is not accessible, logic to perform the operation illustrated in block 2118 may be invoked to remove the current candidate from the candidates from which a selection is to be made. Otherwise the current candidate remains included and/or is otherwise included in a group of candidate operating environments from which an operating environment is selected. The operation of block 2108 may be performed by logic that selects an operating environment from the candidate operating environments as described elsewhere in the present disclosure. Selecting may be performed according any of the various methods described in the present disclosure. For example, if more than one operating environment remains after iteration through the candidates, a selection may be made based on a performance metric as described above in the context of the method of FIG. 9.

In another example, source code may include a symbolic reference to logic that accesses an audio device to play a sound. An environment detector may communicate with one or more operating environments and/or agents of operating environments to determine whether they each include, for example, an audio device and/or a driver to access an audio component. An agent for an operating environment may include a data store that includes a profile or record of OERs in the operating system and/or that may be added or removed from the operating system.

OER detecting logic may determine whether an OER accessed in executing an executable translation of an instruction specified in source code is included in and/or otherwise accessible to a particular operating environment. For example, an OER detector may scan a file system or may request that the file system be scanned to identify, for example, code libraries, device drivers, and/or hardware profiles in an operating environment. An OER detector may interoperate with a code for a registry and/or may process data in a registry that maintains a database or records of code libraries for one or more operating environments. The OER detector logic may receive information from the database that identifies whether an operating environment includes an addressable entity suitable for resolving the reference identified by in a symbol table.

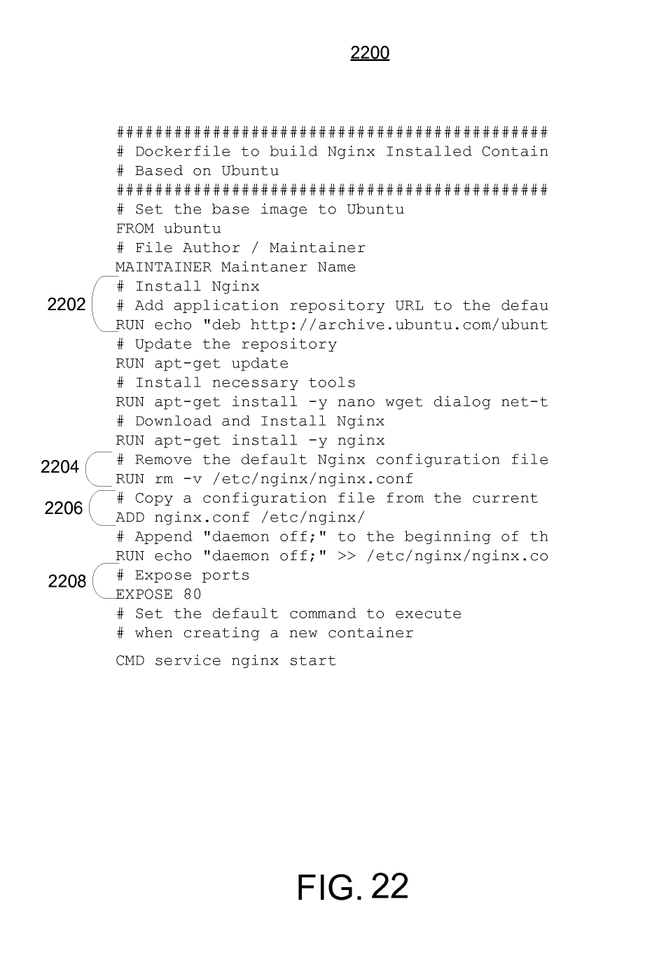

In yet another aspect, logic 1804 may generated from source code written to process a provisioning profile for an operating environment. FIG. 22 illustrates a provisioning profile 2200 that is written as a DOCKER file to build a Linux container (i.e. a COE). Code may be written that detects components and/or other portions included in the COE provisioned and/or yet to be provisioned. Provisioning command 2202 indicates that the provisioned COE includes a version of a UBUNTU operating system (a Linux variant). Information about OERs included in the provisioned COE can be detected directly and/or indirectly from such commands. Provisioning command 2204 and provisioning command 2206 identify information that identifies how the provisioned COE is configured providing additional information about OERs that are accessible and that are not accessible. Provisioning command 2208 identifies a network port (an OER) that is accessible with details indicating that it is accessible for listening for messages received via a network.

As previously described, logic for performing the various methods described in the present disclosure may be included in a translator. For example, with respect to the method of FIG. 17, logic illustrated in FIG. 18 and/or analogs thereof may be included a translator. In an aspect, logic 1802 and/or analogous logic may be included in front-end logic 310 in compilation system 300 in FIG. 3 described above. Front-end 310 as described above identifies a representation of source code 302. Also, a compilation system may include logic 1804 and/or analogous logic in an OER detector (not shown that operates as described with respect to OER detector 1904 in FIG. 19 to determine whether an OER accessed in performing a translation of one or more instructions 304 specified in source code 302 is included in and/or otherwise accessible in various operating environments that are candidates for performing the at least some of the instructions specified in source code 302.

Referring to FIG. 5 and FIG. 3, compilation system 300 may operate in an operating environment of node A 504a. Node A 504a may communicate via network 502 with node B 504b and with node C 504c to determine whether they each include and/or have access to an OER accessed in performing one or more instructions specified in source code 302, such an audio device as described above. Environment detector logic in compilation system 300 may determine that an instance of such an OER is accessible to an operating environment of node B 504b for performing a first instruction specified in the source code and that no instance of the OER is accessible to an operating environment of node C 504c for performing the first instruction.

An adaptation and/or analog of the logic 1806 illustrated in FIG. 18 may be included in logic of a middle-end component (not shown). A phase, when performed, may produce a translation of source code 302. The translation generated may be based on an operating environment selected for performing some or all of the instructions specified in source code 302. Logic 1806 illustrated in FIG. 18 may be included in selector logic included compilation system 300. Selector logic may select the operating environment of node B 504b rather than the operating environment of node C 504c to perform the instruction that accesses an audio device, based on the determination of environment detector logic. Selector logic may instruct back-end 312 to generate object code suitable for the operating environment of node B 504b to execute a translation of instructions 304 of source code 302 rather than generating object code suitable for the operating environment of node C 504c.

Compilation system 300 may generate target translation 306 for translating to a machine code translation that is executable in an operating environment selected according to the method of FIG. 17. Compilation system 300 may generate target translation 306 to be translated to a machine code translation executable in one or more selected operating environments that are architecturally equivalent and/or that may be architecturally dissimilar.

FIG. 4 illustrates yet another portion of an operating environment that may include logic to perform the method of FIG. 17. In an aspect, an adaptation and/or analog of logic 1802 may be included in loader 402 as described above. Also, translating first translation 404 may include determining that an instance of an OER is accessible to a first operating environment for performing an instruction and/or operation translated from and specified in source code and that no instance of the OER is accessible to a second operating environment for performing the instruction and/or operation. Logic 1804 may be included in a context component 422 in loader 402. For example, first translation 404 may include an unresolved reference to a component of an operating environment that accesses an interprocess communication mechanism such as a data stream accessed via a socket. Context 422 may communicate with one or more candidate operating environments to determine whether they each include data stream interprocess communication OERs and/or a suitable interface for interoperating with an executable translated from first translation 404. Logic 1806 may be included in load system 400 that when executed selects the operating system that includes a suitable data stream interprocess communication mechanism, such as an interprocess socket in a UNIX type operating system. Operating environments that do not includes a suitable data stream mechanism are not selected for executing at least the instruction and/or operation specified in the source code.

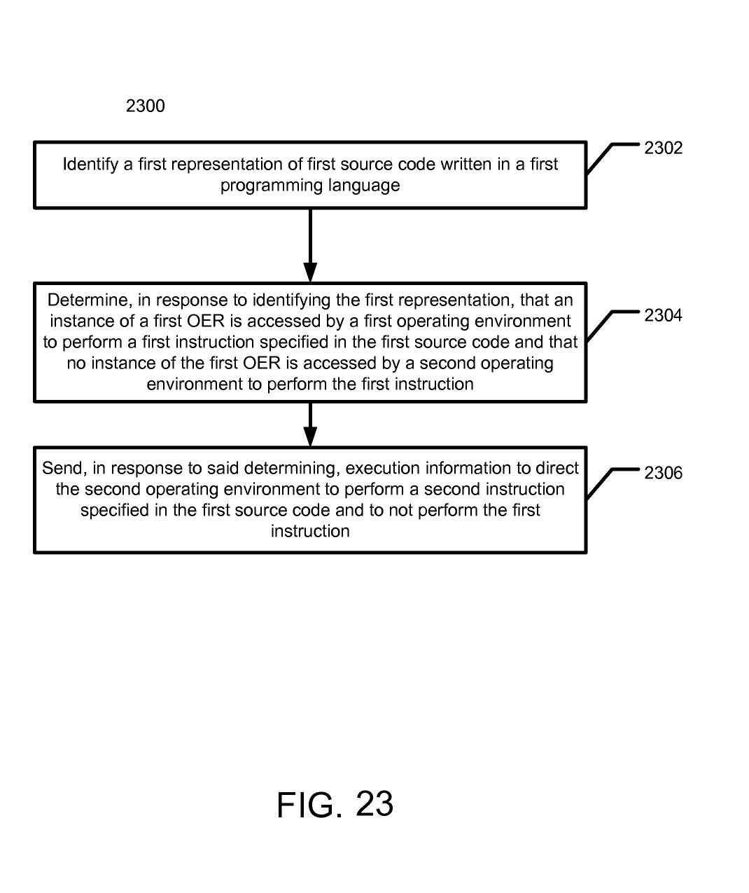

FIG. 23 shows method 2300. Method 2300 includes identifying a first representation of first source code written in a first programming language. See block 2302. Additionally, method 2300 includes determining, in response to identifying the first representation, that an instance of a first OER is accessed by a first operating environment to perform a first instruction specified in the first source code and that no instance of the first OER is accessed by a second operating environment to perform the first instruction. See block 2304. Also, method 2300 includes sending, in response to said determining, execution information to direct the second operating environment to perform a second instruction specified in the first source code and to not perform the first instruction. See block 2306.

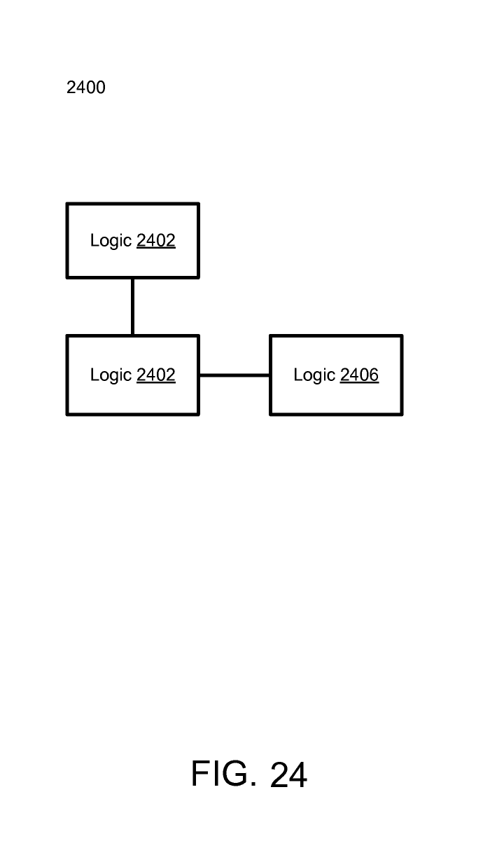

As an option, method 2300 may be implemented based on an arrangement 2400 of logic illustrated in FIG. 24. The arrangement 2400 may include logic 2402 that is included in identifying a first representation of first source code written in a first programming language. The arrangement 2400 may also include logic 2404 that is included in determining, in response to identifying the first representation, that an instance of a first OER is accessed by a first operating environment to perform a first instruction specified in the first source code and determining that no instance of the first OER is accessed by a second operating environment to perform the first instruction. Additionally, the arrangement 2400 may include logic 2406 that is included in sending, in response to the determining operations, execution information to direct the second operating environment to perform a second instruction specified in the first source code and to not perform the first instruction.

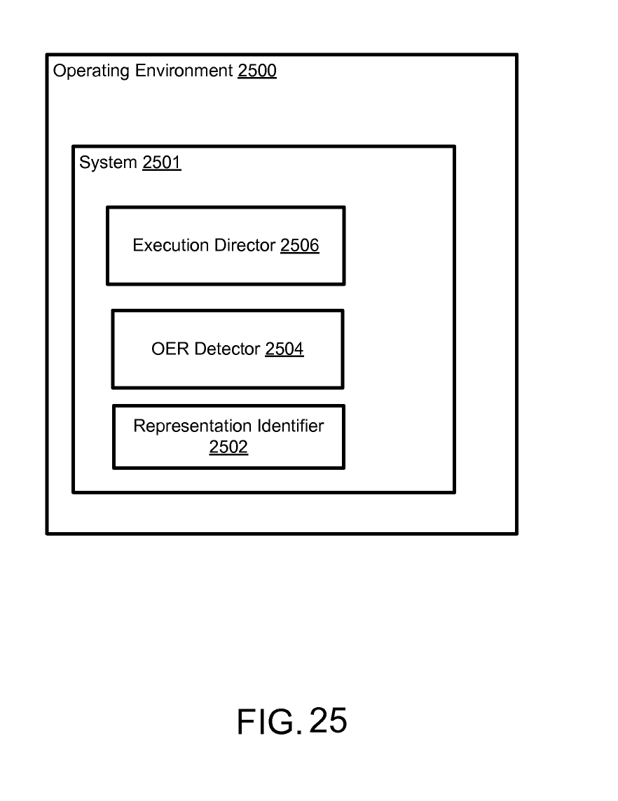

FIG. 25 illustrates an operating environment 2500. Operating environment 2500 may include logic and/or analogs of logic illustrated in FIG. 24 for performing the method of FIG. 23. Such logic may be included in logic of a system 2501, which may be analogous in at least some aspects to one or more other systems described in the present disclosure. System 2501 in an aspect may process source code, a translation of the source code, and/or metadata included in and/or otherwise provided with source code and/or a translation of the source code to select a suitable operating environment for performing one or more instructions specified in the source code via a translation of the one or more instructions. Logic 2402 may be included in representation identifier 2502 that when executed identifies a representation of source code. Such logic has been described above in the context of, for example, FIG. 18 and FIG. 21. Similar and/or otherwise analogous logic 2404 in FIG. 24 may be included in OER detector 2504 that determines, for an operating environment, whether an identified OER is accessed by the operating environment in executing an executable translation of an instruction specified in the source code. OER detector 2504 may access and/or otherwise receive operating environment information that identifies one or more OERs included in and/or includable in a particular operating environment as described above and elsewhere in the present disclosure.

OER detector 2504 may interoperate with logic 2406 in execution director 2506 that may include logic that matches an operating environment with the representation of the source code. The matching may be based on one or more OERs required or optionally accessed in performing one or more instructions specified in the source code. An operating environment may be selected based on the matching where the operating environment does not include and/or does not access an OER in performing the one or more instructions specified in the source code. If there is more than one candidate operating environment, one may be selected according any of the various methods described in the present disclosure.

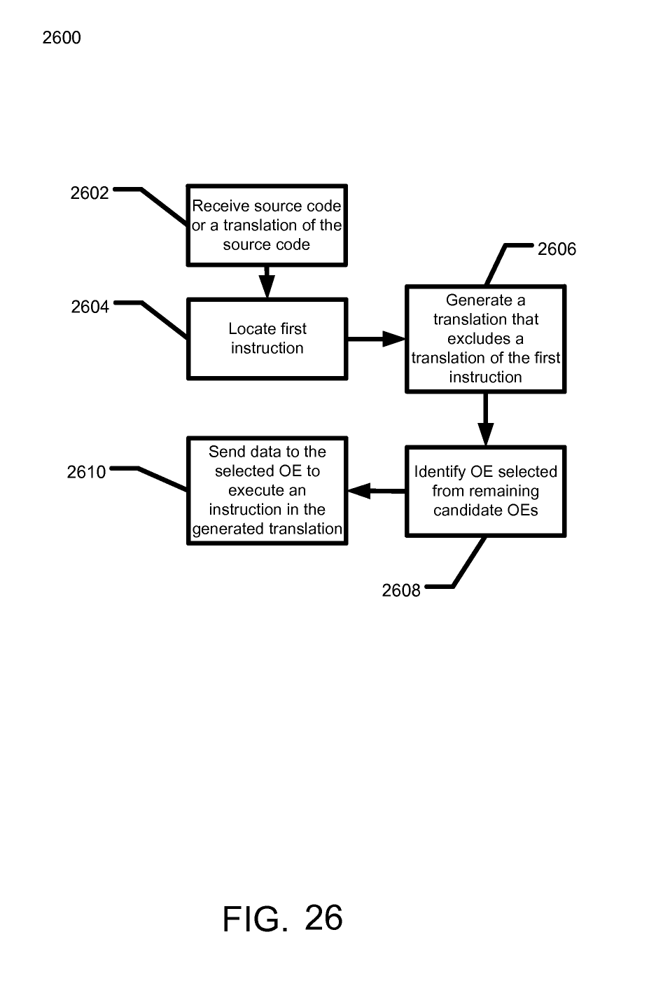

FIG. 26 illustrates a method 2600 that may be performed in performing the method of FIG. 23. The method 2600 of FIG. 26 includes receiving source code, a translation of source code, and/or another representation (such as a provisioning profile and/or configuration data). See block 2602. Logic to perform the operation of block 2602 may be included in an OER detector 2504 and may interoperate with logic in a representation identifier 2502 that receives a representation of the source code. An instruction that when executed accesses and/or causes an access to a specified OER may be detected by logic included in performing the operation of block 2604. The source code that specifies the instruction may be marked as modifiable in one aspect. In another, a translation of the instruction may be marked as modifiable in a translation of the source code. Further still, an addressable entity that includes the instruction and/or a translation of the instruction may be identified in metadata. The addressable entity may be identified as modifiable. The operation in block 2606 may be performed based on logic that translates the source code and/or a translation of the source code. Such logic may also determine that the instruction is configured so that it is not executed or that is modified to execute so as not to result in an access to the specified OER. In one aspect, the translation logic may generate a translation of the source code that does not include a translation of the instruction. An operating environment to execute an instruction specified in the modified translation produces by performing the operation in block 2606 may be identified by logic performing an aspect of the operation in block 2608. Logic to perform the operation of block 2610 may identify a representation to an operating environment identified via logic corresponding to block 2608 to direct the selected operating environment to perform an instruction specified in the modified translation generated by the logic that performed the operation of block 2606.

In various aspects, a removed instruction may be replaced and/or modified so that a particular OER is not accessed. For more information refer to U.S. patent application Ser. No. 12/842,961 filed on 2010 Jul. 23, entitled “Methods, Systems, and Program Products for Processing an Excludable Addressable Entity” and U.S. patent application Ser. No. 12/842,960 filed on 2010 Jul. 23, entitled “Methods, Systems, and Program Products for Excluding an Addressable Entity from a Translation of Source Code” both by the present inventor. Alternatively or additionally new logic may be specified for one more instructions not specified in the source code.

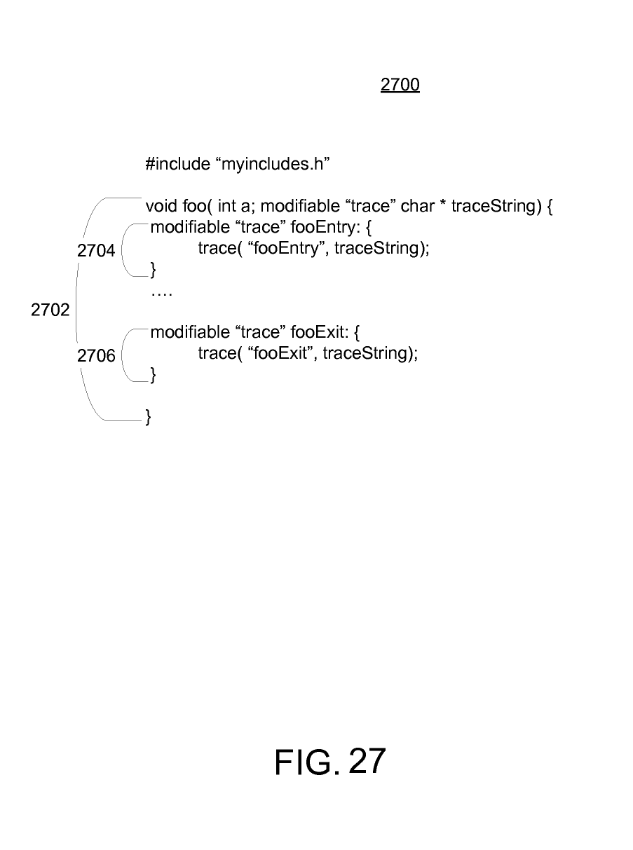

FIG. 27 illustrates source code 2700 that includes a portion of source code that is translatable to executable code for an application. Source code 2700 includes instructions for an addressable entity specified as a function 2702 specified with the name “foo”. The function 2702 includes a first code block 2704 to write an entry into a trace log when execution of an instance of function 2702 begins and a second code block 2706 to write an entry to a trace log as the execution ends. Tracing upon initiation and/or exit of the function 2702 is identified as optional or modifiable by a keyword “modifiable” of the programming language. Writing to the trace log may include writing to a location in processor memory, writing to a location in a persistent memory, sending a message via a network to write to a trace log maintained in a remote node, and/or writing to a presentation space of an output device.

A translator may be configured to exclude addressable entities labeled with a “trace” tag. For example, selector 2506 in FIG. 25 may detect that tracing for one or both of the code blocks 2704, 2706 may be disabled according to a configuration parameter accessible to system 2501. OER detector 2504 may determine that a first operating environment has one or more OERs accessed in executing one or more instructions specified in code block 2704 and/or code block 2706. OER detector 2504 may further determine that a second operating environment has no such OER and/or does not have one of the OERs accessible to the first operating environment to execute an instruction specified by source code in code block 2704 and/or code block 2706. System 2506 may include logic that selects the second operating environment based on the lacking OER(s). Selector 2506 may include logic that selects the second operating environment based on a condition that when met identifies the second operating environment is more efficient according a specified metric that is based on one or more of the OERs accessed in performing a instruction specified in code block 2704 and/or code block 2706.

In another example, source code may be written that accesses a sound card to present audio output. Audio output may be undesirable in certain situations, such as in a library. An operating environment without a sound card may be detected to execute one or more of the instructions specified in the source code. In an aspect, logic in a translation of the source code that accesses a sound card may be removed in generating an executable translation for a selected operating environment. This may reduce data transferred to the selected operating environment. The operating environment may operate more efficiently given that it does not include an unneeded OER for the particular execution of the executable code. Similarly, various types of input OERs, output OERs, data storage OERs, and/or communications OERs may be accessed in some contexts and not in others. The method illustrated in FIG. 23 may allow an operating environment to be selected that matches the OERs needed for a particular execution. Matching may be policy based and/or may be determined based on any number of system and/or user specified conditions.

A translator may include logic 2402 to identify and/or otherwise receive a representation of source code, which may include source code 2700. A translator may also include logic 2404 that operates based on the received representation of source code including source code 2700 to determine whether an OER accessed in performing one or more instructions specified in source code 2700 is included in and/or otherwise accessible in various operating environments that are candidates for performing at least some of the instructions specified in source code 2700. Further, an adaptation and/or analog of the logic 2406 illustrated in FIG. 24 may be included in a translator. Logic 2406 in the translator may select one operating environment rather than another operating environment to perform instructions specified in the function 2702 and not to perform instructions specified in one or both of code block 2704 and code block 2706.

For example, FIG. 2700, illustrates source code that includes an instruction that may access a data stream to write trace records. An operating environment A (OE A) may include a code library for writing to an in memory trace log. Other instructions in source code may not require an in memory data stream. The instructions in the source code that access the in memory data streaming OER may be labeled as modifiable by a key word of the programming language. A configuration file associated with the source code or a translation of the source code may be configured to indicate that the tracing code should not be included. An operating environment B (OE B) may include OERs for executing instructions specified in source other than the trace instructions. Logic 2406 illustrated in FIG. 24 may be included in a translator which may select one operating environment rather than the other operating environment to perform the instructions in source code other than the modified and/or removed trace instructions, based on the determination performed by logic 2404. The translator may instruct back-end logic to generate object code suitable for the selected operating environment to perform the instructions specified in the source code without the included tracing instructions rather than generating object code suitable for some other operating environment. The object code for the selected operating environment may or may not include the tracing instructions. In either case, the tracing function is modified so that OERs for in memory data streaming are not accessed in executing the resulting executable code translated from the source code

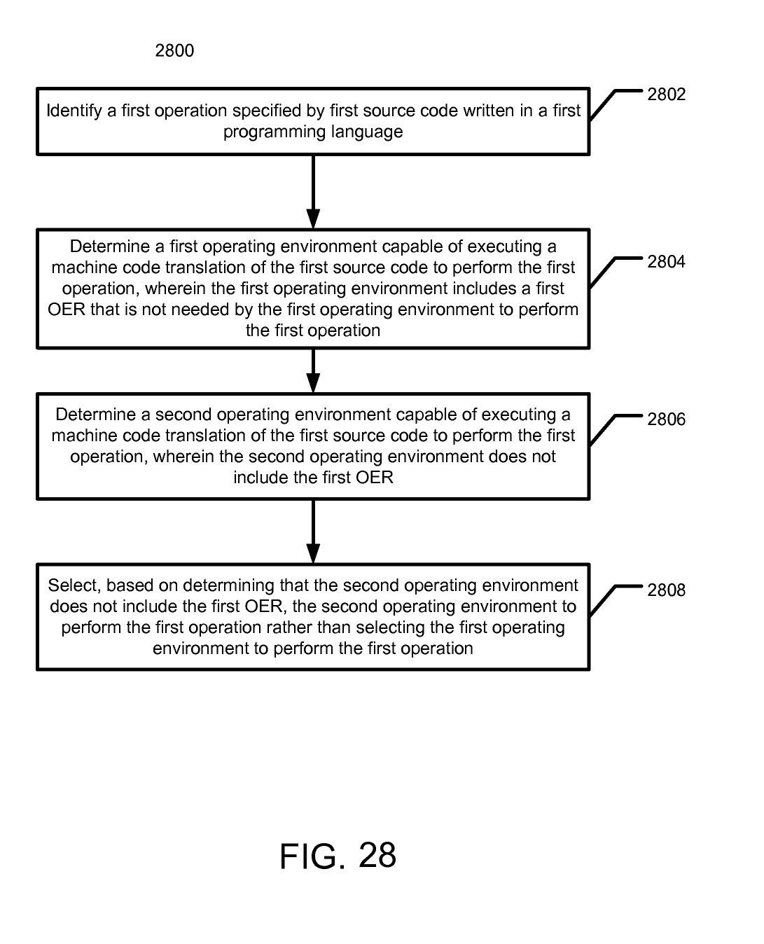

FIG. 28 shows method 2800. Method 2800 includes identifying a first operation specified by first source code written in a first programming language. See block 2802. Additionally, method 2800 includes determining a first operating environment capable of executing a machine code translation of the first source code to perform the first operation. The first operating environment includes a first OER that is not needed by the first operating environment to perform the first operation. See block 2804. Also, method 2800 includes determining a second operating environment capable of executing a machine code translation of the first source code to perform the first operation. The second operating environment does not include the first OER. See block 2806. Further, method 2800 includes selecting, based on determining that the second operating environment does not include the first OER, the second operating environment to perform the first operation rather than selecting the first operating environment to perform the first operation. See block 2808.

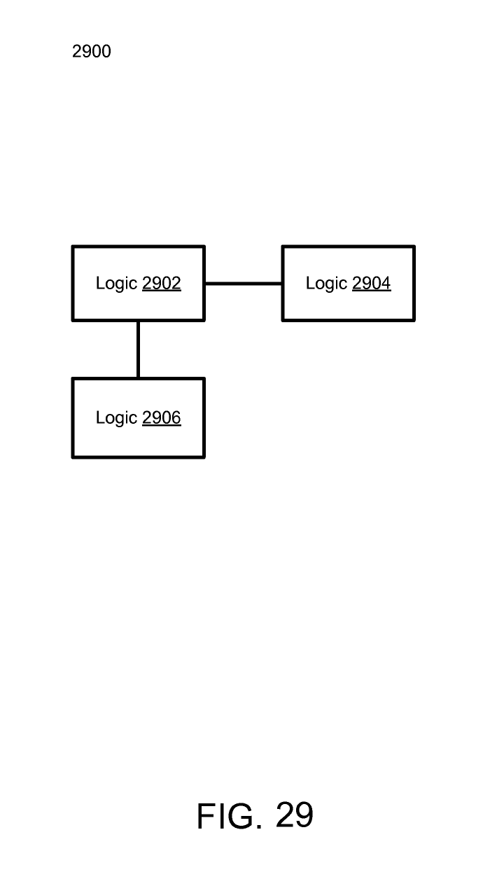

As an option, method 2800 may be implemented based on an arrangement 2900 of logic illustrated in FIG. 29. In the arrangement of FIG. 29, logic 2902 is included in identifying a first operation specified by first source code written in a first programming language. The arrangement 2900 may also include logic 2904 that is included in determining a first operating environment capable of executing a machine code translation of the first source code to perform the first operation, where the first operating environment includes a first OER that is not needed by the first operating environment to perform the first operation. Additionally, logic 2904 may also operate in determining a second operating environment capable of executing a machine code translation of the first source code to perform the first operation, wherein the second operating environment does not include the first OER. The arrangement 2900 may further include logic 2906 that is included in selecting, based on determining that the second operating environment does not include the first OER, the second operating environment to perform the first operation rather than selecting the first operating environment to perform the first operation.

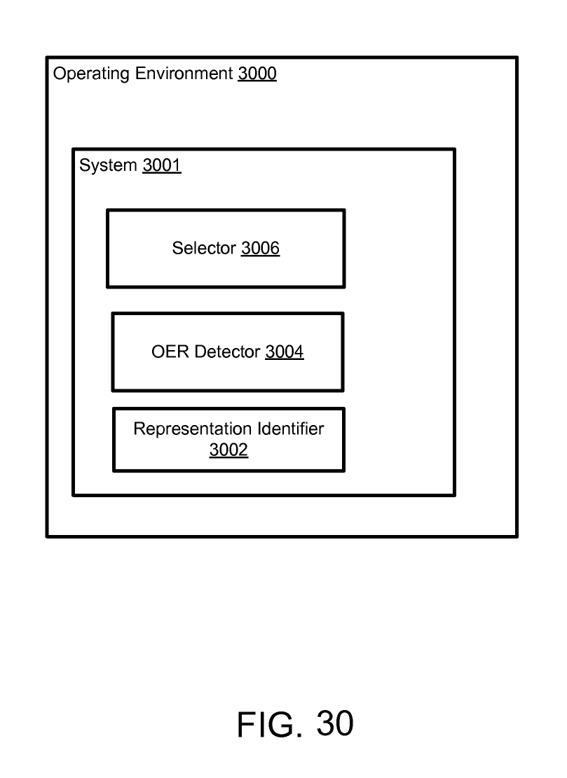

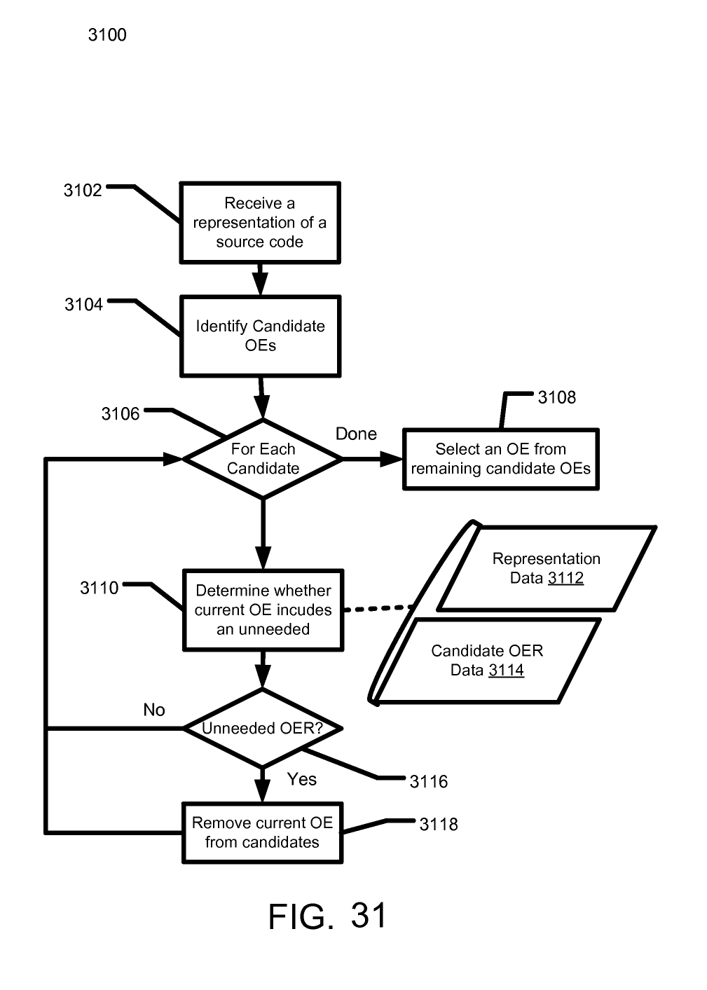

FIG. 30 illustrates an operating environment 200 that includes logic and/or analogs of logic illustrated in FIG. 29 for performing the method of FIG. 28. Such logic may be included in logic of a system 3001, which may be analogous in at least some aspects to one or more other systems described in the present disclosure. Logic 2902 may be included in representation identifier 3002 that when executed identifies a first operation specified by first source code written in a first programming language. Logic 2904 may be included in OER detector 3004 that determines and/or otherwise identifies a first operating environment capable of executing a machine code translation of the first source code to perform the first operation and further determine that the first operating environment includes a first OER that is not needed by the first operating environment to perform the first operation. Logic 2904 in OER detector 3004 may also determine a second operating environment to perform the first operation including executing a machine code translation of the first source code, where the second operating environment does not include the first OER. FIG. 31 illustrates one example of a method 3100 that may performed in performing the method illustrated in FIG. 28. The operation of block 3102 may be performed by logic that receives and/or otherwise accesses a representation that, for example, may be identified by a representation identifier 3002. Some or all of the logic in FIG. 31 may be included in OER detector component 3004. Logic to perform the operation of block 3104 may operate in OER detector 3004 to identify multiple candidate operating environments as described elsewhere in the present disclosure. Logic to perform the operation of block 3106 may identify a current candidate operating environment to evaluate in iterating through the candidate operating environments. Logic to perform the operation of block 3110 may determine and/or may otherwise identify an OER in the current candidate operating environment that is unneeded in executing an instruction and/or operation specified in the source code. In an aspect, OER detector component 3004 including logic to perform to operation of block 3110 may interoperate with logic that analyzes representation data 3112 to identify a reference to and/or otherwise identify an OER that is accessed, such as an OER in an OER Container, for the instruction(s) and/or operation. Additional logic may be included that analyzes current candidate OER data 3114 to identify an OER that is not needed. For example, the unneeded OER may be in a code library and/or may be a network protocol component. The presence of some OERs, as has been described above, may be detectable via a provisioning profile such as a DOCKER file, in a boot configuration file, a startup file, and/or other configuration data. Logic to perform the operation of block 3116 may identify whether the current candidate operating environment includes an unneeded OER. If it is determined that the current candidate operating environment includes an unneeded OR, logic that removes the current candidate operating environment from consideration for selection is executed. See block 3118. Otherwise the current candidate operating environment may remain a candidate operating environment. Logic to perform the operation of block 3108 may be executed to select an operating environment from the candidate operating environments as described in more detail elsewhere in the present disclosure.

Selector 3006 may include logic 2906 that selects, based on determining that the second operating environment does not include an unneeded OER, the second operating environment. The unneeded OER may be any unneeded OER. In another aspect, the unneeded OER may be a specified OER and/or a specified type of OER. An operating environment may be selected using any of the methods and/or variations of methods described in the present disclosure. In some aspects, the iteration process may result in no candidates, one candidate, or multiple candidates.

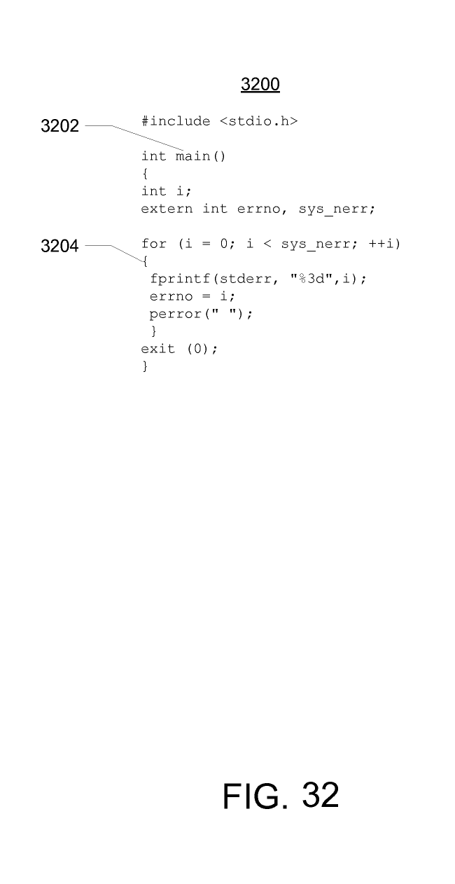

FIG. 32 illustrates source code 3200 written in a version of the C programming language. Source code 3200 is translatable to executable code included in an application. Source code 3200 includes instructions for an addressable entity specified as a function 3202 specified with the name “main”. The function 3202 includes a first code block 3204 that is invoked in a “for” statement for error numbers that have been recorded and are accessible as external data entities with respect to the application generated and/or translated from source code 3200. There are a number of OERs included in many operating environments that are either not accessed and/or otherwise not necessary to perform the operation specified in source code 3200. For example, for source code 3200 a SQL database is not required, a scheduler that supports multi-threaded processes is not required, OERs for programs written in programming languages other than C are not required (such as a Java Runtime Environment (JRE), no interprocess communications mechanisms are required, no data synchronization and/or serialization mechanisms are required, and so on. A writable stream identified by the symbol “stderr” is required, but may take any number of forms. For example, stderr may be a data stream maintained in a processor memory, in a file of a file system, and/or in a presentation space of an output device. The architecture of “stderr” may be determined by an operating environment selected to perform the operations specified in source code 3200 or may be prespecified. If prespecified, a system may choose one operating environment over another for embodying stderr via an OER that is not identified in the prespecificaiton.

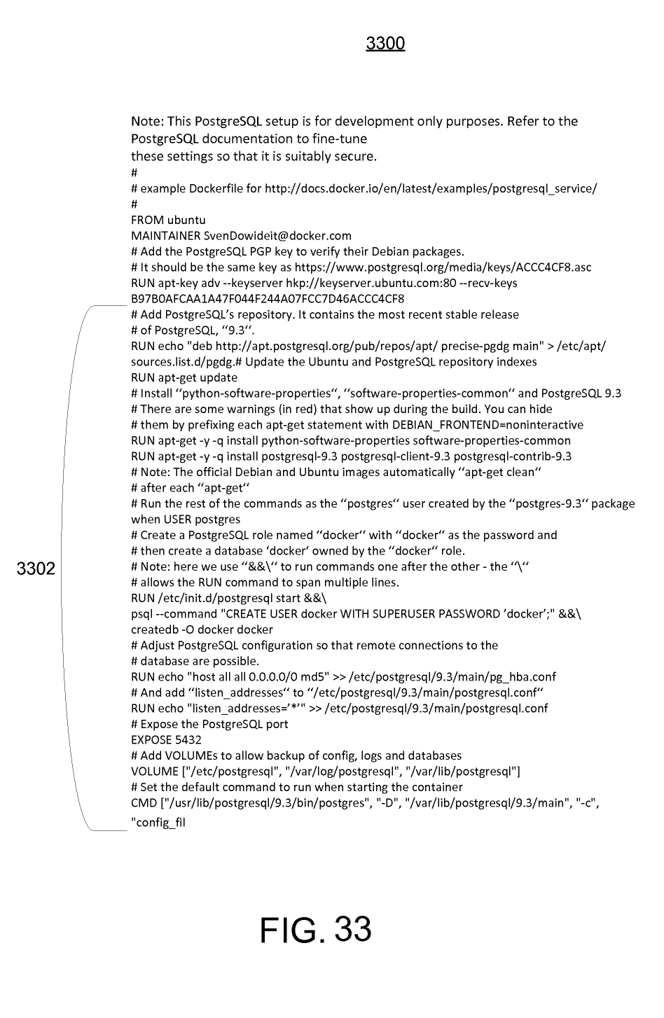

FIG. 33 illustrates a DOCKER file 3300 that adds a SQL data base to a Linux container. See comments and commands 3302. Such a file may be received as a representation of the Linux container and/or a particular instance of the container. The Linux container may be removed from a group of candidate operating environments for executing a translation of source code that does not access a SQL database and/or otherwise cause an access to a SQL database in an operating environment performing the executing.

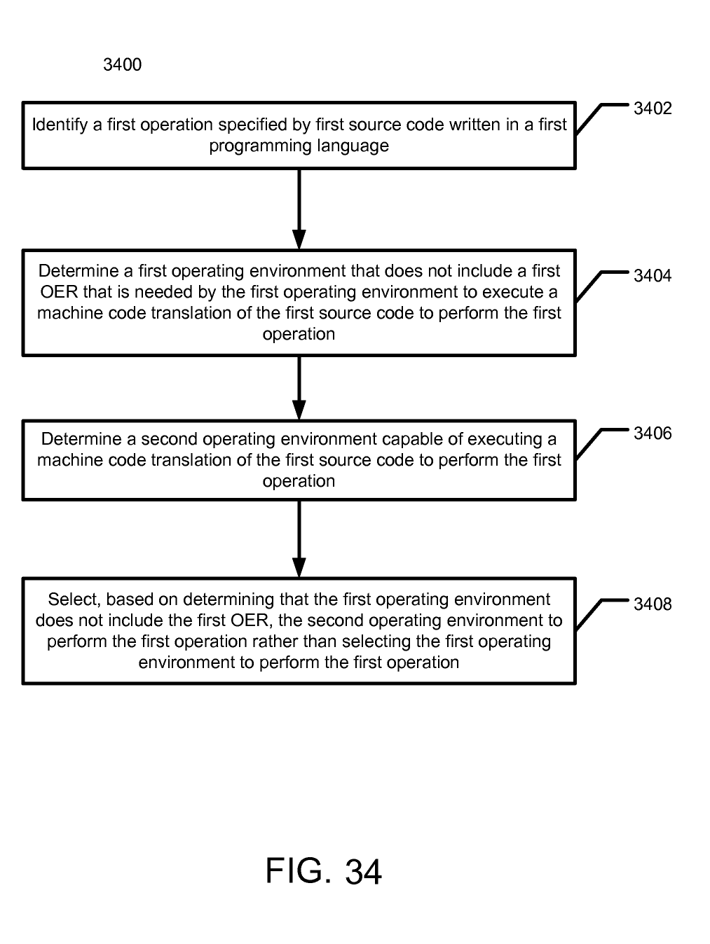

FIG. 34 shows method 3400. Method 3400 includes identifying a first operation specified by first source code written in a first programming language. See block 3402. Additionally, method 3400 includes determining a first operating environment that does not include a first OER that is needed by the first operating environment to execute a machine code translation of the first source code to perform the first operation. See block 3404. Also, method 3400 includes determining a second operating environment capable of executing a machine code translation of the first source code to perform the first operation. See block 3406. Further, method 3400 includes selecting, based on determining that the first operating environment does not include the first OER, the second operating environment to perform the first operation rather than selecting the first operating environment to perform the first operation. See block 3408.

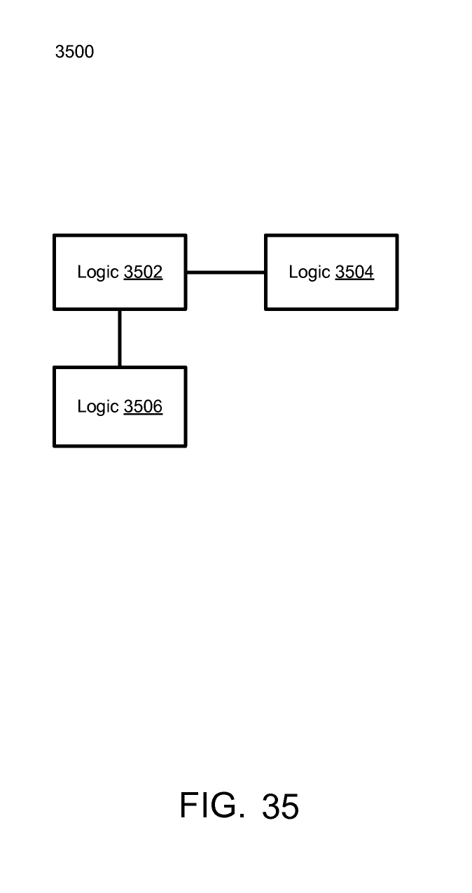

As an option, method 3400 may be implemented based on an arrangement 3500 of logic illustrated in FIG. 35, which may include and/or emulate hardware, code, and/or data. The arrangement 3500 may include logic 3502 that is included in identifying a first operation specified by first source code written in a first programming language. The arrangement may also include logic 3504 that is included in determining a first operating environment that does not include a first OER that is needed by the first operating environment to execute a machine code translation of the first source code to perform the first operation. Logic 3503 may also be included in determining a second operating environment capable of executing a machine code translation of the first source code to perform the first operation. The arrangement may further include logic 3506 that is included in selecting, based on determining that the first operating environment does not include the first OER, the second operating environment to perform the first operation rather than selecting the first operating environment to perform the first operation.

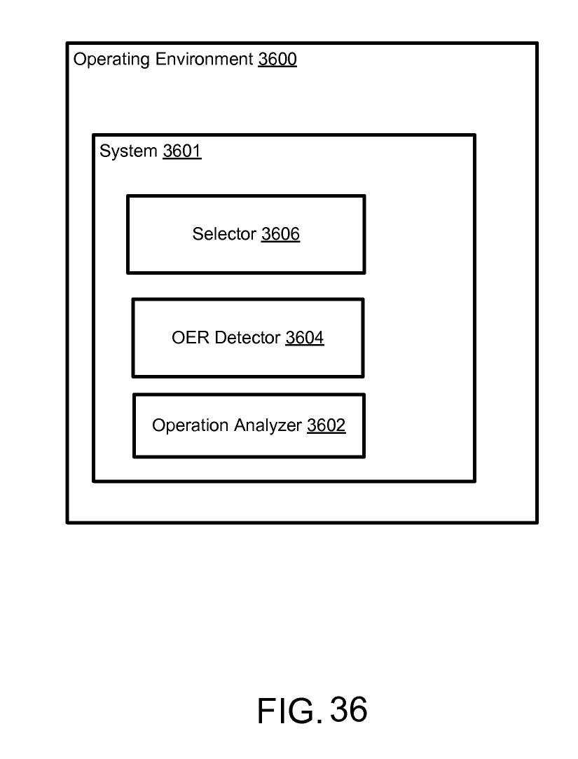

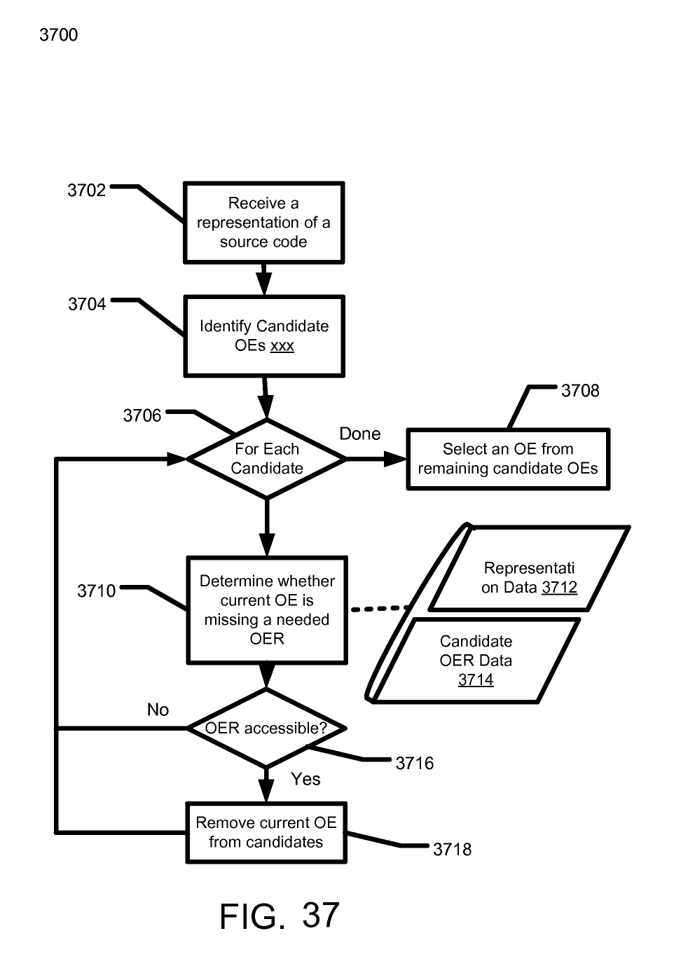

FIG. 36 illustrates an operating environment 3600 that includes logic and/or analogs of logic illustrated in FIG. 35 for performing the method of FIG. 34. Such logic may be included in logic of a system 3601, which may be analogous in at least some aspects to one or more other systems described in the present disclosure. Logic 3502 may be included in representation identifier 3602 that when executed identifies a first operation specified by first source code written in a first programming language. Logic 3504 may be included in OER detector 3604 that determines and/or otherwise identifies a first operating environment does not include an OER needed by the first operating environment to execute the instruction(s) specified in the source code to perform an operation specified in the source code. Logic 3504 in OER detector 3604 may also determine a second operating environment that is capable of performing the first operation. The second operating environment may or may not include the OER needed by the first operating environment. FIG. 37 illustrates one example of a method 3700 that may be included in performing the method 3400 illustrated in FIG. 34. The operation of block 3702 may be performed by logic that receives and/or otherwise accesses a representation, identified for example for example a representation identifier 3602. Some or all of the logic for performing the method 3700 may be included in OER detector component 3604. The operation of block 3704 may be performed by logic that identifies multiple candidate operating environments as described elsewhere in the present disclosure. Block 3706 identifies an operation that may be performed by logic that identifies a current candidate operating environment to evaluate in iterating through the candidate operating environments. Performing the operation of block 3710 may include executing logic to determine and/or otherwise identify an OER that is needed by the current candidate operating environment in executing an instruction and/or in performing an operation specified in the source code and to determine whether the current candidate operating environment includes or does not include the OER. In an aspect, OER detector component 3604 including logic to perform the operation of block 3710 may interoperate with logic that analyzes the representation data 3712 to identify a reference and/or other access to an OER, such as an OER in an OER Container, for the instruction(s) and/or operation. Additional logic may be included that analyzes current candidate OER data 3714 to identify an OER that is needed but not included in the operating environment. Determining the presence and/or absence of one or more OERs has been described above and may be detectable via a provisioning profile such as a DOCKER file, in a boot configuration file, a startup file, and/or other configuration data. Performing the operation of block 3716 may include executing logic that identifies whether the current candidate operating environment includes a needed and/or otherwise desired OER. If it is determined that the current candidate operating environment does not include a needed or desired OER, logic that removes the current candidate operating environment from consideration for selection may be executed. See block 3718. Otherwise the current candidate operating environment may remain a candidate operating environment. Block 3708 identifies an operation that may be performed by logic that selects an operating environment from the candidate operating environments as described elsewhere herein.

Selector 3606 may include logic 3506 that selects, based on determining that the second operating environment is capable of performing the operation specified in the source code. The needed OER may be any OER. In another aspect, the needed OER may be a specified OER and/or a specified type of OER. An operating environment may be selected using any of the methods and/or variations of methods described in the present disclosure. In some aspects, the iteration process may result in no candidates, one candidate, or multiple candidates.

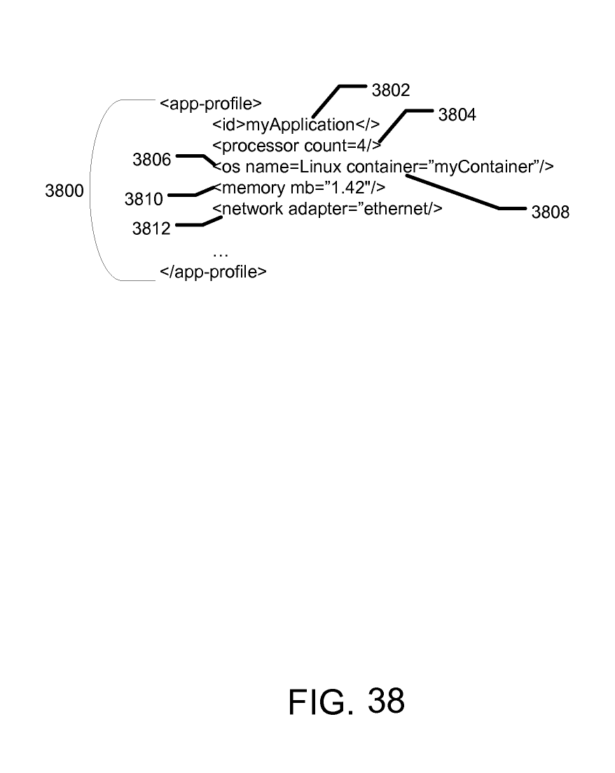

FIG. 38 illustrates a portion of an OER profile 3800 that may be maintained for an application. The OER profile 3800 is a representation of source code, where the source code specifies one or more instructions to be executed by a processor in an operating environment and/or specifies operations to be performed by the operating environment. The OER profile 3800 may identify OERs required to execute the one or more instructions and/or otherwise to perform the one or more operations. OER profile 3800 may include an id element 3802 that specifies an identifier of a particular application and/or a particular type of application. Various elements may be included that identify required resources, optional OERs, and/or unneeded OERs. A processor element 3804 may be included that identifies a minimum number of cores or processors needed. Additional processors or cores may be identified as unneeded in some aspects and/or optional in some aspects. An os element 3806 indicates the operating environment requires an instance of a particular Linux container. The particular container may be located via a value assigned to a container attribute 3808 in the os element 3806. A memory element 3810 specifies a minimum size of available memory. The size specified in some aspects may indicate a size of a physical memory and in other aspects may identify a size of virtual memory. Both may be specified. A network element 3812 indicates that OERs sufficient to support network interoperation via an Ethernet protocol are also required.

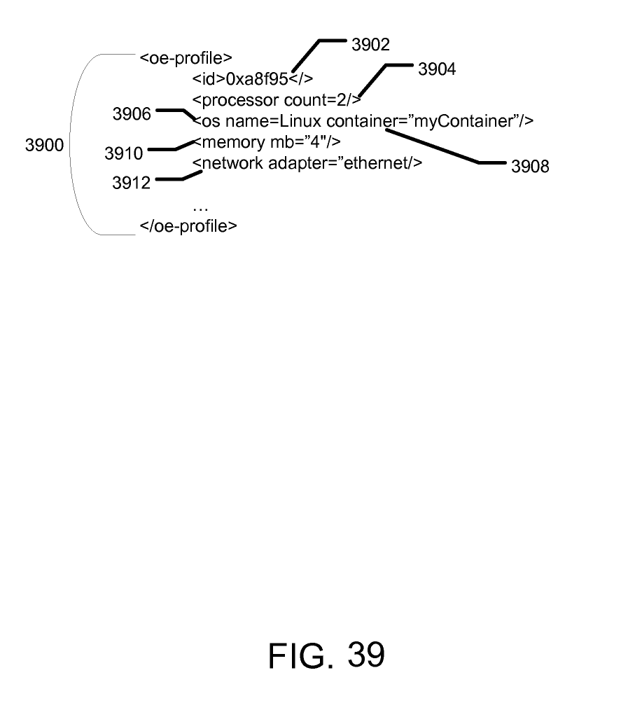

FIG. 39 illustrates a portion of an OER profile 3900 that may be maintained for an operating environment. An OER profile 3900 may be static specifying OERs included in the operating environment upon initialization and/or OERs required to boot an image of the operating environment. In another aspect a profile may be dynamically updated to identify OERs that are currently available, accessible, and/or included and/or not available altogether or in part. OER profile 3900 may include an id element 3902 that specifies an identifier of a particular image of an operating environment or may specify an identifier of an operating instance of an operating environment. Various elements may be included that identify included OERs, accessible OERs, and/or unavailable or inaccessible OERs in whole or in part. A processor element 3904 may be included that identifies a maximum number of cores or processors available or a number of processors that may be currently reserved. In an aspect, fewer processors may be requested for an application or other executable. Other OERs may be managed in an analogous manner. An os element 3906 indicates the operating environment includes a particular Linux container identified by a container attribute 3908 in the os element 3906. A memory element 3910 specifies a minimum size of available memory. Alternatively or additionally, an operating environment OER profile may specify a maximum amount of memory. The size specified in some aspects may indicate a size of a physical memory and in other aspects may identify a size of virtual memory. Both may be specified. A network element 3912 indicates that OERs sufficient to support network interoperation via an Ethernet protocol are also included.

In an aspect, OER profile 3900 for an identified as a candidate operating environment for the application represented by the OER profile 3800 may not be selected since it does not include 4 processors or cores required according to OER profile 3800.

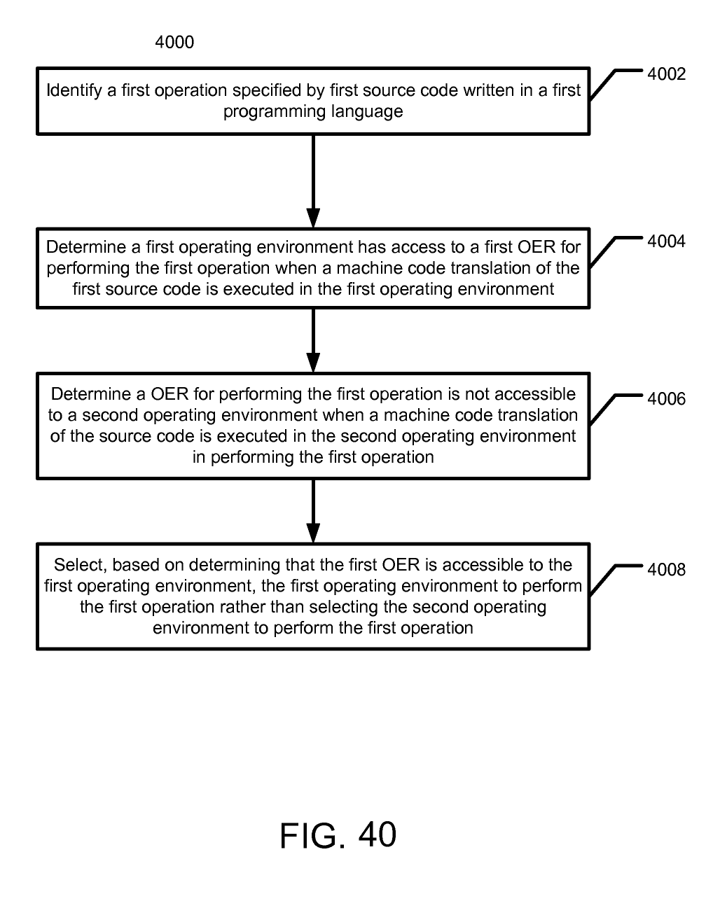

FIG. 40 shows method 4000. Method 4000 includes identifying a first operation specified by first source code written in a first programming language. See block 4002. Additionally, the method 4000 includes determining a first operating environment has access to a first OER for performing the first operation when a machine code translation of the first source code is executed in the first operating environment. See block 4004. Also, method 4000 includes determining an OER for performing the first operation is not accessible to a second operating environment when a machine code translation of the source code is executed in the second operating environment in performing the first operation. See block 4006. Further, method 4000 includes selecting, based on determining that the first OER is accessible to the first operating environment, the first operating environment to perform the first operation rather than selecting the second operating environment to perform the first operation. See block 4008.

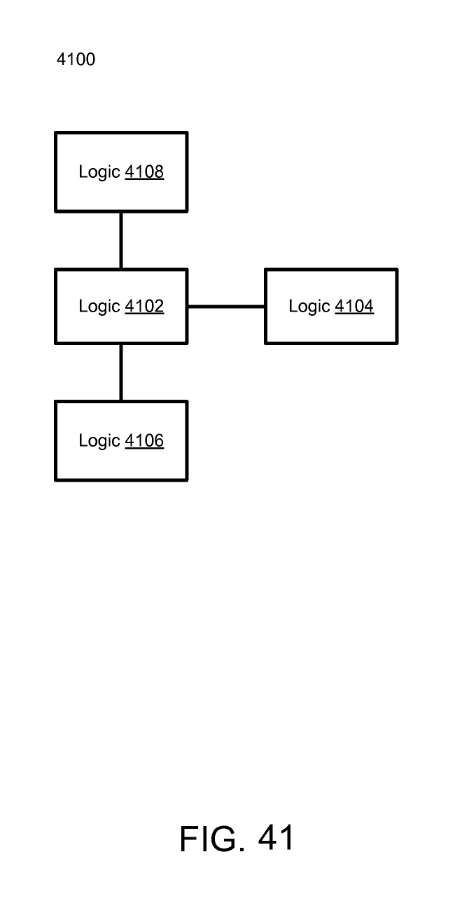

As an option, method 4000 may be implemented based on an arrangement 4100 of logic illustrated in FIG. 41. The arrangement 4100 may include logic 4102 that is included in identifying a first operation specified by first source code written in a first programming language. The arrangement 4100 may also include logic 4104 that is included in determining a first operating environment has access to a first OER for performing the first operation when a machine code translation of the first source code is executed in the first operating environment. Additionally, the arrangement 4100 may include logic 4106 that is included in determining an OER for performing the first operation is not accessible to a second operating environment when a machine code translation of the source code is executed in the second operating environment in perform the first operation. The arrangement 4100 may further include logic 4108 that is included in selecting, based on determining that the first OER is accessible to the first operating environment, the first operating environment to perform the first operation rather than selecting the second operating environment to perform the first operation.

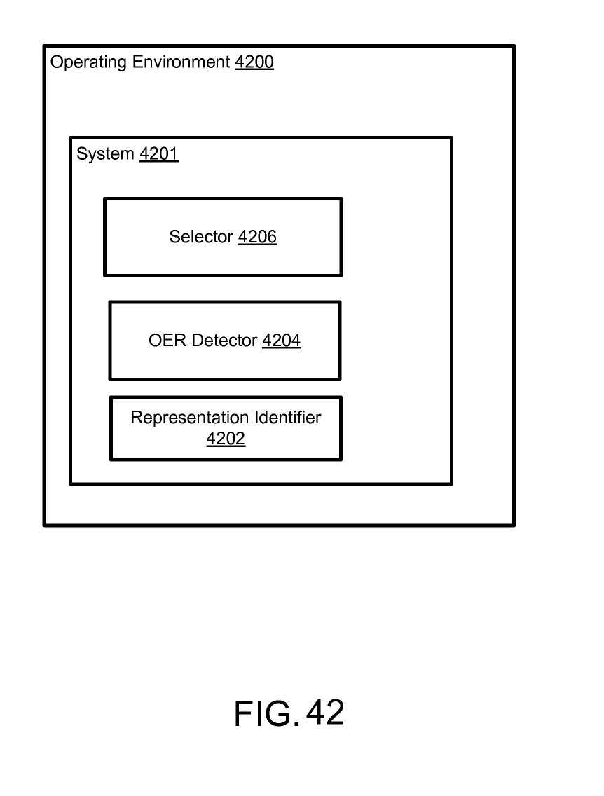

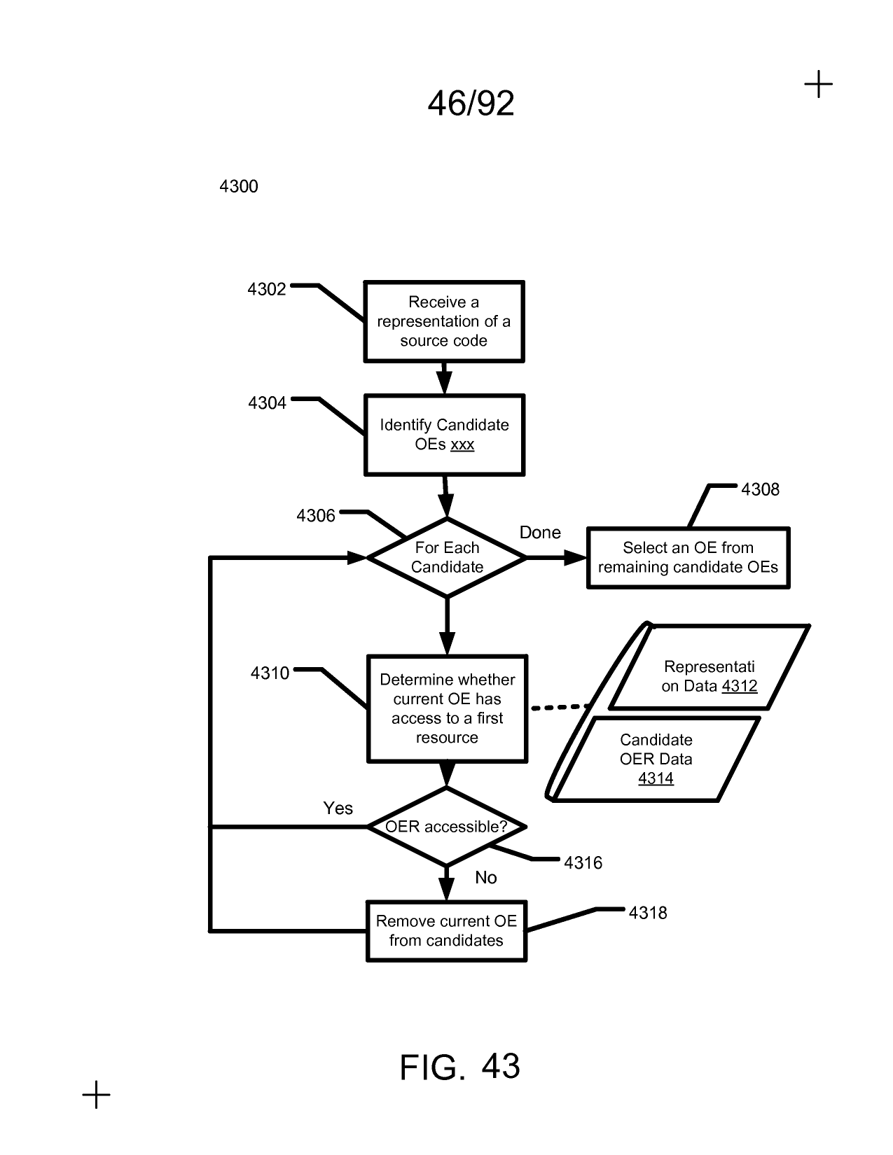

FIG. 42 illustrates an operating environment 4200 that may include logic and/or analogs of logic illustrated in FIG. 41 for performing the method 4000 of FIG. 40. Such logic may be included in logic of a system 4201, which may be analogous in at least some aspects to one or more other systems described in the present disclosure. Logic 4102 may be included in representation identifier 4202 that when executed identifies a first operation specified by first source code written in a first programming language. Logic 4104 may be included in OER detector 4204 that determines and/or otherwise identifies a first operating environment that does not include an OER needed by the first operating environment to execute the instruction(s) specified in the source code to perform an operation specified in the source code. Logic 4106 may also be include in OER detector 4204 may be executing in determining a second operating environment that is capable of performing the first operation. The second operating environment may or may not include the OER needed by the first operating environment. FIG. 43 illustrates a method 4300 that may be performed in performing the method illustrated in FIG. 40. Performing the operation of block 4302 may include executing logic that receives and/or otherwise accesses a representation, identified for example by a representation identifier 4202. Some or all of the method 4300 in FIG. 43 may be performed by logic included in an OER detector component 4204. Performing the operation of block 4304 may include executing logic that identifies multiple candidate operating environments as described elsewhere in the present disclosure. Performing the operation of block 4306 may include executing logic to identify a current candidate operating environment to evaluate in iterating through the candidate operating environments. Performing the operation of block 4310 may include executing logic that determines and/or otherwise identifies an OER that is accessible to and/or accessed by the current candidate operating environment in executing an instruction and/or operation specified in the source code. The logic may determine that a particular operating environment while processed as the current candidate operating environment does not include the OER. In an aspect, an operating environment that does not include the OER may be capable of executing the instruction and/or performing the operation. Performing the operation and/or executing the instruction via accessing the OER may be desirable or otherwise preferable. In an aspect, OER detector component 4204 including logic included in performing the operation of block 4310 that interoperates with logic that analyzes the representation data 4212 to identify a reference and/or other access to an OER for the instruction(s) and/or operation. Additional logic may be included that analyzes current candidate OER data 4314 to identify an OER that is needed and/or otherwise desired but not included in the current candidate operating environment or to identify an OER that is not included and not needed and/or not otherwise desired. Determining the presence and/or absence of an OER has been described elsewhere herein. For example a provisioning profile such as a DOCKER file, a boot configuration file, a startup file, and/or other configuration data may provide data for determining whether a particular OER or type of OER is in an operating environment or not. If a determination cannot be made, logic may be included that treats a failed determination as a determination that the operating environment involved in the determination does not include the OER. Logic that treats the operating environment as if it includes the OER may be included, in another aspect. Performing the operation of block 4316 may include executing logic that identifies whether the current candidate operating environment includes the OER. If it is determined that the current candidate operating environment does not include the OER, logic that removes the current candidate operating environment from consideration for selection is executed in performing the operation of block 4318. Otherwise the current candidate operating environment may remain a candidate operating environment. Once iteration through the candidate operating environments completes, block 4308 illustrates the method 4300 includes selecting an operating environment from the remaining candidate operating environments.

Selector 4206 may include logic 4106 that selects, based on determining that a particular operating environment is capable of performing the operation specified in the source code via accessing the OER. The needed and/or otherwise desired OER may be a specified OER and/or a specified type of OER. An operating environment may be selected using any of the methods and/or variations of methods described in the present disclosure. In some aspects, the iteration process may result in no candidates, one candidate, or multiple candidates.

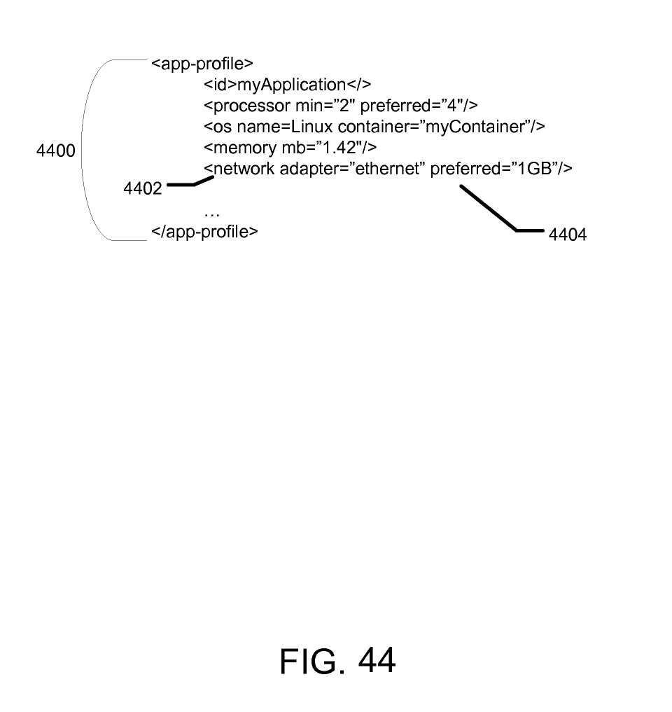

FIG. 44 illustrates a portion of an OER profile 4400 that may be maintained for an application similar to that illustrated in FIG. 38. A network element 4402 indicates that OERs sufficient to support network interoperation via an Ethernet protocol are also required and that OERs sufficient to support one gigabit bandwidth is preferred according a preference attribute 4404.

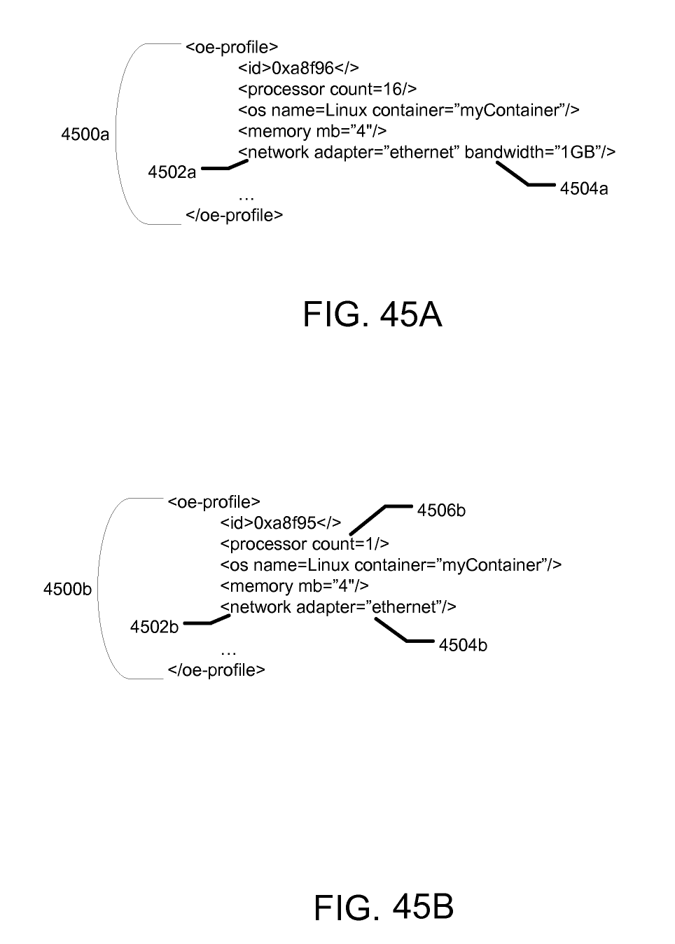

FIG. 45A illustrates a portion of an OER profile 4500a that may be maintained for an operating environment similar to that in FIG. 39. OER profile 4500a includes a network element 4502a that indicates that OERs sufficient to support network interoperation via an Ethernet protocol are included and that the network OERs will support a bandwidth of one gigabyte. FIG. 45B illustrates a portion of another OER profile 4500b. OER profile 4500b includes a network element 4502b that indicates that OERs sufficient to support network interoperation via an Ethernet protocol are included, but no indication that the network OERs included provide the applications preferred bandwidth. As described, this may be processed by logic that determines that the operating environment of OER profile 4500b does not include one or more OERs needed to provide the preferred bandwidth specified by the application OER profile 4400. As such, the operating environment of OER profile 4500a may be selected to execute the application rather than the operating environment of OER profile 4500b.

In an aspect, an operating environment associated with OER profile 4500b may also not be selected for the application represented by the OER profile 4400 as the profile indicates the associated operating environment does not include the minimum processors or cores required according to OER profile 4400 as indicated by count attribute 4506b.

In another example, source code may be written that writes data to a default data stream of an operating environment. In a first operating environment writing to the default data stream may include storing data in a relational database. Writing data to the default data stream in a second operating environment may include accessing a log file stored in a file system of the second operating environment. The second operating environment may be selected based on determining that accessing the relational data base is too slow or otherwise more costly that executing a machine code translation of the source code in the first operating environment. The data stream may be identified by a symbol such as “stderr”. OERs accessed in an architecture of “stderr” may take any number of forms and may vary across operating environments. A system may choose one operating environment over another for embodying stderr or being capable of embodying stderr via an OER that is preferred according to some configuration and/or other criterion

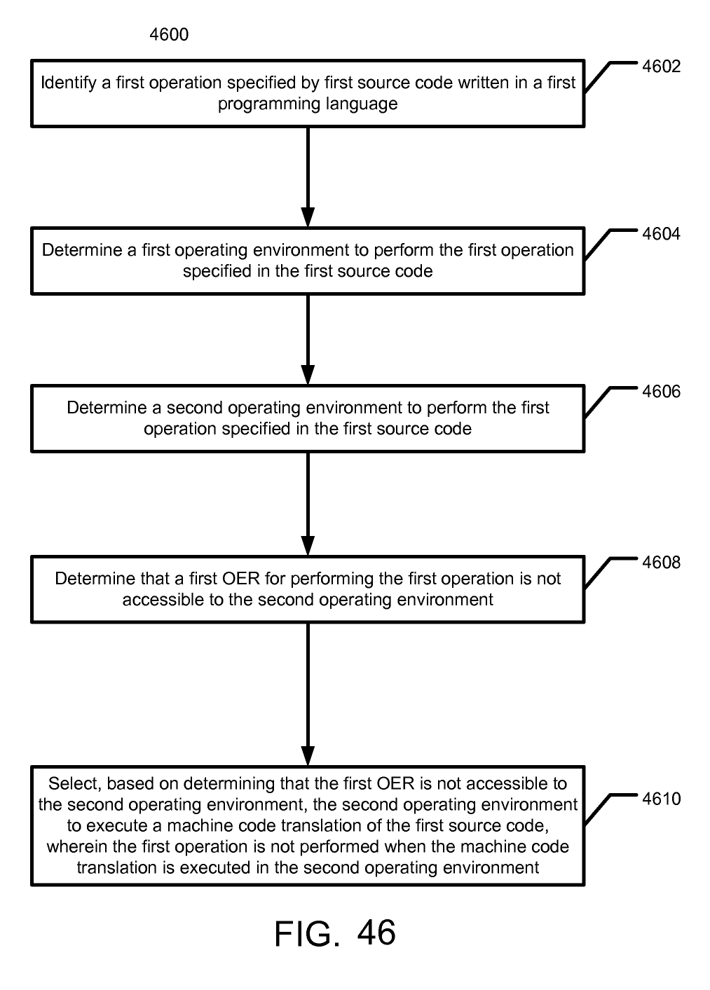

FIG. 46 shows method 4600. Method 4600 includes identifying a first operation specified by first source code written in a first programming language. See block 4602. Additionally, method 4600 includes determining a first operating environment to perform the first operation specified in the first source code. See block 4604. Also, method 4600 includes determining a second operating environment to perform the first operation specified in the first source code. See block 4606. Further, method 4600 includes determining that a first OER for performing the first operation is not accessible to the second operating environment. See block 4608. Still further, method 4600 includes selecting, based on determining that the first OER is not accessible to the second operating environment, the second operating environment to execute a machine code translation of the first source code, wherein the first operation is not performed when the machine code translation is executed in the second operating environment. See block 4610.

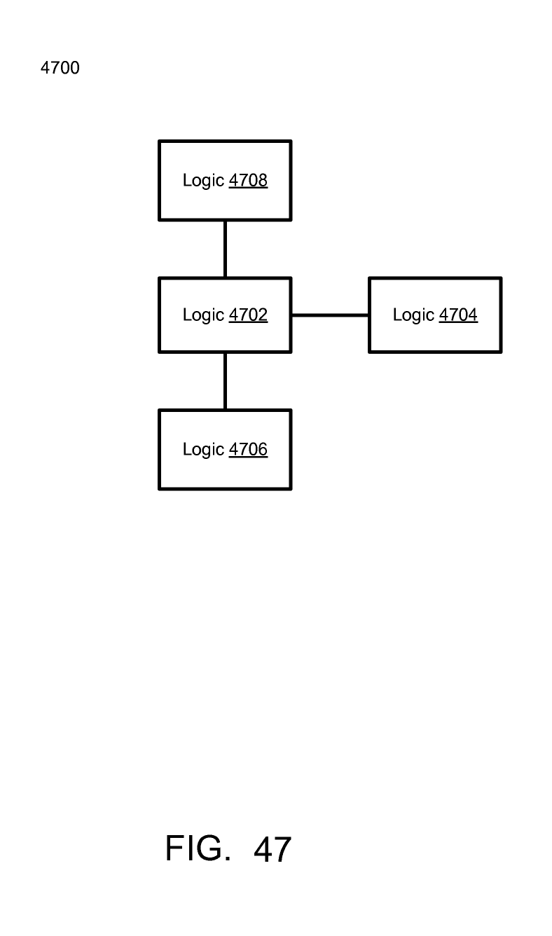

As an option, method 4600 may be implemented based on an arrangement 4700 of logic illustrated in FIG. 47. The arrangement may include logic 4702 that is included in identifying a first operation specified by first source code written in a first programming language. The arrangement may also include logic 4704 that is included in determining a first operating environment to perform the first operation specified in the first source code. Additionally, the arrangement may include logic 4706 that is included in determining a second operating environment to perform the first operation specified in the first source code. The arrangement may further include logic 4708 that is included in determining that a first OER for performing the first operation is not accessible to the second operating environment. Yet further, the arrangement may include logic 4710 that is included in selecting, based on determining that the first OER is not accessible to the second operating environment, the second operating environment to execute a machine code translation of the first source code, wherein the first operation is not performed when the machine code translation is executed in the second operating environment.

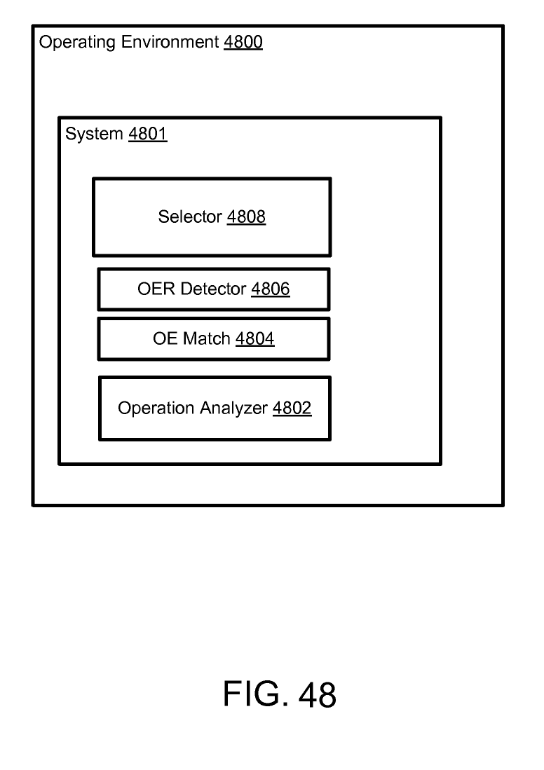

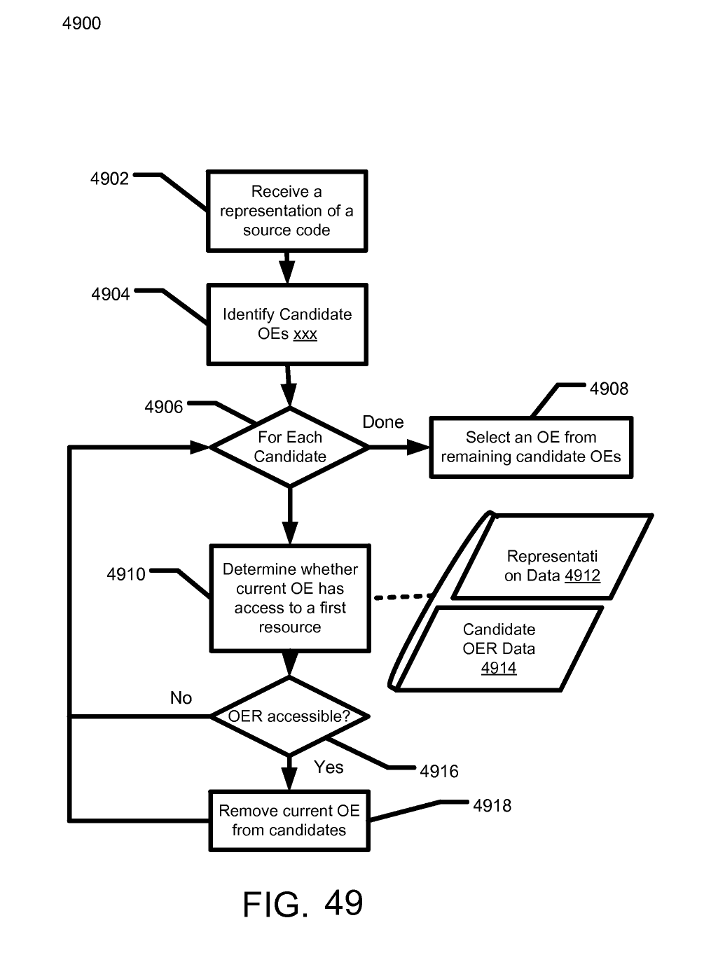

FIG. 48 illustrates an operating environment 4800 that includes logic and/or analogs of logic illustrated in FIG. 47 for performing the method 4700. Such logic may be included in logic of a system 4801, which may be analogous in at least some aspects to one or more other systems described in the present disclosure. Logic 4702 may be included in an operation analyzer component 4802 that when executed identifies an operation specified by source code written in a programming language. Logic 4704 may be included in an OE match component 4804 that determines and/or otherwise identifies more than one operating environment to perform the first operation specified in the first source code. FIG. 49 illustrates one example of a method 4900 that may be performed in performing the method 4600 illustrated in FIG. 46. Performing the operation of block 4902 may include executing logic that receives and/or otherwise accesses a representation, identified for example by logic illustrated in FIG. 48 included in a representation identifier component 4802. Some or all of the method 4900 may be performed by logic included in an OE match component 4804. Performing the operation of block 4904 may include executing logic in OE match component and/or in a librarian component (not shown) as described above to identify multiple candidate operating environments. Performing the operation of block 4906 may include executing logic that identifies a current candidate operating environment to evaluate in iterating through the candidate operating environments. Performing the operation of block 4910 may include executing logic to determine and/or otherwise identify whether an OER is included in the current candidate operating environment and whether it is accessed by the current candidate operating environment in executing an instruction and/or operation specified in the source code of the identified representation. In an aspect, an OER detector component 4806 may include logic to perform the operation in block 4910. OER detector component 4806 may interoperate with logic that analyzes representation data 4912 to identify an accessed OER, such as an OER in an OER Container, for the instruction(s) and/or operation. Additional logic may be included in and/or invoked by OER detector component 4806 that maps a reference, an instruction, and/or a specified operation to an OER in the current candidate operating environment based on data from the candidate OER data 4914. Performing the operation of block 4916 may include, in one aspect, executing logic identifies whether the current candidate operating environment includes and/or accesses the OER in performing the operation(s). If it is determined that the current candidate operating environment does include the OER, logic that removes the current candidate operating environment from consideration for selection is may be executed in performing block 4918. Otherwise the current candidate operating environment may remain a candidate operating environment. Once iteration through the candidate operating environments completes, logic that performs block 4908 may operate in selecting an operating environment from the candidate operating environments as described in more detail below.

Selector 4806 may include logic 4706 that selects, based on determining that a particular operating environment is capable of performing the operation via accessing the OER, where the operation is specified in the source code. The needed and/or otherwise desired OER may be a specified OER and/or a specified type of OER. An operating environment may be selected using any of the methods and/or variations of methods described in the present disclosure. In some aspects, the iteration process may result in no candidates, one candidate, or multiple candidates.

In an example, a first operating environment may include a sound card that is accessed to generate sound as a result of executing an application. A system may be configured to reduce noise in a workspace occupied by several users. A second operating environment may not include a sound card, but may still execute the application. The system may select the second operating environment to execute the application.

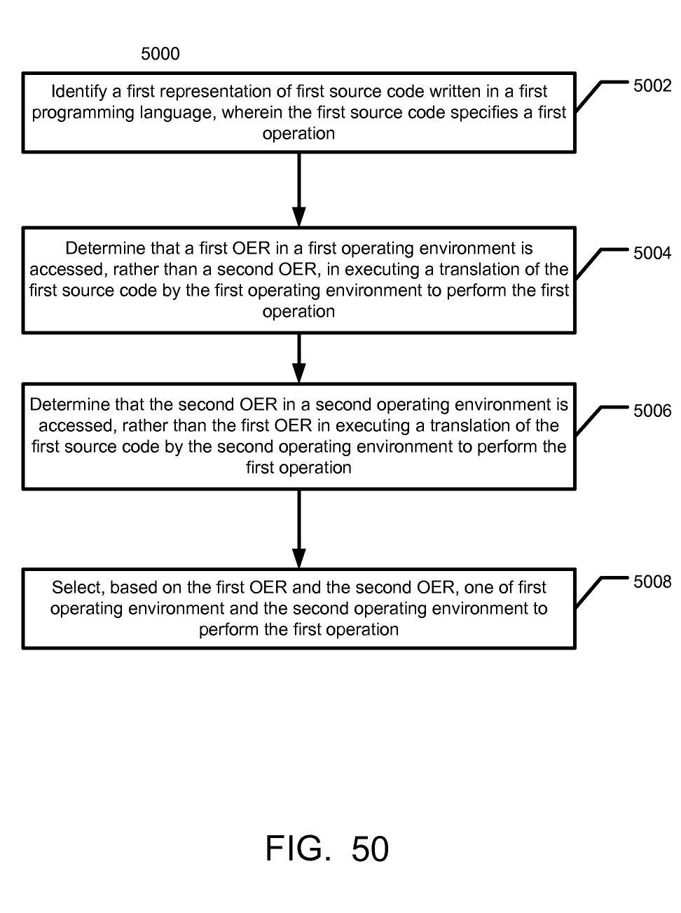

FIG. 50 shows method 5000. Method 5000 includes identifying a first representation of first source code written in a first programming language, wherein the first source code specifies a first operation. See block 5502. Additionally, method 5000 includes determining that a first OER in a first operating environment is accessed, rather than a second OER, in executing a translation of the first source code by the operating environment to perform the first operation. See block 5504. Also, method 5000 includes determining that the second OER in a second operating environment is accessed, rather than the first OER in executing a translation of the first source code by the second operating environment to perform the first operation. See block 5006. Further, method 5000 includes selecting, based on the first OER and the second OER, one of first operating environment and the second operating environment to perform the first operation. See block 5008.

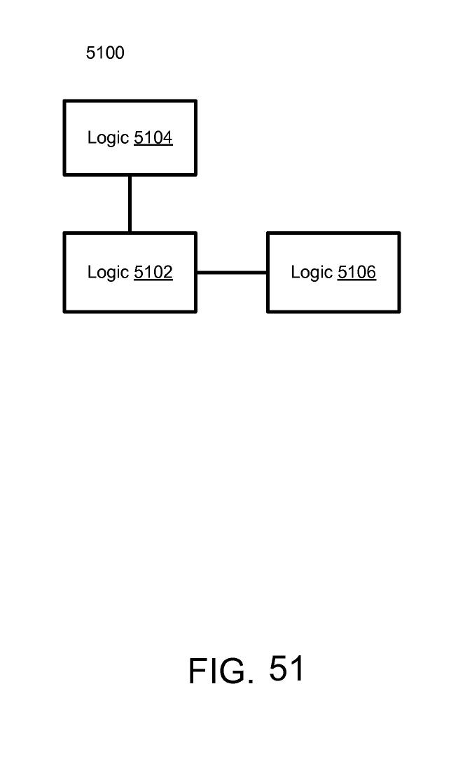

As an option, method 5000 may be implemented based on an arrangement 5100 of logic illustrated in FIG. 51. The arrangement 5100 may include logic 5102 that is included in identifying a first representation of first source code written in a first programming language, wherein the first source code specifies a first operation. The arrangement 5100 may also include logic 5104 that is included in determining that a first OER in a first operating environment is accessed, rather than a second OER, in executing a translation of the first source code by the first operating environment to perform the first operation. Additionally, logic 5104 may be executed in determining that the second OER in a second operating environment is accessed, rather than the first OER in executing a translation of the first source code by the second operating environment to perform the first operation. The arrangement 5100 may further include logic 5106 that is included in selecting, based on the first OER and the second OER, one of first operating environment and the second operating environment to perform the first operation.

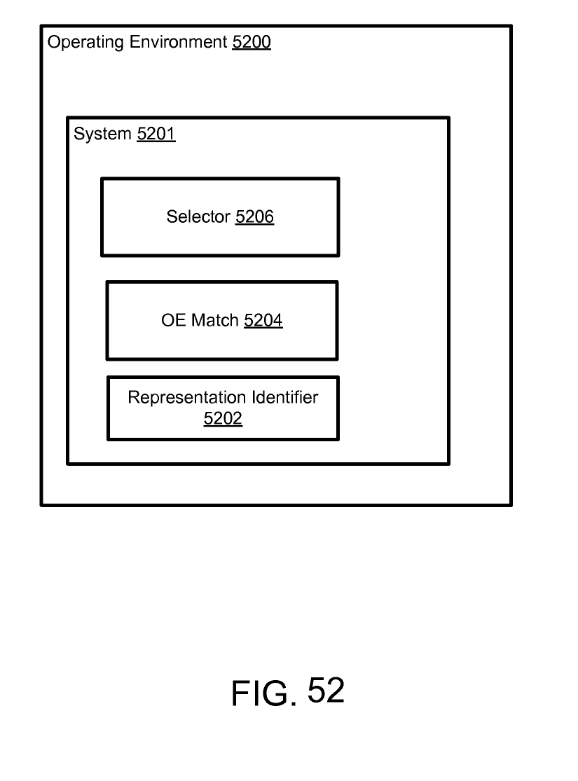

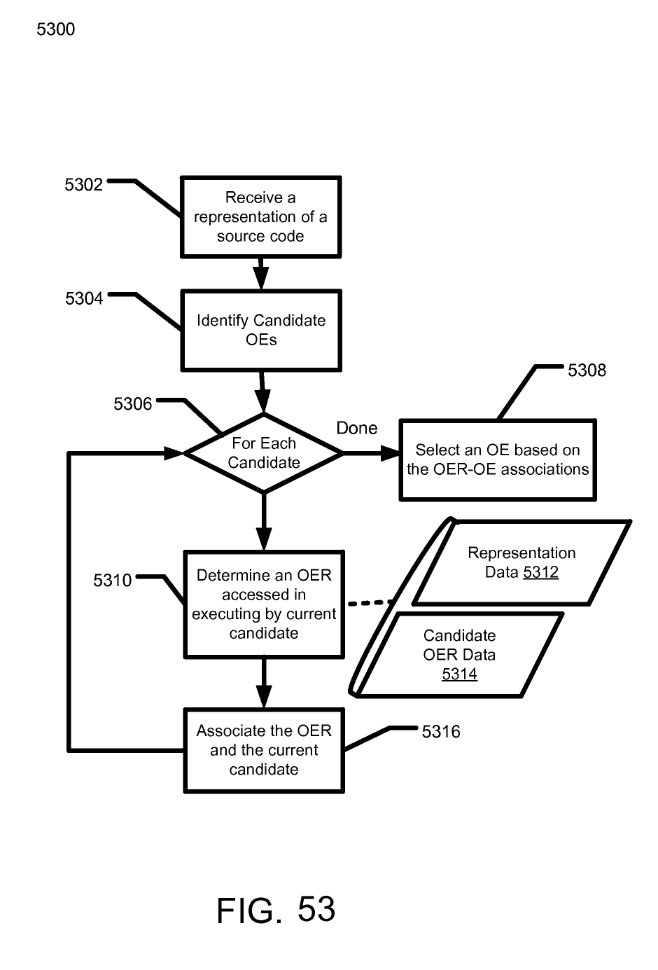

FIG. 52 illustrates an operating environment 5200 that may include logic and/or analogs of logic illustrated in FIG. 51 to perform the method 5000 of FIG. 50 may be included in logic of a system 5201, which may be analogous in at least some aspects to one or more other systems described in the present disclosure. Logic 5102 may be included in representation identifier 5202 that when executed identifies an operation specified by source code written in a programming language. Logic 5104 may be included in OE match 5204 that determines and/or otherwise identifies more than one operating environment to perform the first operation specified in the first source code by executing a translation of the first source code. FIG. 53 illustrates one example of a method that may be included in performing the method illustrated in FIG. 50. Performing the operation of block 5302 may include executing logic that receives and/or otherwise accesses a representation of source code. Such logic may be included in a representation identifier component 5202. Some or all of the method of FIG. 53 may be performed by logic included in OER component 5204. Performing the operation of block 5304 may include executing logic to identify multiple candidate operating environments. Performing the operation of block 5306 may include executing logic that identifies a current candidate operating environment to evaluate in iterating through the candidate operating environments. Performing the operation of block 5310 may include executing logic to determine and/or otherwise identify one or more OERs accessed by the current candidate operating environment in executing an instruction and/or operation specified in the source code of the representation. Different operating environments may access the same and/or different OERs. As described in the present specification above and below such logic may access, directly and/or indirectly, the source code, a translation of the source code, and/or another data representation of the source code (see data representation 5312). Also as described elsewhere herein, such logic may operate based on access to candidate OER data 5314. Performing the operation of block 5316 may include executing logic that operates to associate one or more OERs accessed by a candidate operating environment with the candidate operating environment for further processing. The operation of block 5308 may be performed by logic executed to select an operating environment from the candidate operating environments based on a difference in the OERs accessed by the respective candidate operating environments.

Logic 5106 may be included in selector 5206 that selects a first operating environment from the candidate operating environments based a first OER accessed by the first operating environment rather than a second OER in executing a translation of the first source code. The candidate operating environments includes a second operating environment that is not selected. The second OER is accessed by the second operating environment rather than the first OER in executing a translation of the first source code.

As indicated selecting one operating environment over another may be performed based on a performance cost, a law, a term of a contract, a geopolitical boundary, an environmental policy, an established practice, a user, a group, a security requirement, a reliability attribute, and/or any other suitable criterion, condition, and/or specification. If two or more operating environments accessed a same OER or a same set of OERs, selecting an operating environment from the two or more operating environments may be performed according any of the various methods described in the present disclosure.

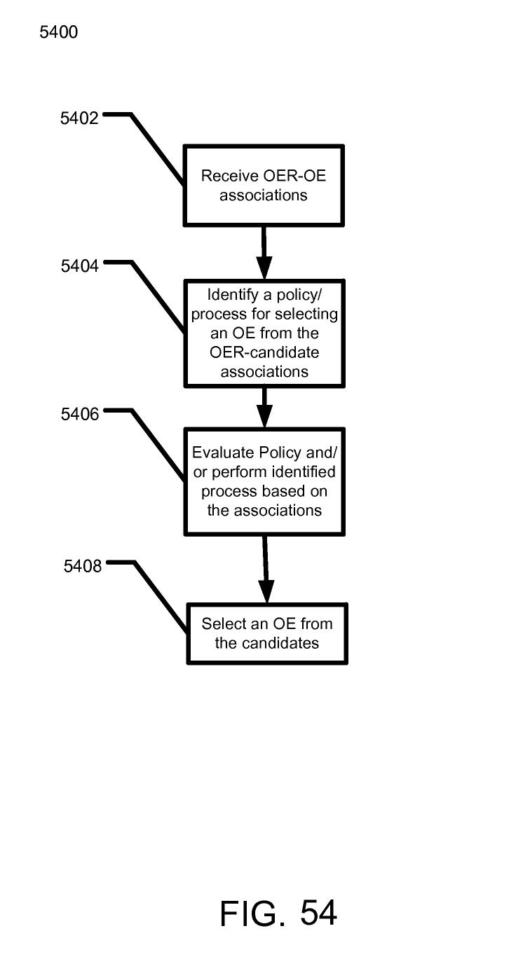

FIG. 54 illustrates one example of a method 5400 that may be performed in performing the method illustrated in FIG. 50. Performing the operation of block 5402 may include executing logic that receives associations that associate one or more OERs with a candidate operating environment included in multiple candidate operating environments. A policy may be retrieved from a storage location in a memory and/or particular logic for carrying out a process may be identified for performing the selecting based on data accessible in the associations and/or based on data otherwise accessible via the associations in performing the operation of block 5404. Performing the operation of block 5406 may include executing logic that, based on the associations, evaluates the identified policy and/or performs the identified logic to identify an operating environment from candidate operating environments. Performing the operation of block 5408 may include executing logic that operates to select the operating environment identified as a result of performing the operation of block 5406.

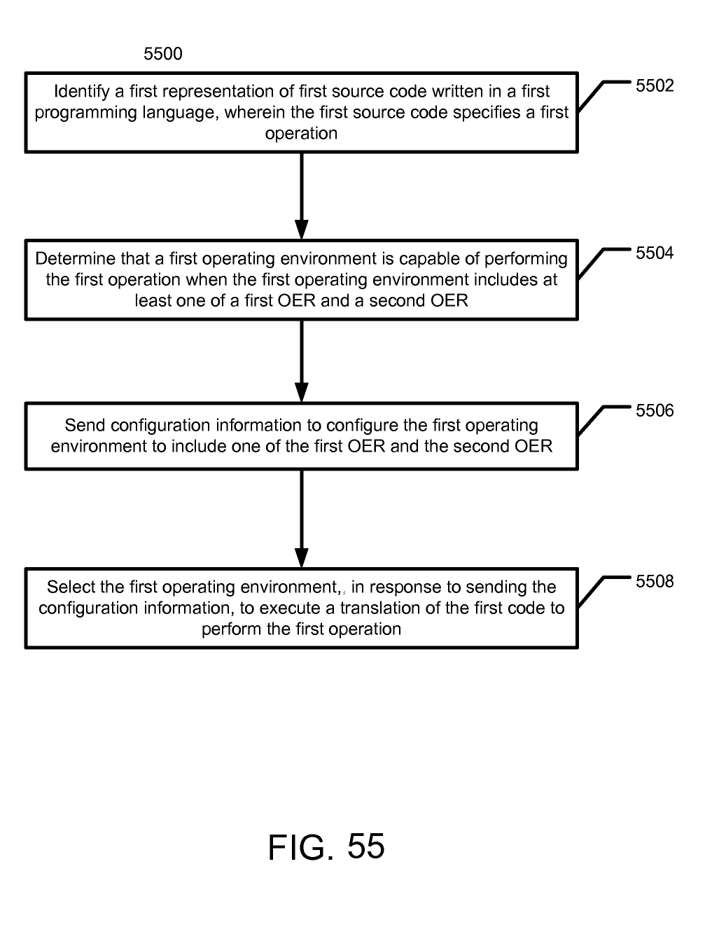

FIG. 55 shows method 5500. Method 5500 includes identifying a first representation of first source code written in a first programming language, wherein the first source code specifies a first operation. See block 5502. Additionally, method 5500 includes determining that a first operating environment is capable of performing the first operation when the first operating environment includes at least one of a first OER and a second OER. See block 5504. Also, method 5500 includes sending configuration information to configure the first operating environment to include one of the first OER and the second OER and not to include the other one of the first OER and the second OER. See block 5506. Further, method 5500 includes directing and/or otherwise selecting the first operating environment, in response to sending the configuration information, to execute a translation of the first code to perform the first operation. See block 5508.

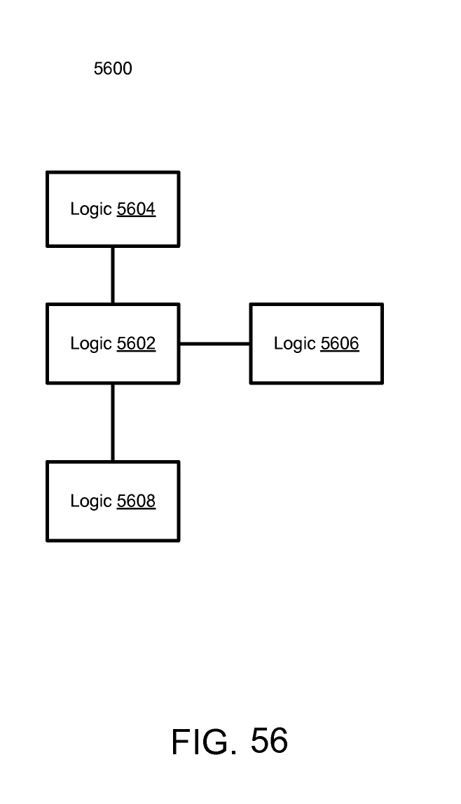

As an option, method 5500 may be implemented based on an arrangement 5600 of logic illustrated in FIG. 56. The arrangement 5600 may include logic 5602 that is included in identifying a first representation of first source code written in a first programming language, wherein the first source code specifies a first operation. The arrangement 5600 may also include logic 5604 that is included in determining that a first operating environment is capable of performing the first operation when the first operating environment includes at least one of a first OER and a second OER. Additionally, the arrangement 5600 may include logic 5606 that is included in sending configuration information to configure the first operating environment one of the first OER and the second OER and not to include the other one of the first OER and the second OER. The arrangement 5600 may further include logic 5608 that is included in selecting, directing, and/or otherwise instructing the first operating environment, configured according to the sent configuration information to execute a translation of the first source code to perform the first operation.

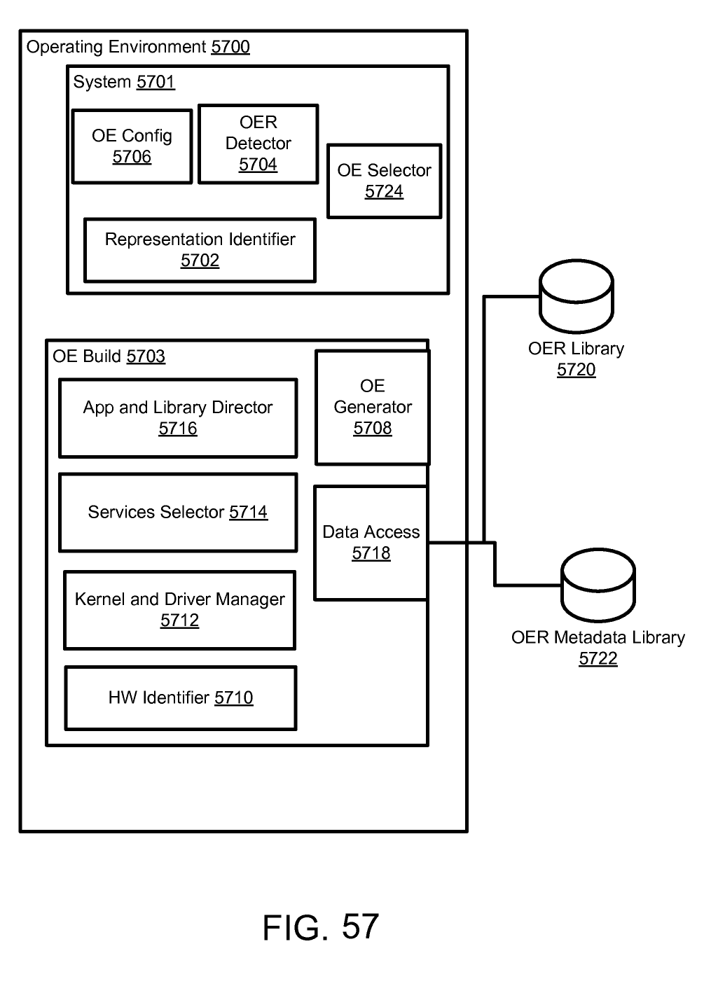

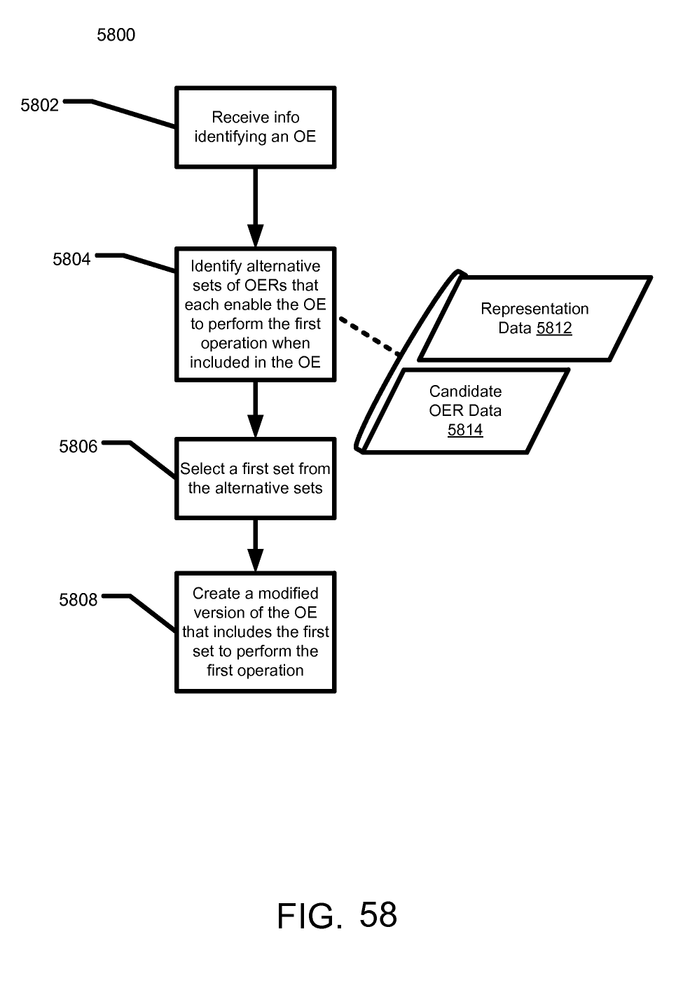

FIG. 57 illustrates an operating environment 5700 that includes logic and/or analogs of logic illustrated in FIG. 56 for performing the method of FIG. 55. Such logic may be included in logic of a system 5701, which may be analogous in at least some aspects to one or more other systems described in the present disclosure. Logic 5602 may be included in representation identifier 5702 that when executed identifies a first operation specified by first source code written in a first programming language. Logic 5604 may be included in OER detector 5704 that determines and/or otherwise identifies a first operating environment capable of performing the first operation when the first operating environment includes one or more identified OERs. An OER may be identified specifically and/or may be identified indirectly by one or attributes such as a function and/or service it performs. The operating environment may include none of the OERs or one or more of the OERs. At least some of the OERs may be duplicative. That is, they may be alternatives. Others may provide different functions and/or services. One OER may be accessed rather than another. One OER may be missing when another is present where the first operation may be still be performed by the first operating environment. For some executables, the first operation may be performed differently. For some source code that specifies a second operation in addition to the first operation, the second operation may operate differently based on the absence of one of the OERs or may not be performed at all. Logic 5606 may identify configuration information to send and/or otherwise provide to configure or otherwise modify the first operating environment to include one or more of the OERs and not include another one or more of the other OERs. Such logic may be included in an OE config component 5706 in FIG. 57. FIG. 58 illustrates a method 5800 that may be performed in performing the method 5500 illustrated in FIG. 55. The operation in block 5802 may be performed by logic that receives and/or otherwise identifies an operating environment to perform an operation specified in a representation of source code. Such logic may, for example, interoperate with logic in a representation identifier 5702. Some or all of the logic to perform the method 5800 may be included in an OER detector component 5704 and some or all in an OER selector component 5706. Logic to perform the operation illustrated in block 5804 may operate to identify multiple OERs and/or multiple sets of OERs that when included in the operating environment allow the operating environment to perform the operation specified by the source code. The logic may process representation data 5812 such as a translation of the source code, a symbol table, a provisioning profile, and/or any other suitable data associated with the representation as described throughout the present disclosure. The logic may also process candidate OER data 5814 to identify one or more OERs included and/or not included in the operating environment as described elsewhere in the present disclosure. The operation identified in block 5806 may be performed by logic that selects a set of OERs as opposed to another set. Each set includes at least one OER. The OERs in the sets may intersect, but they are not the same. Selection may be based on any of the various criteria described in the present disclosure for selecting an operating environment. The operation in 5808 may be performed and/or provided for by logic that invokes logic in OE build 5703 that operates in modifying an operating environment to include one or more of the OERs in the selected OER Set. With respect to FIG. 57, such logic may be include in an OE generator component 5708.

Referring to FIG. 57, OE build 5703 may retrieve and/or otherwise receive information identifying an OER not accessed in performing an instruction specified in source code written in a programming language. OE build 5703, in an aspect may access an operating environment in identifying such an OER. Alternative or additionally, OE build 5703 may access one or more other representations of the operating environment such as one or more images of logic that may each be included in the operating environment when included in and/or otherwise includes a device. A representation of an operating environment may be an installable image of logic, may be a profile or metadata that identifies portions of an operating environment that may be accessed to create an instance of the operating environment. That is, an operating environment may be represented by executable code that may be associated with compatible hardware and/or an operating environment may be represented by data that identifies one or more portions of an operating environment that may be combined to create an instance of the operating environment. Descriptive data and executable code may be maintained together in a same data store and/or may be maintained in separate data stores. For example, a provisioning profile for an operating environment may be provided to a device which may access portions of the operating environment identified in the provisioning profile to create an instance of an operating environment that operates in and/or includes the device. The portions of the operating environment may be stored on a local data store, such as a hard disk of the device, and/or may be accessed via a network. For example, a profile entry for a device driver to include in an operating environment may include a URL for accessing a driver that is compatible with the hardware of the device and the operating environment that is represented by the profile.

FIG. 57 illustrates HW identifier 5710 that includes logic to identify one more hardware OERs. HW identifier 5710 may include logic to disable, remove, and/or modify one more hardware OERs and/or portions thereof not needed and/or otherwise not desired in performing an instruction specified in the source code processed by system 5701 as described above. FIG. 57 also illustrates kernel and driver manager 5712 that includes logic that identifies one or more drivers and/or kernel services, and/or portions thereof. A kernel and driver manager may include logic to disable, remove, and/or modify one more drivers and/or kernel services and/or portions thereof not needed and/or otherwise desired in performing an instruction specified in the source code. FIG. 57 additionally illustrates services selector 5714 that includes logic to identify one or more operating environment services and/or portions thereof. A services selector may include logic to disable remove, and/or modify one more operating environment services and/or portions thereof not needed and/or otherwise desired in performing an instruction specified in the source code. Services selector 5714 may identify these services to modify them from an existing operating environment and/or to modify them from an operating environment to be built. FIG. 57 further illustrates application and library director 5716 that includes logic to identify one or more libraries, applications, and/or portions thereof. An app and library director may include logic to disable, remove, and/or modify one more operating environment dynamic link libraries, static libraries, and/or applications and/or portions thereof. Whole libraries and applications may be modified and/or parts of libraries and/or parts of applications not accessed in performing the instruction(s) specified in the source code may be identified to remove them from and/or otherwise modify them to generate a modified operating environment.

Application and library director 5716, services selector 5714, kernel and driver manager 5712, and HW identifier 5710 may access OER and/or operating environment representations from one or more data stores illustrated by via a data access component 5718. OER library 5720 and OER metadata library 5722. OER library 5720 illustrates a data store for storing source code and/or translations of source code for instantiating an operating environment and/or for adding an OER to an operating environment. OER metadata library 5722 illustrates a data store that includes information that identifies operating environment images and/or OERs along with metadata for accessing and/or instantiating the operating environment images and/or OERs in and/or including a hardware device. Exemplary metadata includes processor compatibility information, programming language compatibility information, dependencies on other OERs, configuration information, and initialization information—to name a few examples. An operating environment image along with one or more additional OERs to include in the operating environment may be selected by OE build 5703 based on the source code and/or representation of the source code that is processed, may be selected by a user interacting with OE build 5703, may be selected by a device included in instantiating the generated and/or otherwise specified operating environment, and/or may be selected by a user of a device that provides the generated operating environment and/or is otherwise included in the generated operating environment.

OERs managed by application and library director 5716, services selector 5714, kernel and driver manager 5712, and HW identifier 5708 are exemplary and the description above does not describe an exhaustive list of OERs and/or types or OERs that may be identified to modify and/or create an operating environment.

OE Selector 5724 may include logic 5608 that selects the modified operating environment to execute a translation of the source code to perform the operation and/or otherwise cause the modified operating environment to perform the operation. If more than one operating environment has been modified according to the method of FIG. 55, an operating environment may be selected using any of the methods and/or variations of methods described in the present disclosure. In some aspects, the iteration process may result in no candidates, one candidate, or multiple candidates.

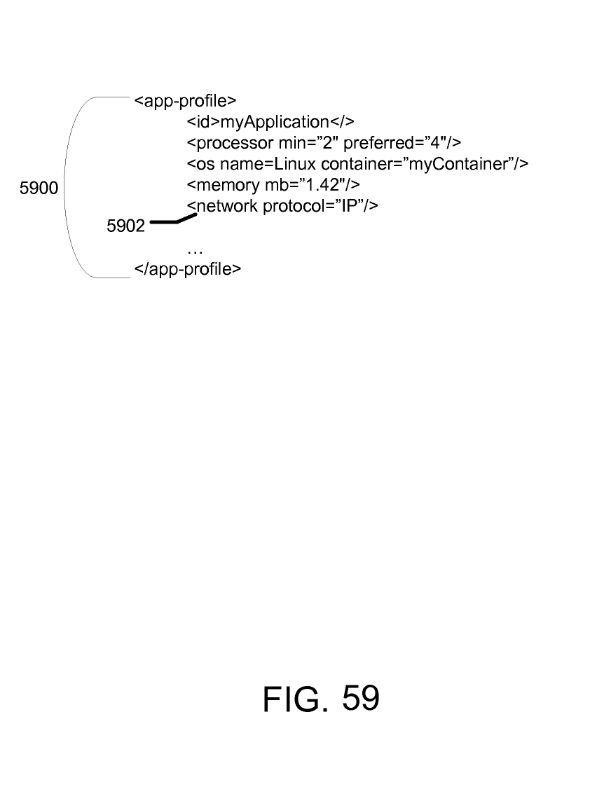

FIG. 59 illustrates a portion of an OER profile 5900 that may be maintained for an application. A network element 5902 may indicate that OERs sufficient to support a network layer for the Internet Protocol (IP) are required. Note that a link layer protocol may not be left unspecified in the OER profile 5900 indicating any suitable link layer protocol is acceptable. In another aspect, the OER profile 5900 may specify multiple link layer protocols which may all be included in an instance of a hosting operating environment or some may be alternatively included.

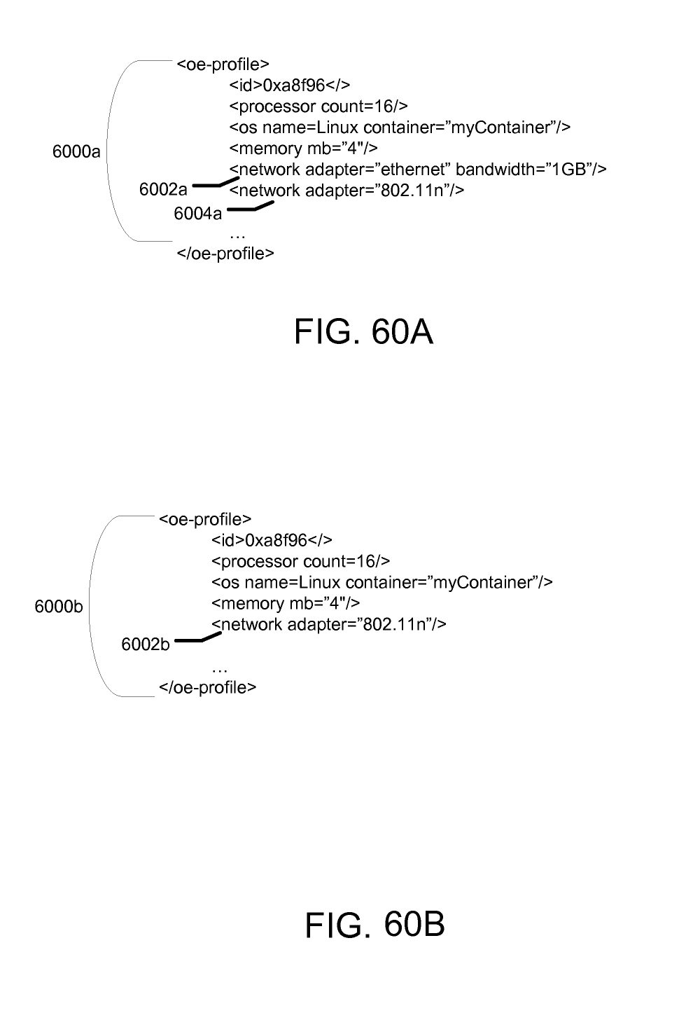

FIG. 60A illustrates a portion of an OER profile 6000a that may be maintained for an operating environment. OER profile 6000a includes a network element 6002a that indicates that OERs sufficient to support network interoperation via an Ethernet protocol are included. OER profile 6000a network element 6004a indicates that OERs sufficient to support network interoperation via an 802.11n protocol are included. FIG. 60B illustrates a portion of another OER profile 6000b modified from OER profile 6000a. OER profile 6000b includes only one network element 6002b to provision one physical layer for network communication.

In an aspect, an operating environment associated with OE profile 6000b may be identified as a candidate operating environment and/or selected for the application represented by the OER profile 5900.

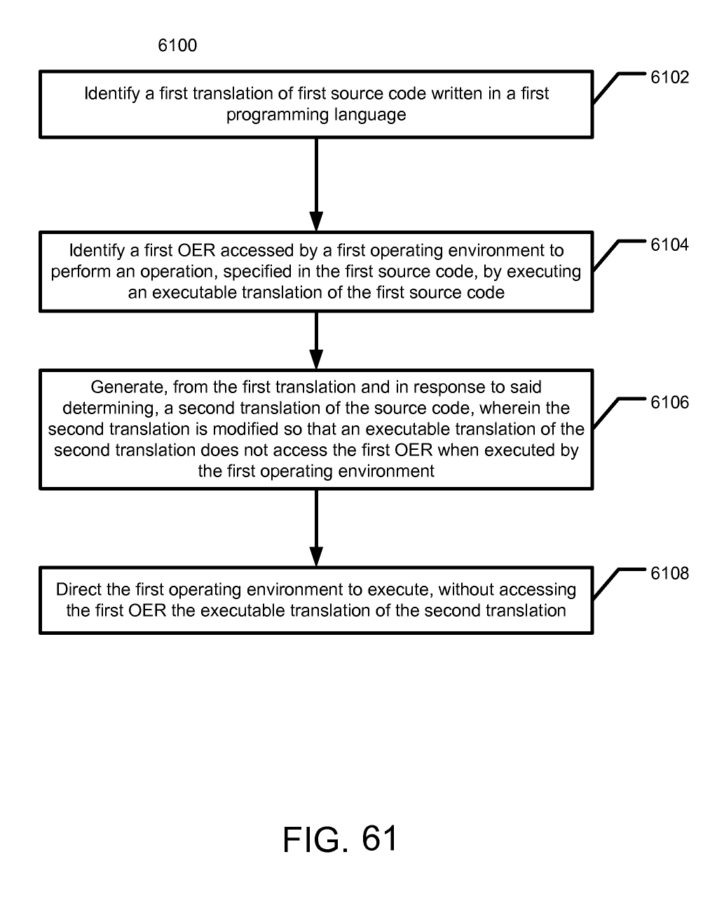

FIG. 61 shows method 6100. Method 6100 includes identifying a first translation of first source code written in a first programming language. See block 6102. Additionally, method 6100 includes identifying a first OER accessed by a first operating environment to perform an operation, specified in the first source code, by executing an executable translation of the first source code. See block 6104. Also, method 6100 includes generating, from the first translation and in response to said determining, a second translation of the source code, wherein the second translation is modified so that an executable translation of the second translation does not access the first OER when executed by the first operating environment. See block 6106. Further, method 6100 includes directing the first operating environment to execute, without accessing the first OER the executable translation of the second translation. See block 6108.

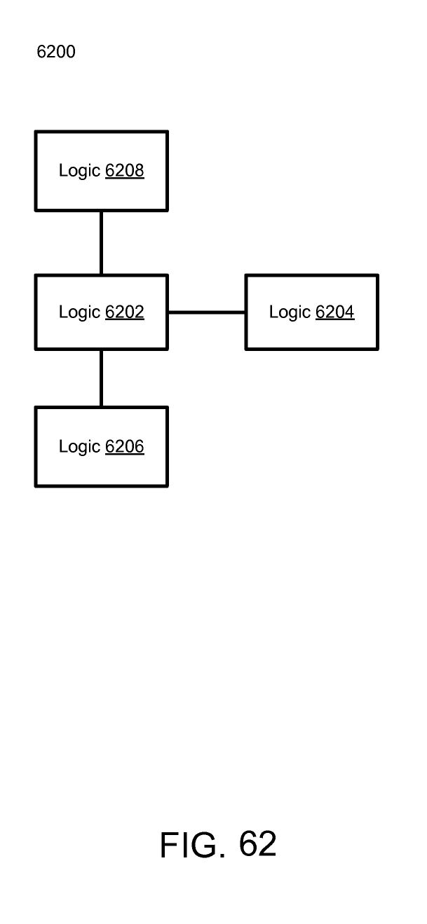

As an option, method 6100 may be implemented based on an arrangement 6200 of logic illustrated in FIG. 62. The arrangement 6200 may include logic 6202 that is included in identifying a first translation of first source code written in a first programming language. The arrangement 6200 may also include logic 6204 that is included in identifying a first OER accessed by a first operating environment to perform an operation, specified in the first source code, by executing an executable translation of the first source code. Additionally, the arrangement 6200 may include logic 6206 that is included in generating, from the first translation and in response to said determining, a second translation of the source code, wherein the second translation is modified so that an executable translation of the second translation does not access the first OER when executed by the first operating environment. The arrangement 6200 may further include logic 6208 that is included in directing the first operating environment to execute, without accessing the first OER the executable translation of the second translation.

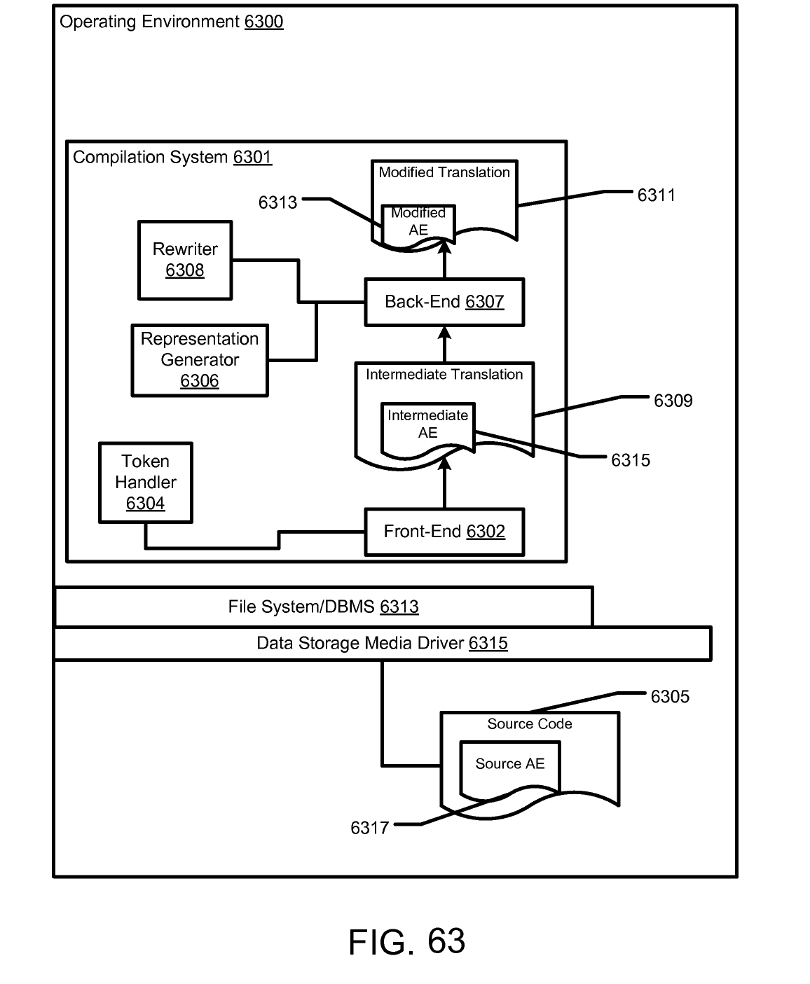

FIG. 63 illustrates operating environment 6300 hosting a compilation system 6301 analogous to compilation system 301 in FIG. 3 described above. FIG. 63 illustrates compilation system 6301 including an adaptation of the arrangement of components in FIG. 62. FIG. 63 illustrates front-end component 6302 included in compilation system 6301. Front-end component 6302 may include logic 6202 that is executed in receiving and/or otherwise identifying a first translation of source code 6205 written in a programming language as has been described above with respect to FIG. 3.

Back-end component 6307 may translate intermediate translation 6309 and/or a translation generated from intermediate translation 6309 into a modified translation 6311 that is modified so that a particular OER that is accessed in executing an otherwise unmodified executable translation is not accessed in executing an executable translation of the modified translation. A modified translation may include assembler code, byte code, machine code, and/or any data representation that is translatable into a machine code translation of source code 6305. In FIG. 63, modified translation 6311 includes a modified addressable entity (AE) 6313 translated from intermediate addressable entity 6315, directly and/or indirectly.

As described above, FIG. 63 illustrates front-end component 6302 that when executed receives source code from a user, from a data store, and/or via a network. FIG. 63 illustrates source code 6305 accessible to operating environment 6300. Source code 6305 includes an addressable entity, illustrated by source AE 6317, specified in a programming language. Source code 6305 may include other addressable entities in addition to source AE 6317.

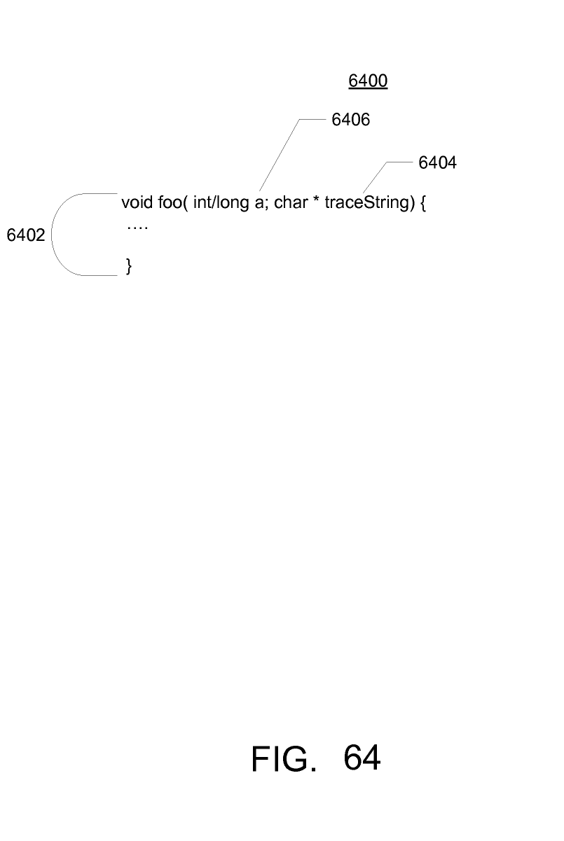

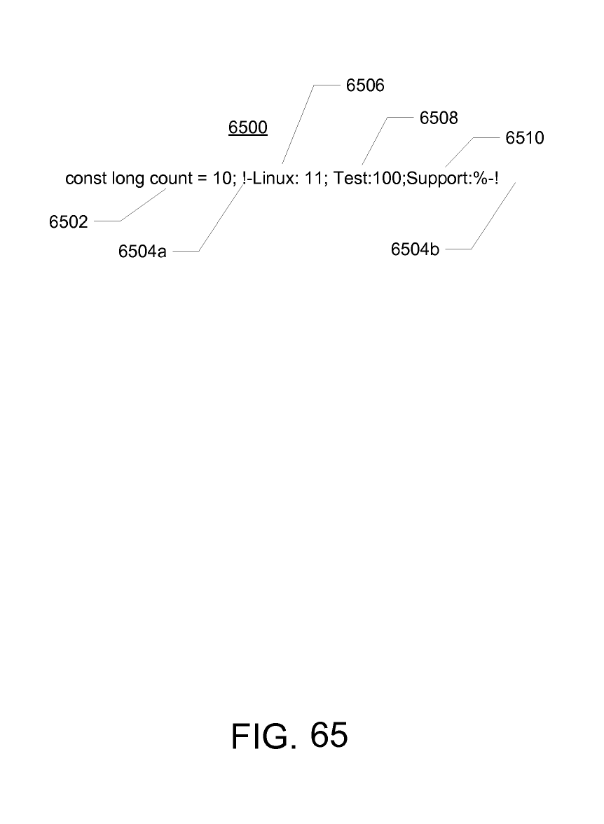

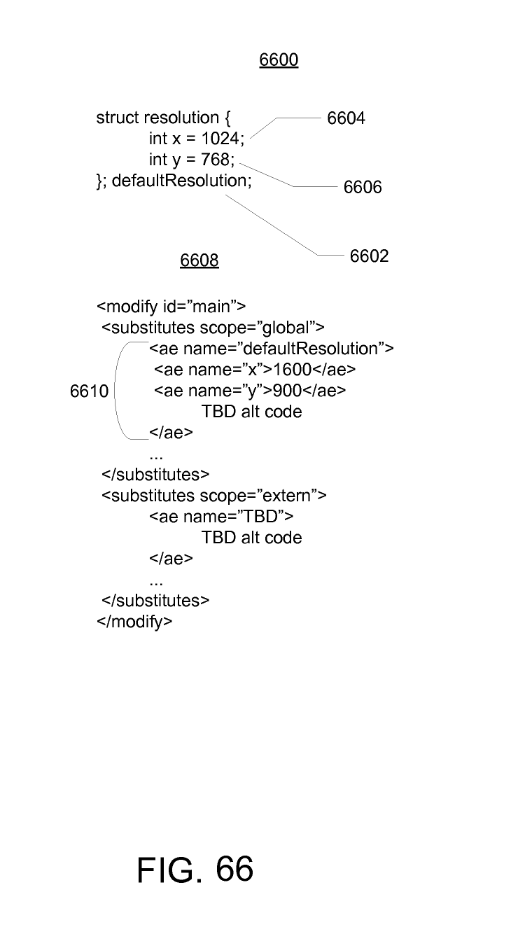

FIG. 64 illustrates a syntax for specifying an alternate data type of an addressable entity. The syntax that includes a ‘/’ character may be reserved in an adaptation of the C programming language according to the subject matter described in the present disclosure. The syntax may be defined by the language to extend the programming language's type definition syntax and semantics. A translator, of source code 6400, may select the default or alternate data type for a particular translation and/or executing of an executable translation of source code 6400. FIG. 65 illustrates syntactic elements “!-” and “-!” that may be defined by a programming language to allow more than one value to assign initialize or assigned under other specified conditions to a data addressable entity. FIG. 66 illustrates metadata 6608 associated with source code and/or a translation of the source code. A metadata element may be scoped providing a context for identifying code that can be replaced. Code that is replaceable may be identified by any suitable matching criterion such a name assigned to an addressable entity such a label, a class name, a function name, and a variable name—to name a few examples. Replacement may be performed on the source code or on any translation of the source code by a source code editor, compiler, loader, linker, and/or other code build tool.

Those skilled in the art will understand, based on the descriptions in the present disclosure that keywords and syntactic elements illustrated in FIGS. 64, 65, and 66 are exemplary and not exhaustive. Any suitable indicator defined in and/or definable via a programming language and/or via a schema for metadata for source code and/or a translation of the source code may identify alternative code, data, and/or other OERs accessed in executing a translation of the source code.

Returning to FIG. 63, back-end component 6307 may interoperate with representation generator component 6306 to generate a modified translation of source code 6305 where a particular OER that is access in executing the unmodified translation is not accessed in executing the modified translation. A modified translation is illustrated by modified translation 6311 in FIG. 63.

In an aspect, front-end component 6302 may interoperate with an adaptation and/or analog of representation generator component 6306 to generate intermediate translation 6309 of source code 6305. In one aspect, intermediate translation may be modified to prevent access to the particular OER. A modified translation may be generated from a modified intermediate translation and/or may be generated from an unmodified intermediate translation.

A modified translation may represent some or all of the source code including the OER modification as assembler, a high-level programming language, byte code, unlinked object code, and/or linked object code. A modified translation 6311 may include a relocatable machine code translation, a position independent translation, and/or an unrelocatable machine code translation.

A translation of source code may be unmodified but may be included and/or otherwise may be associated with metadata specifying that a subsequent translation be generated so that a particular OER is not accessed as a result of executing an executable translation of the subsequent translation or as a result of executing the subsequent translation if executable. For example, representation generator component 6306 may generate an unmodified translation of source code 6305, In the aspect, back-end component 6307 may invoke rewriter 6308 providing modifying information included in and/or otherwise associated with the unmodified translation to prevent an executable translation of the unmodified translation from causing an access to a particular OER or type of OER when executed. For example, the metadata may instruct a linker component to resolve an unresolved reference to an OER with an alternative addressable entity rather than the addressable entity that would be used to resolved the reference otherwise. The alternative addressable entity may include logic that does not access the same OER that the addressable entity ordinarily linked to resolve the unresolved reference.

In another aspect, representation generator component 6306 and rewriter 6308 may be directed by back-end component 6307 to operate in a combined, interleaved, and/or otherwise cooperative fashion to include some or all of the modifying information in modified translation 6307.

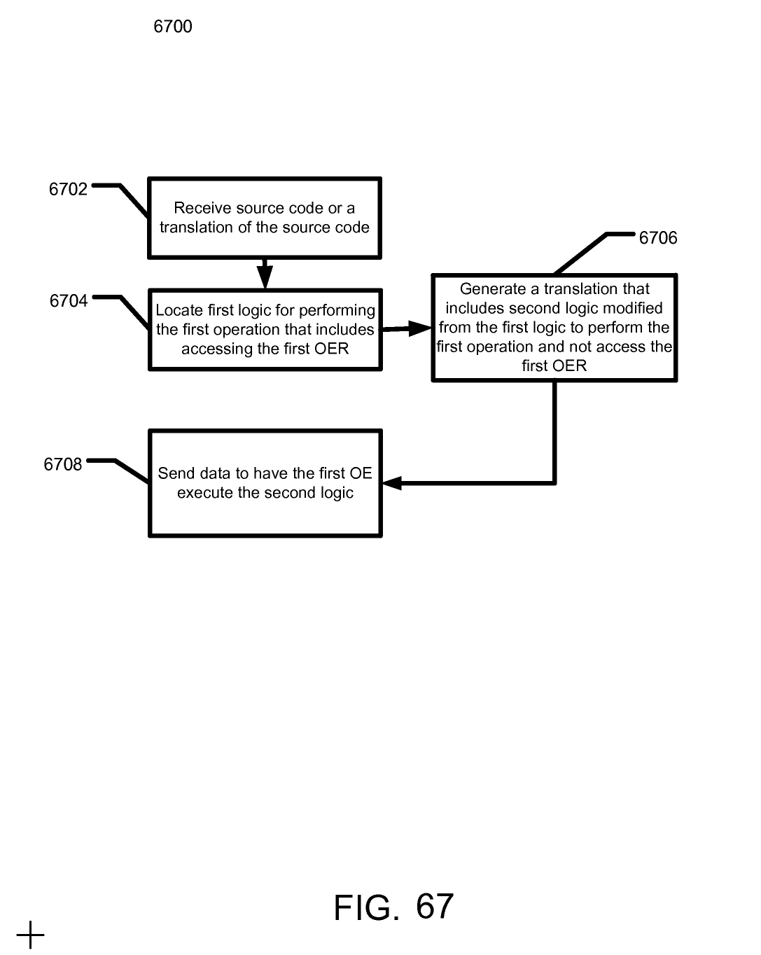

The method illustrated in FIG. 61 may include additional aspects supported by various adaptations and/or analogs of the arrangement of components in FIG. 62. For example, as described above a modify indicator may be defined to indicate that a specified addressable entity is modifiable by a programming language in a variety of ways. Logic 6204 in FIG. 62 may be adapted according to one or more of the various aspects. FIG. 67 illustrates one example of a method 6700 that may be performed in performing the method illustrated in FIG. 61. The operation of block 6702 may be performed by logic that receives and/or otherwise accesses a representation of source code, such an object code file stored on a disk drive. Such logic may be included in a frond-end component 6302, illustrated in FIG. 63. Some or all of the logic to perform the method of FIG. 67 may be included in a token handler component 6304. Performing the operation of block 6704 may include executing logic in token handler 6304 to locate an addressable entity that includes logic included in performing an operation that accesses an identified OER and/or an identified type of OER. Performing the operation of block 6706 may include executing logic included in representation generator component 6306. The logic in representation generator 6306 in one aspect may generate a translation that includes second logic modified from the first logic and/or replacing the first logic to perform the first operation and not access the first OER. For example, representation generator 6306 may provide a rewriter 6308 with a substitute reference to replace an existing unresolved reference and/or may provide substitute instructions to be included in the generated translation to modify the translation. Representation generator 6306 may include logic that coordinates operation of back-end 6307 to allow rewriter 6308 to add, replace, and/or otherwise modify a particular portion of a translating process to generate modified translation 6311. For example, rewriter 6308 may insert a modified addressable entity 6313 into modified translation 6311 during operation of back-end 6307. The operation of block 6710 may be performed by logic that sends data to direct, instruct, and/or otherwise cause the operating environment to execute an executable translation that includes the second logic. For example, compilation system 6301 may include logic that stores modified translation 6311 in a location accessible to a load system in a particular operating environment. The modified translation 6311 may be an object code translation stored in a code library and/or as an application and stored in a file system in path searched by the load system for loadable program components.

FIG. 65 illustrates a source code 6500 statement that declares a const named “count” 6502 and initialized with the value “10”. The statement may be written in an adaptation of the JAVA™ programming language according to another aspect of the subject matter described in the present disclosure. Source code 6500 includes syntactic elements “!-” 6504a and “-!” 6504b which may defined by a schema, as taught in the present disclosure, that adds for the programming a mechanism for identifying alternative values for a data addressable entity as well as for specifying one or more conditions for modifying a translation of the statement based on an alternative value. FIG. 65 illustrates a first alternative 6506 indicating the value “11” is to be used when the target operating environment includes a Linux operating system and/or a Linux container. A second alternative 6508 identifies a value for use during testing of code. A third alternative 6510 identifies a value which may be included in a modified translation for use in supporting a customer by support personnel and/or a support system. The ‘%’ may be defined to allow support personnel to specify a value as needed. The constant “count” may determine a number of OERs, such as files or records, accessed in executing instructions specified by source code that includes source code 6500. A larger value may result in a modified executable translation that accesses more OERs and a smaller value may result in a modified executable translation that accesses less OERs.

In addition or instead of modifying a number or OERs accessed, an OER modification may change a type of OER accessed, a location of an accessed OER, a size of an OER, a type of processing and/or operation performed on an OER—to name a few examples. While FIG. 65 illustrates modifying information included in source code, those skilled in the art will appreciate that source code modifying information may be translated and/or otherwise included in a translation of the source code and/or may otherwise be associated with a translation of the source code. This allows OER modification of a translation to be deferred from one translator to another translator of the output of the one translator.

Logic in token handler component 6304 in FIG. 63 may detect a modify indicator in a declaration and/or in a definition of an addressable entity. A modification for environments that include Linux is illustrated by alternative value 6506. A modification for testing of the logic is identified by alternative value 6508. A modification for use by support personnel is identified by alternative value 6510. A modify indicator may include a non-alphanumeric symbol defined by the programming language for indicating that the addressable entity is modifiable. FIG. 65 illustrates modify indicator pair “!-” and “-!” expressed in a non-alphanumeric manner.

In yet another aspect, a programming language may be specified to identify a modify indicator by an absence of an indicator indicating that the addressable entity is not modifiable. An indicator “fixed” defined by a programming language to identify an addressable entity that is not modifiable. In an aspect, an addressable entity without the “fixed” indicator may be identified as modifiable according to a specification of the programming language.

In another aspect, a modify indicator may be specified in a type defined by a programming language, such as the “int” type is defined in the C specification. FIG. 64 illustrates source code 6400 written in the C programming language adapted according to an aspect of the subject matter described in the present disclosure. Source code 6400 includes multiple addressable entities. One of the addressable entities illustrated in FIG. 64 includes “foo” addressable entity 6402 specified as a function. FIG. 64 also illustrates “traceString” addressable entity 6404 specified as a pointer to a storage location including one or more values of data type “char” defined by the C language. Both the pointer specified by “traceString” addressable entity 6404 and the storage location(s) of one or more “char” values are addressable entities specified by source code 6400. FIG. 64 also illustrates “a” addressable entity 6406 specified as an input parameter for “foo” addressable entity 6402. A data type of “int” is specified for “a” addressable entity 6406. An alternate type of “long” is specified as allowed by an extension to the programming language. A modified translation may specify instances of addressable entity a 6406 according to the type long rather than the type int. Token handler component 6304 may detect a modify indicator in a type specification. For example an addressable entity may be declared and/or defined including a reserved word indicating the addressable entity is modifiable. “foo” addressable entity 6402 in FIG. 64 may be specified as “void modifiable foo( . . . )” that may be defined in a specification of a programming language where “modifiable” is a reserved keyword that indicates that foo 6402 is a modifiable addressable entity. Alternatively or additionally, a modify indicator may be defined in a user defined type. User defined types are types that are definable in a programming language. For example, a user may define a structured type with a “modifiable” attribute defining an addressable entity with a modifiable structured type according to a particular programming language. FIG. 64 illustrates a syntax for specifies alternative types utilizing a ‘/’ character between alternative type identifies (see 6406).

Examples described above demonstrate that a modify indicator may be specified by including a reserved word, also referred to as a keyword, reserved by a programming language for indicating that an addressable entity is modifiable. The string “modifiable” described above is an example of a reserved word usable in a language such as the C language, JAVA, and/or ECMAScript extended according to the subject matter described in the present disclosure.

In another aspect, a programming language may define a naming convention for indicating that an addressable entity is modifiable. Token handler component 6304 may detect a modify indicator in and/or otherwise based on an addressable entity name or identifier. For example, a programming language may specify that identifiers that include “_mod” as a postfix are identifiers of modifiable addressable entities. This example illustrates that a name space defined by a programming language for identifiers of addressable entities may include a portion of the name space defining identifiers of modifiable addressable entities. A portion of a name space reserved for identifying an addressable entity may be defined by a naming convention as just illustrated, may be definable according to a programming language by a user, and/or may be defined as one or more identifiers reserved for identifying modifiable addressable entities and explicitly specified, for example, in a list.

An addressable entity or a portion thereof is associated with one or more locations. For example, an addressable entity may be defined according to a language in one location, declared in another location, and/or referenced in yet another location in source code. A translation of an addressable entity may be associated with one or more locations in a translation of the source code. A rewriter component 6308 may process modifying information that identifies one or more locations corresponding to an addressable entity in a translation. For example, a location may be identified by an address such as an offset into a file and/or a location may be identified by a marker or symbol for a matching location. A location identifier may be based on another identifier. For example, an identifier may identify an addressable entity within an identified scope and/or relative to a location of another addressable entity.

FIG. 66 illustrates a source code statement 6600 that declares and initializes a data structure named defaultResolution 6602 which may part of source code written in any number of programming languages. FIG. 66 shows that defaultResolution 6602 includes an “x” addressable entity 6604 initialized with a value of “1024” and a “y” addressable entity 6606 initialized with a value of “768”. The defaultResolution addressable entity 6602 may be included in source code with instructions that allocate a presentation space with the assigned resolution. Additionally, instructions may be included that select an output device based on the assigned resolution. That is, a different resolution may result in a different output device being selected or no output device (e. g. one or both of x addressable entity 6604 and y addressable entity 6606 may be unassigned or assigned a value too small for any output device to support). FIG. 66 also illustrates metadata 6608 that may be associated with source code (not shown) that includes source code statement 6600 and/or a translation of the source code including a translation of statement 6600. The translation of the statement may be modified and/or may include and/or be associated with modifying information as described elsewhere in the present disclosure.

In an aspect, the source code may be written in a scripting language, such as the BASH shell script language, adapted according to yet another aspect of the subject matter described in the present disclosure. Metadata 6608 illustrates substitute code that may be substituted into the source and/or translated for substitution into a translation of the source code. Further details are provided below.

A programming language may specify or define a format, a syntax, a vocabulary, and/or a grammar for expressing a valid modify indicator in the programming language as described above and illustrated in FIG. 64, FIG. 65, and FIG. 66. The string “modifiable” may be defined as a reserved keyword for including in a modify indicator. A programming language may specify one or more such keywords defining a vocabulary for at least a portion of a modify indicator for the language.

A programming language may define a modify indicator to allow modify indicators to identify one or more attributes. A modify indicator may be specified that includes a tag and/or other annotation as an attribute of a modify indicator. The annotation attribute value may be predefined by the programming language and/or may be user defined. A matching criterion that matches based on a particular tag may be defined for modifying groups and/or sets of addressable entities defined by the particular tag. An attribute identified by a modify indicator may include a tag, a phrase, a symbol, a symbolic expression, a condition, a logical expression, a mathematical expression, and/or other annotation. Token handler component 6304 may detect attributes identified by a modify indicator, and representation generator 6306 may generate modifying information to be processed by rewriter 6308. The modifying information may identify the one or more attributes and/or may otherwise be based on the one or more attributes. See FIG. 66 and the associated description above. In another aspect, modifying information may be stored by back-end component 6307 external to a generated translation and/or may be included in a translation for processing by a subsequent translator.

Modifying information may identify a location of an addressable entity in a translation of source code based on a programming language specifying the source code and/or a representation language of the translation. The location may be based on a format, a syntax, a grammar, and/or a vocabulary defined by the programming language of the source code and/or the representation language of the translation. Modifying information may identify an attribute of a modify indicator. The attribute may be specified in the source language code and/or the representation language of the translation. The attribute may be specified according to the source language by a user. The attribute may include a tag, a phrase, a symbol, a symbolic expression, a condition, a logical expression, a mathematical expression, and/or other annotation in the source code. The attribute may be included in determining whether an associated modifiable addressable entity is to be modified from a second translation as described below. A translation of source code including and/or otherwise associated with modifying information may include an assembler language statement, a statement in a high-level programming language, object code, byte code, and/or machine code.

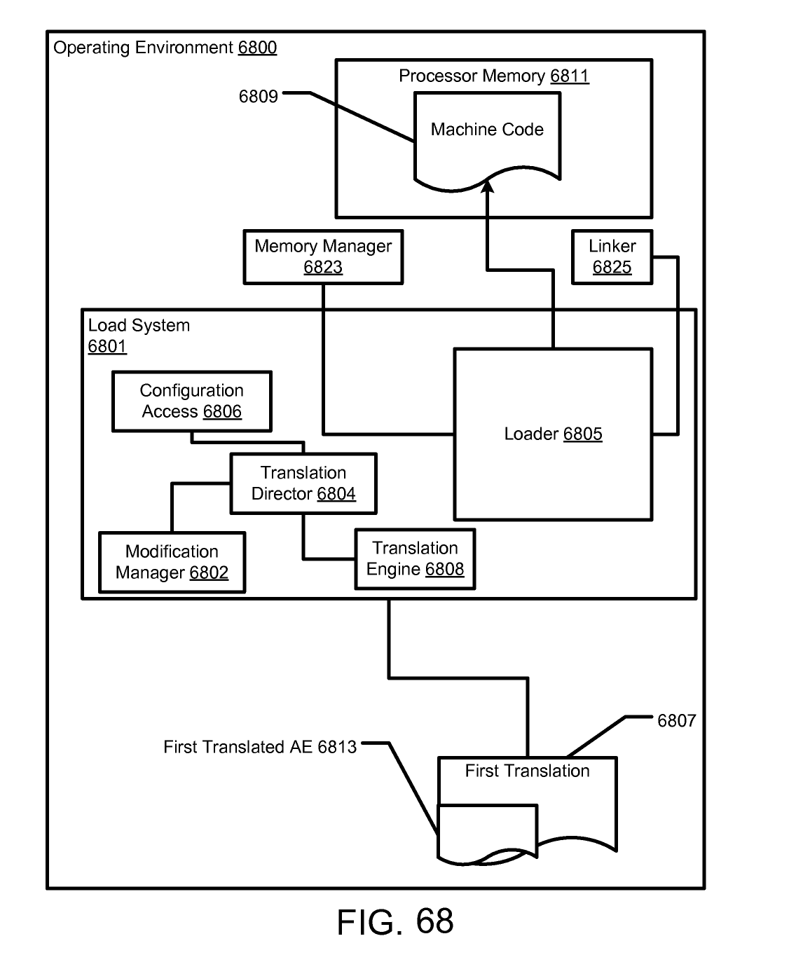

FIG. 68 illustrates operating environment 6800 hosting load system 6801 for loading a program component translated from source code into a processor memory of operating environment 6800 for accessing by a processor to execute one or more machine code instructions included in the machine code translation of the source code. Aspects of operation of a load system are described above with respect to FIG. 4 which are not repeated, but may be embodied in load system 6801. FIG. 68 illustrates an adaptation of the arrangement of components in FIG. 62 in load system 6301. FIG. 68 illustrates loader component 6805 in load system 6801. Loader component 6805 may receive a first translation 6807 generated from source code written in a programming language. The first translation may be any translation described above, an analog, and/or an equivalent.

First translation 6807 may include machine code 6809 that is executable by a processor or operation environment 6800 when translated into an executable translation in an address space defining a processor memory 6811 of the processor. In another aspect, first translation 6807 may include intermediate code, such as byte code, that is translated into machine code 6809 for loading.

First translation 6807 as described above may include a first translation of an addressable entity 6813 where the addressable entity is specified in the programming language in the source code. In an aspect, some or all of first translation 6807 may be generated from source code 6400 illustrated in FIG. 64. In another aspect, some or all of first translation 6807 may be generated from source code 6500 in FIG. 65. In yet another aspect, some or all of first translation 6807 may be generated from source code 6600 in FIG. 66. FIG. 68 illustrates modification manager 6804 for receiving and/or otherwise detecting modifying information. Modifying information may be generated as described with respect to FIG. 63. As described above, an arrangement of components such as in compilation system 6301 in FIG. 63 may generate first translation 6807 and may produce modifying information identifying first translated AE 6813. Logic in a modification manager 6802 may detect some or all modifying information in metadata such as illustrated in FIG. 66.

In an aspect, logic may be included in a translation director component 6804 may interoperate with configuration access component 6806 to receive and/or otherwise detect translation configuration information. Some or all translation configuration information may be included in and/or otherwise identified by modifying information generated for a translation of source code as described above with respect to FIG. 63. Translation configuration information may be included in first translation 6807 and/or may be stored external to first translation 6807.

In another aspect, configuration access component 6806 may receive translation configuration information including and/or otherwise identifying a policy or condition for modifying a translation of source code based on corresponding modifying information. A policy or condition may include and/or otherwise be based on a matching criterion for determining what to modify in a modified translation of a first translation of source code. A policy or condition may be predefined for operating environment 6800. A predefined policy or condition may be received and/or identified by configuration access component 6806 in response to user input selecting and/or otherwise associating the predefined policy or condition with translation configuration information for first translation 6807. Alternatively of additionally, a policy or condition may be specified based on information received from a user, as may any other information included in and/or otherwise identified by translation configuration information.

FIG. 65 illustrates that a programming language syntax may be defined by the programming language for specifying one or more attributes for determining whether a matching criterion may be met. A matching criterion may be specified for determining whether an addressable entity is to be modified in a translation of a first translation of source code. A matching criterion may be specified based on available attribute information in the first translation. For example, a first translation may include and/or otherwise be associated with a symbol table generated from source code for the first translation. Translation configuration information detected in a file associated with first translation 6807 and/or included in first translation 6807 may include a matching criterion based on information maintained in the symbol table and/or in other metadata in and/or otherwise associated with first translation 6807.

In FIG. 66, translation configuration information may specify a matching criterion based on a name in source code 6600. Element 6610 is matched based the name “defaultResolution” as shown. Any suitable indicator definable in a representation language may specify a modifying indicator. A naming convention for addressable entities may be defined for providing modifying indicators. For example, a representation language may specify a name space for translator generated symbolic identifiers for addressable entities translated from modifiable addressable entities specified in source code.

A modification manager 6802 may determine whether a matching criterion specified in translation configuration information is met for modifying a translation of source code. Also as described above, translation configuration information may specify a matching criterion that is met when evaluated based on attribute information in a symbol table and/or other data associated with a translation. Modification manager 6802 may determine whether a matching criterion specified in translation configuration information is met for a particular OER modification. Other matching criteria may be included in translation configuration information to narrow a matching condition or to expand it. Logical operations such as “and” and “or” operators and/or analogs may allow for more complex matching conditions to be configured.

With respect to FIG. 66, translation configuration information may specify a matching criterion that is met based on matching label identifiers specified in a programming language. Locations of translated addressable entities identified by the labels may be stored in symbol table entries for the respective labels. Modification manager 6802 may determine whether a matching criterion specified in translation configuration information is met for a modifiable entity at a location labeled in the programming language with “defaultResolution”. For example, modification manager 6804 may determine that translation configuration information, including the matching criterion “default*”, is met for labeled locations “defaultResolution” AE 6602 and any other addressable entities whose name begins with “default”. A schema for the translation configuration information may define a format and/or a vocabulary identifying and expressing valid matching criterion expressions.

In FIG. 68, modification manager 6802 may identify to translation engine component 6808 a location of a translation of an addressable entity in a translation. Translation director component 6804, in an aspect, may direct the interoperation of modification manager 6802 and translation engine component 6808. Translation engine component 6808 may generate an intermediate translation and/or may generate an executable translation (i.e. machine code 6809) stored in a processor memory 6811 of operating environment 6800.

Translation engine component 6808 may translate first translation 6807 modifying the modifiable first translated addressable entity 6813 and/or other addressable entities identified by modification manager 6802. In another aspect, translation engine component 6808 may generate a translation including a second translation of first translated AE 6813. Translation engine component 6808 may then modify second translations of the one or more addressable entities from the second translation of the source code. When producing code for loading into a processor memory for execution, translation engine component 6808 may interoperate with loader component 6805 to modify the one or more addressable entities when loading the second translation into a processor memory as machine code for execution in operating environment 6800.

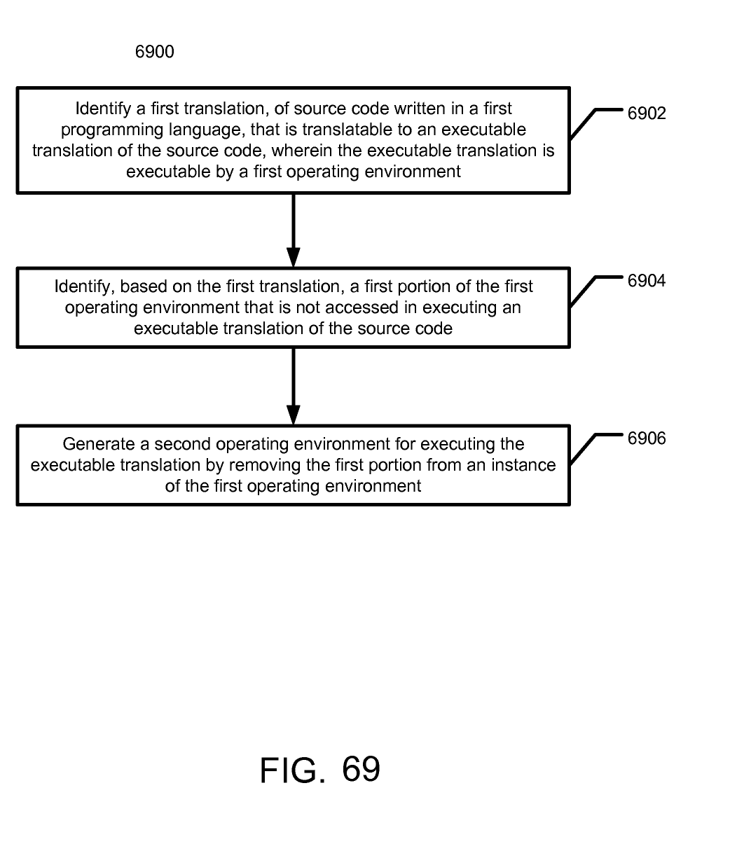

FIG. 69 shows method 6900. Method 6900 includes identifying a first translation, of source code written in a first programming language, which is translatable to an executable translation of the source code, wherein the executable translation is executable by a first operating environment. See block 6902. Additionally, method 6900 includes identifying, based on the first translation, a first portion of the first operating environment that is not accessed in executing an executable translation of the source code. See block 6904. Also, method 6900 includes generating a second operating environment for executing the executable translation by removing the first portion from an instance of the first operating environment. See block 6906.

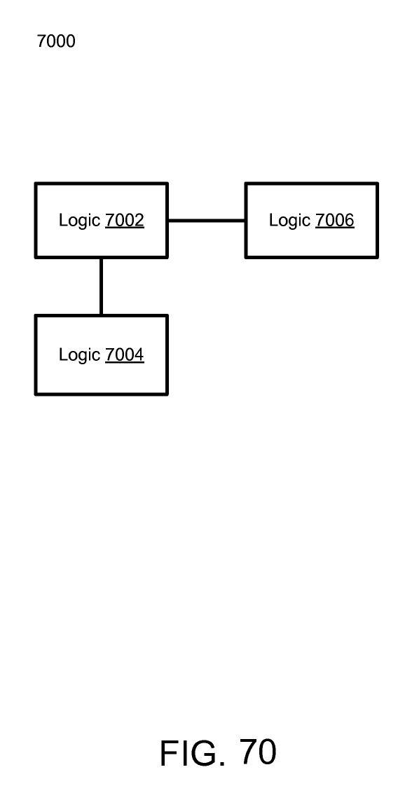

As an option, method 6900 may be implemented based on an arrangement 7000 of logic illustrated in FIG. 70. The arrangement 7000 may include logic 7002 that is included in identifying a first translation, of source code written in a first programming language, which is translatable to an executable translation of the source code, wherein the executable translation is executable by a first operating environment. The arrangement 7000 may also include logic 7004 that is included in identifying, based on the first translation, a first portion of the first operating environment that is not accessed in executing an executable translation of the source code. Additionally, the arrangement 7000 may include logic 7006 that is included in generating a second operating environment for executing the executable translation by removing the first portion from an instance of the first operating environment.

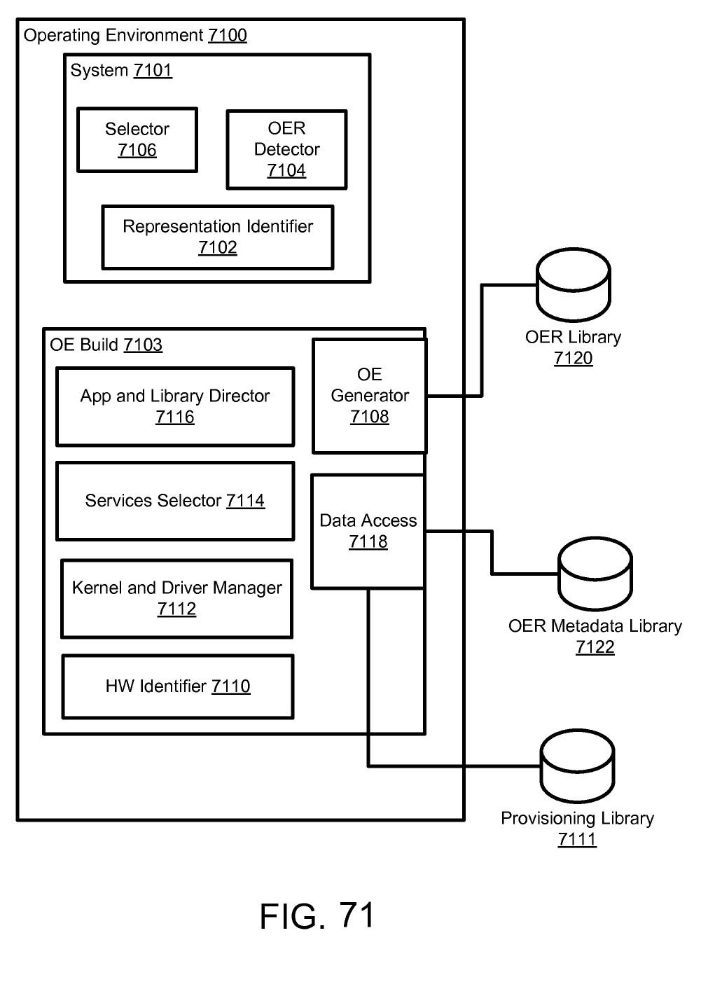

FIG. 71 illustrates an operating environment 7100 that includes logic and/or analogs of logic illustrated in FIG. 70 for performing the method of FIG. 69. Such logic may be included in logic for a system 7101 and/or in logic included in creating, configuring, instantiating, and/or managing an operating environment, such as illustrated by OE build component 7103. Aspects of operation of components and logic illustrated in FIG. 71 have been described above with respect to FIG. 57 which are not now repeated.

Logic 7002 may be included in representation identifier 7102 in system 7101 that when executed identifies a first translation, of source code written in a first programming language, that is translatable to an executable translation of the source code, wherein the executable translation is executable by a first operating environment. Logic 7004 may be included in OER detector 7104 that when executed determines and/or otherwise identifies, based on the first translation, a first portion of the first operating environment that is not accessed in executing an executable translation of the source code. In one aspect, OER detector 7104 may access and/or otherwise receive operating environment information that identifies one or more OERs included in and/or includable in a particular operating environment.

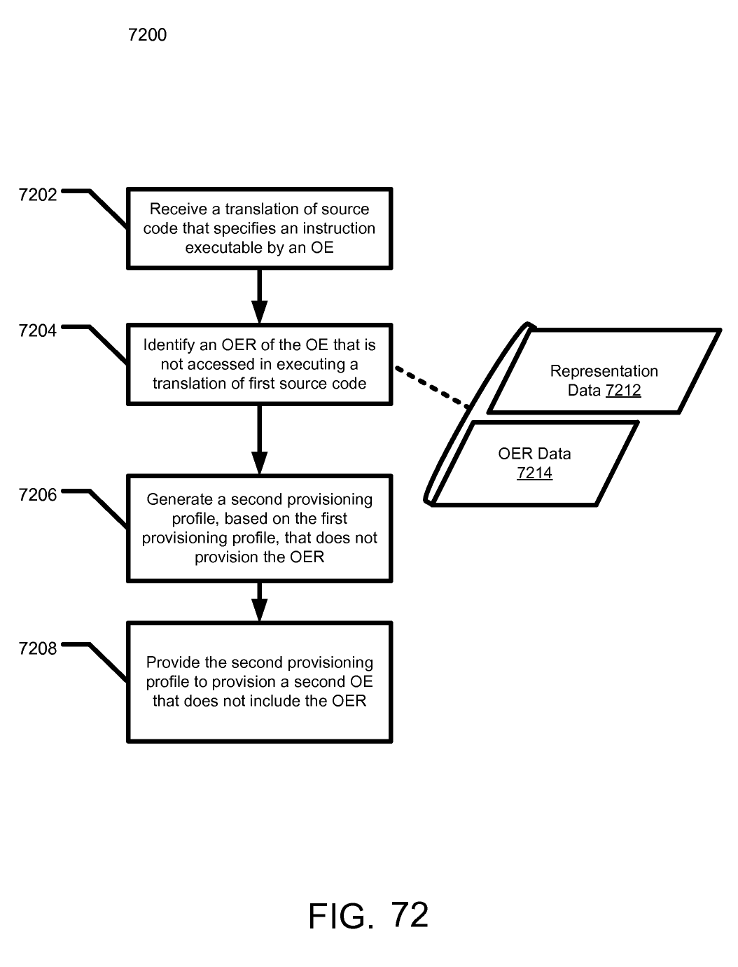

FIG. 72 illustrates one example of a method 7200 that may be performed in performing the method illustrated in FIG. 69. The operation in block 7202 may be performed by logic that receives a translation of source code that specifies an instruction executable by an operating environment. Logic that performs the operation in block 7202 may be included in a representation identifier component 7102. Logic that performs the operation of block 7204 may be included in an OER detector 7104 and in an OE build component 7103. The operation in block 7204 may be performed by logic that determines and/or otherwise identifies an OER that is not accessed by the operating environment in executing the instruction and/or operation specified in the source code. In an aspect, OER detector 7104 including logic to perform the operation of block 7206 may interoperate with logic that analyzes the translation data and/or metadata for the translation 7212 to identify a reference and/or other access to an OER, such as an OER in an OER Container, for the instruction(s) and/or operation. Additional logic may be included in and/or invoked by OER detector 7104 that identifies one or more OERs not accessed based on data from and/or otherwise about the operating environment, see OER data 7214.

As described elsewhere in the present disclosure, operating environment data may include and/or may be included in a provisioning profile, a registry whether dynamic or static, an installable and/or otherwise executable image, and/or other metadata for the current candidate operating environment and optionally other candidate operating environments. The operation in 7206 may be performed by logic that generates, based on identification of OERs accessed and not accessed, a new provisioning profile for an operating environment that does not include data for provisioning one or more of the OERs not accessed. Such logic may be included in an OE generator component 7108. The operation in block 7208 may be performed by logic in a data access component 7104. The logic may be executed in providing the new provisioning profile to provision a second operating environment that does not include the one or more unaccessed OERs. Data access component 7118 may store the new provisioning profile in provisioning library (local and/or remote from operating environment 7100. The provisioning profile may be identified in an association stored in a record in provisioning library 7111 where the record associates the new profile with a representation of the source code.

An OER that is not accessed may be explicitly identified and/or may be determined by OE build based information identifying one or more OER OERs that are accessed in performing the one or more instructions specified in the source code. In another aspect, an OE build may build an operating environment to perform an instruction specified in source code based information identifying one or more OERs that are accessed in executing the instruction thereby excluding one more OERs that are not accessed.

As described with respect to FIG. 57, FIG. 71 illustrates HW identifier 7110 that may include logic to disable, remove, and/or modify one more hardware OERs and/or portions thereof not accessed in performing an instruction specified in the source code processed by system 7101 as described above. FIG. 71 also illustrates kernel and driver manager 7112 that may include logic to disable, remove, and/or modify one more drivers and/or kernel services and/or portions thereof not accessed in performing an instruction specified in the source code. For example, executing an executable translation of the source code may not require access control, such as read/write control, for data segments allocated by a memory manager included in the kernel. The executing may not include accessing a mouse, thus a device driver for a pointing device may be identified by kernel and driver manager 7112 to modify from the operating environment to be built. FIG. 71 additionally illustrates services selector 7114 that may include logic to disable remove, and/or modify one more operating environment services and/or portions thereof not accessed in performing an instruction specified in the source code. For example, executing an executable translation of the source code may not DNS caching, disk encryption, nor any listening ports or endpoints of one or more network protocols. Services selector 7114 may identify these services to modify them from an existing operating environment and/or to modify them from an operating environment to be built. FIG. 71 further illustrates application and library director 7116 that may include logic to disable, remove, and/or modify one more operating environment dynamic link libraries, static libraries, and/or applications and/or portions thereof, which are not translations of the source code that specifies the instruction(s) to be performed by the generated operating environment. Whole libraries and applications may be modified and/or parts of libraries and/or parts of applications not accessed in performing the instruction(s) specified in the source code may be identified to remove them from and/or otherwise modify them in to generate a modified operating environment.

A portion of an operating environment may be removed by modifying an installer for the operating environment. An installer may include metadata such as manifest that identifies components to be installed. OE generator 7108 may remove one or more entries from such a manifest. Installer metadata for an operating environment may also include dependency information. OE generator 7108 may also remove components that a removed portion is dependent upon and/or is otherwise unneeded. In another aspect, OE generator 7108 may add metadata to include a component otherwise not included in an installation of the operating environment. The added component may operate as a substitute for at least part of one more removed portions of the operating environment.

Portions or parts of an operating environment may be specified by one or more locations. For example, a driver for an operating environment may be stored in a particular location in a memory. A portion of an operating environment may be removed from the particular location. Alternatively or additionally, the portion may be removed by removing and/or modifying an identifier of the location, so that the operating environment includes a part, component, and/or logic stored in another location. Such a location may be part of an active operating environment. Such a location may be part of an operating environment that is not operating, such as an operating environment on a disk drive that has not been booted. The disk driver may be local, remote, and/or virtual (such as a “cloud” drive with physical storage replicated and/or otherwise distributed across a number of storage devices).

A hardware portion of an operating environment may be removed by disabling it. A hardware portion may be removed via mechanical and/or electro-mechanical means. Those skilled in the arts will appreciate that automated assembly-line technology is capable of both assembling and disassembling hardware. In an aspect, an OE generator may direct an assembly line to construct an operating environment including hardware based on a representation of source code processed by systems in all aspects described in the present disclosure. A portion of a provisioning profile may be removed in performing an aspect of the method of FIG. 69.

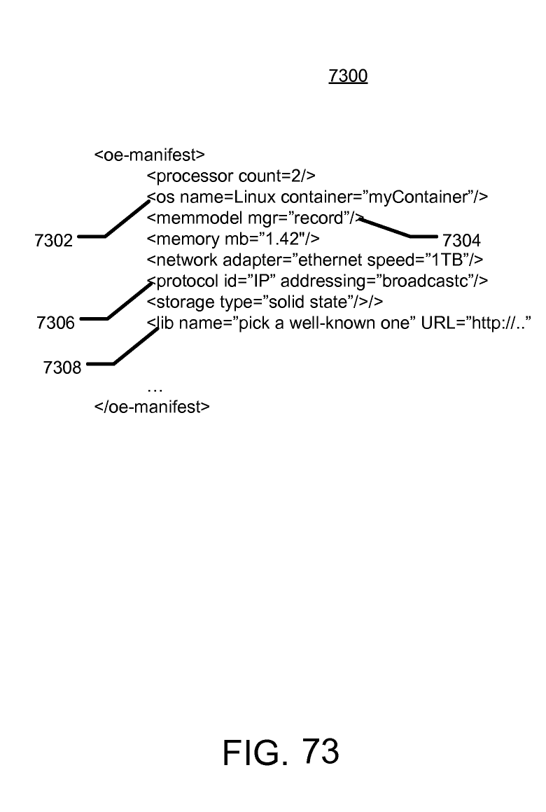

FIG. 73 illustrates a portion of an exemplary manifest 7300 for an operating environment. The manifest may identify OERs included in an operating environment. Manifest 7300 identifies a container operating environment that operates as a Linux container in a Linux operating system that may also be specified in the manifest. A manifest may identify hardware included in the operating environment. The level of specificity may vary as logic that processes a manifest may vary according to its particular logic. For example, manifest 7300 identifies a Linux container OS in os element 7302, but provides no further detail. Such detail may be provided by a user, coded into logic that processes manifest 7300, and/or may be automatically determined by logic processing the manifest based on a suitable attribute such as a user, a legal entity, other data in the manifest, a geographic location, a date, a time, and/or a type of network. Manifests may be specified according to various schemas. Some may be expressed in human readable text while other representations may be encoded in any of various other machine readable encodings. FIG. 7400 illustrates a manifest 7400 generated from manifest 7300 by logic, for example, in an OE generator 7108.

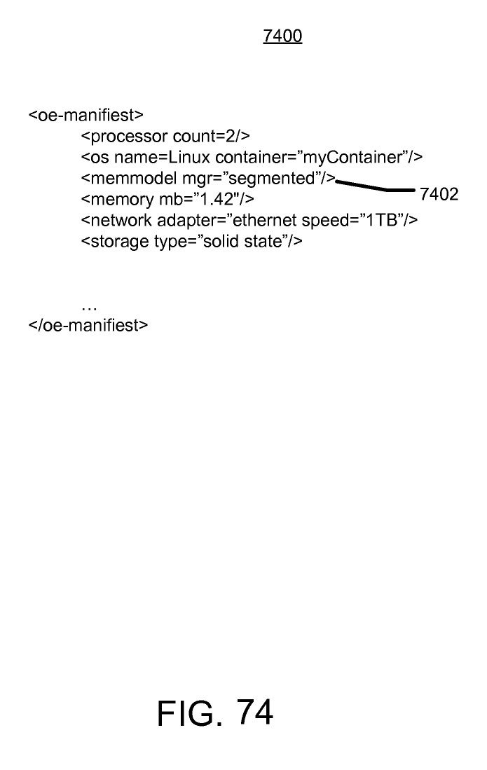

System 7101 may receive a representation of source code and determine that executing one or more instructions specified in the source code does not require and/or otherwise result in access to a memory manager that stores executable code in segments in a virtual processor memory as indicated by element 7304 in manifest 7300. OE generator may remove element 7304. FIG. 74 shows that OE generator 7108 may add an element 7402 to include a memory manager that provides a segmented storage layout rather than a record-based layout for an executable translation of the source code.

System 7101 may further determine that logic to support a particular type of network protocol address identified by element 7306 as a broadcast address for the IP protocol. OE generator 7108 may generate manifest 7400 without such an element.

System 7101 may further determine that logic in an identified code library identified by element 7308 is not accessed in executing the instruction(s) in the source code represented to system 7101. OE generator 7108 may generate manifest 7400 without such an element.

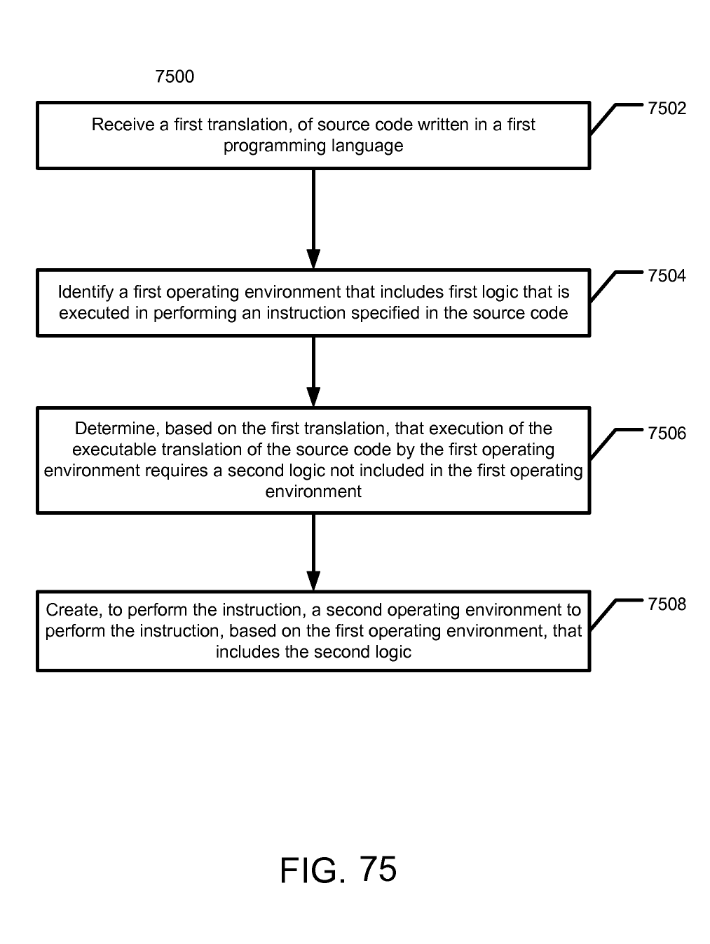

FIG. 75 shows a method 7500. Method 7500 includes receiving a first translation, of source code written in a first programming language. See block 7502. Additionally, method 7500 includes identifying a first operating environment that includes first logic that is executed in performing an instruction specified in the source code. See block 7504. Also, method 7500 includes determining, based on the first translation, that execution of the executable translation of the source code by the first operating environment requires a second logic not included in the first operating environment. See block 7506. Further, method 7500 includes creating, to perform the instruction, a second operating environment to perform the instruction, based on the first operating environment, which includes the second logic. See block 7508.

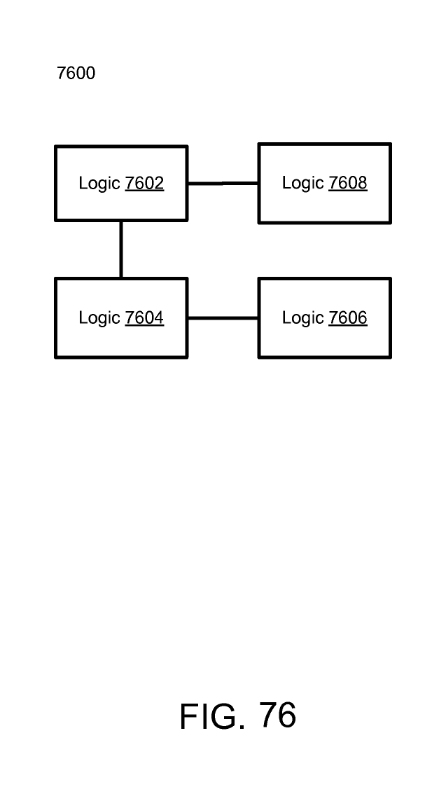

As an option, method 7500 may be implemented based on an arrangement 7600 of logic illustrated in FIG. 76. The arrangement 7600 may include logic 7602 that is included in receiving a first translation, of source code written in a first programming language. The arrangement 7600 may also include logic 7604 that is included in identifying a first operating environment that includes first logic that is executed in performing an instruction specified in the source code. Additionally, the arrangement 7600 may include logic 7606 that is included in determining, based on the first translation (e. g. metadata for the first translation), that execution of the executable translation of the source code by the first operating environment requires a second logic not included in the first operating environment. The arrangement 7600 may further include logic 7608 that is included in creating, to perform the instruction, a second operating environment to perform the instruction, based on the first operating environment, which includes the second logic.

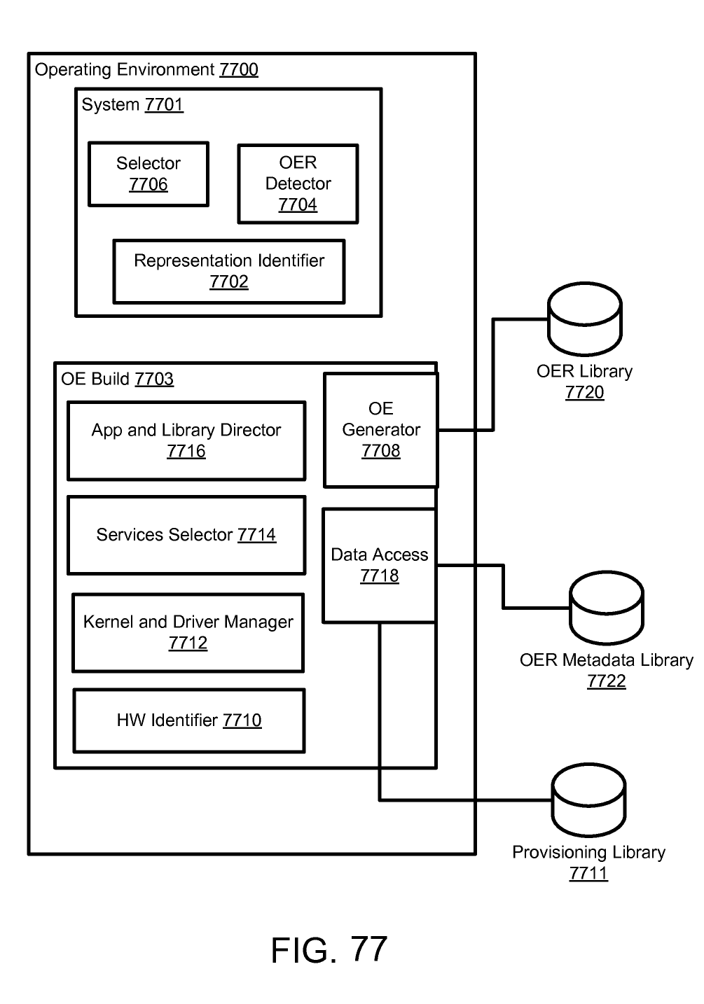

FIG. 77 illustrates an operating environment 7700 that includes logic and/or analogs of logic illustrated in FIG. 76 for performing the method of FIG. 75. Such logic may be included in logic for a system 7701. Embodiments of logic for identifying a representation of source code written in a programming language are described above and further alternatives and additional aspects are described in various other locations below. Logic 7602 may be included in representation identifier 7702, in system 7701, that when executed receives and/or otherwise identifies a first translation, of source code written in a first programming language.

Logic 7604 may be included in OER detector 7704 that when executed identifies a first operating environment that includes first logic that is executed in performing an instruction specified in the source code. In one aspect, OER detector 7704 may access and/or otherwise receive operating environment information that identifies one or more OERs included in and/or includable in a particular operating environment. OER detector may identify one or more OERs that are not accessed in executing an executable translation of the source code. OER detector 7704 may also include logic 7606 in FIG. 76 that determines, based on the first translation, which execution of the executable translation of the source code by the first operating environment requires second logic not included in the first operating environment. Additional logic may be included in system 7701 that interacts with an OE build 7703 that further customizes the selected operating environment and/or otherwise creates an operating environment that includes and/or otherwise executes the second logic.

Referring to FIG. 77, OE build 7703 may retrieve and/or otherwise receive information identifying the second logic. OE build 7703, in an aspect may access one or more active operating environments operating in and/or or otherwise including a device. Alternatively or additionally, OE build 7703 may access representations as described above, for example with respect to FIG. 57.

FIG. 7703 illustrates HW identifier 7710 that includes logic to disable, add, remove, and/or modify one more hardware OERs to add logic needed to perform an instruction identified in source code and/or in a translation of the source code processed by system 7701 as described above. FIG. 77 also illustrates kernel and driver manager 7712 that includes logic to disable, add, remove, and/or modify one more drivers and/or kernel services to add logic needed to perform an instruction identified in source code and/or in a translation of the source code processed by system 7701. For example, executing an executable translation of the source code may require access control, such as read/write control, for data segments allocated by a memory manager included in the kernel. The executing may include accessing a mouse, thus a device driver for a pointing device may be identified by kernel and driver manager 7710 to modify from the operating environment to be built. FIG. 77 additionally illustrates services selector 7714 that includes logic to disable, add, remove, and/or modify one more operating environment services to add logic needed to perform an instruction identified in source code and/or in a translation of the source code processed by system 7701 as described above. For example, executing an executable translation of the source code may require DNS caching, disk encryption, or one or more listening ports or endpoints of one or more network protocols. Services selector 7714 may identify these services to add needed logic to an existing operating environment and/or to include the needed logic in an operating environment to be built. FIG. 77 further illustrates application and library director 7716 that includes logic to disable and/or modify one more operating environment dynamic link libraries, static libraries, and/or applications that are not translations of the source code that specifies the instruction(s) to be performed by the generated operating environment. Whole libraries and applications may be modified and/or added to add needed logic. Parts of libraries and/or parts of applications may be modified and/or added to add needed logic to perform the instruction(s) specified in the source code.

Application and library director 7716, services selector 7714, kernel and driver manager 7712, and HW identifier 7710 may access OER and/or operating environment representations from one or more data stores illustrated by OER library 7720 and OER metadata library 7722 either or both of which may be accessed via data access logic 7718. OER library 7720 illustrates a data store for storing source code and/or translations of source code for instantiating an operating environment and/or for adding an OER to an operating environment. OER metadata library 7722 illustrates a data store that includes information that identifies operating environment images and/or OERs along with metadata for accessing and/instantiating the operating environment images and/or OERs in and/or including a hardware device. Exemplary metadata includes processor compatibility information, programming language compatibility information, dependencies on other OERs, configuration information, and initialization information—to name a few examples. Options may be selected by OE build 7703 based on the source code and/or representation of the source code that is processed, may be selected by a user interacting with OE build 7703, may be selected by a device included in instantiating the generated and/or otherwise specified operating environment, may be selected by a user of a device that provides the generated operating environment and/or is otherwise included in the generated operating environment.

In an aspect, a hardware component, data, and/or logic may be added to an operating environment by modifying an installer for the operating environment. An installer may include metadata such as a manifest, list, and/or other data that identifies components to be installed. A component may include hardware, software, data, and/or logic in some other form. OE generator 7708 may add and/or modify one or more components identified in and/or based on a manifest. Installer metadata for an operating environment may also include dependency information. The dependency metadata may be included in the manifest and/or may be maintained separately. OE generator 7708 may also add components that another added component is dependent upon and/or otherwise needs. In another aspect, OE generator 7708 may add and/or remove metadata to add and/or remove components. An added component may operate as a substitute for at least part of one more removed components and/or removed parts of components.

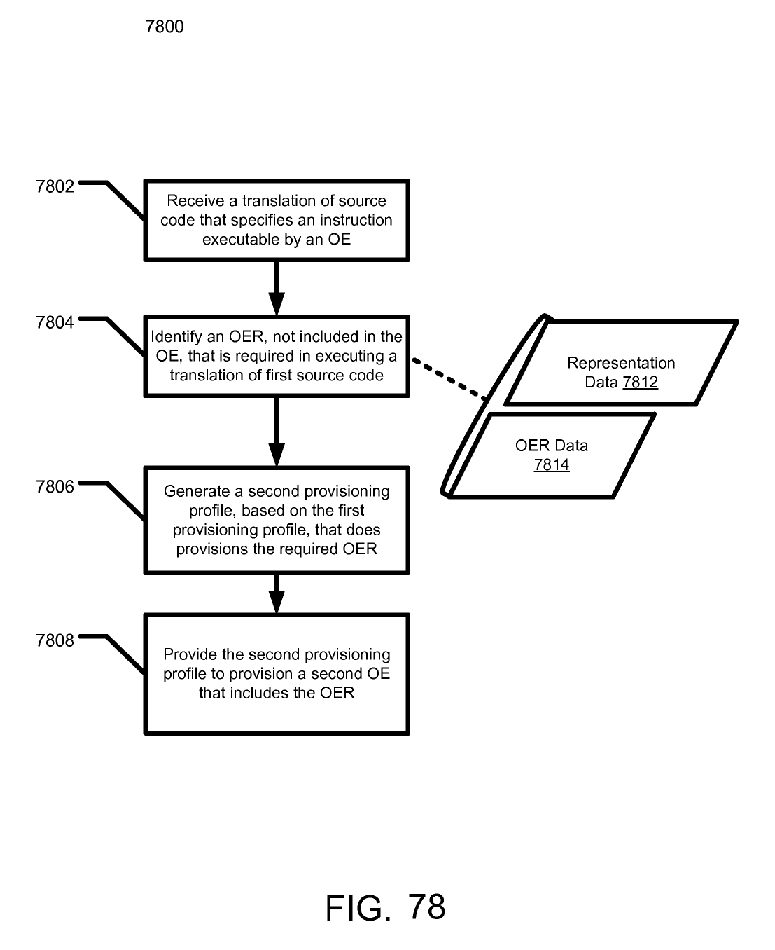

FIG. 78 illustrates one example of a method 7800 that may be performed in performing the method illustrated in FIG. 75. The operation in block 7802 may be performed by logic that receives a translation of source code that specifies an instruction executable by an operating environment. Logic that performs the operation in block 7802 may be included in a representation identifier component 7702. Logic that performs the operation of block 7804 may be included in an OER detector 7704 and/or in an OE build component 7703. The operation in block 7804 may be performed by logic that determines and/or otherwise identifies an OER that is not in operating environment and that is required in executing the instruction and/or operation specified in the source code. In an aspect, OER detector 7704 may include logic that interoperates with logic in OE build 7703 that may analyze the translation and/or metadata for the translation 7812 to identify a reference and/or other access to an OER, such as an OER in an OER Container, for the instruction(s) and/or operation. An OE generator 7708 may include logic to perform the operation of block 7806 that generates and/or otherwise creates a second provisioning profile, based on the first provisioning profile for the operating environment that does not include the required OER. The logic when executed may include generates the second profile that does provisions the required OER in an operating environment provisioned based on the second profile.

Additional logic may be included in and/or invoked by OER detector 7704 that identifies one or more OERs that are required and/or otherwise desirable based on data from and/or otherwise about the operating environment, see OER data 7814. As described elsewhere in the present disclosure, operating environment data may include and/or may be included in a provisioning profile, registry whether dynamic or static, an installable and/or otherwise executable image, and/or other metadata for the current candidate operating environment and optionally other candidate operating environments. The operation in 7806 may be performed by logic that generates, based on identification of OERs accessed and not accessed, a new provisioning profile for an operating environment that does includes data for provisioning one or more of OERs not previously included and required or desired for executing the instruction(s). Such logic may be included in an OE generator component 7708. The operation in block 7808 may be performed by logic in a data access component 7718. The logic may be executed in providing the new provisioning profile to provision a second operating environment that does include the one or more previously inaccessible OERs. Data access 7718 may store the new provisioning profile in provisioning library (local and/or remote from operating environment 7700). The provisioning profile may be identified in an association stored in a record in provisioning library 7711 where the record associates the new profile with a representation of the source code.

A hardware portion of an operating environment may be added by enabling and/or otherwise activating it. In another aspect, a hardware portion may be added via mechanical and/or electro-mechanical means. Those skilled in the arts will appreciate that automated assembly-line technology is capable of both assembling and disassembling hardware as well as adding and/or removing code and other data. In an aspect, an OE generator 7716 may direct an assembly line to construct an operating environment including hardware based on a representation of source code. A portion of a default OE build configuration may be added in performing the method of FIG. 75, in an aspect.

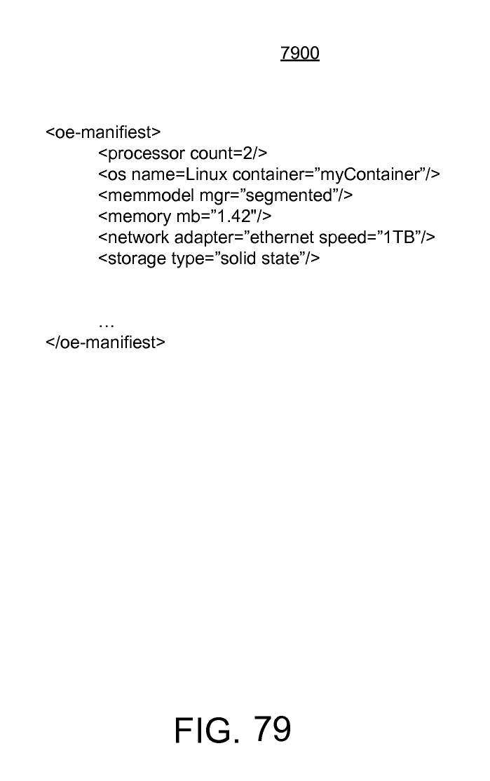

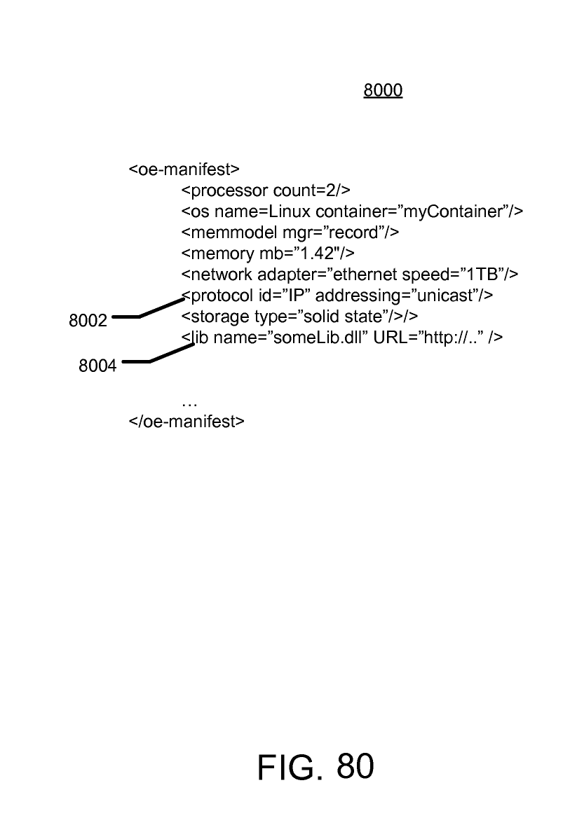

FIG. 79 illustrates a portion of an exemplary manifest 7900 for an operating environment. The manifest may identify OERs included in an operating environment. FIG. 8000 illustrates a manifest 8000 generated from manifest 7900 by logic in an OE generator 7708. System 7701 may determine that logic is needed to support a particular type of network protocol address. OE generator 7708 may generate manifest 8000 including protocol element 8002 indicating that logic that supports IP with unicast addressing is to be added to an operating environment generated based on manifest 7900. System 7701 may further determine that logic in an identified code library is accessed in executing the instruction(s) in the source code represented to system 7701. A lib element 8004 may be included in manifest 8000.

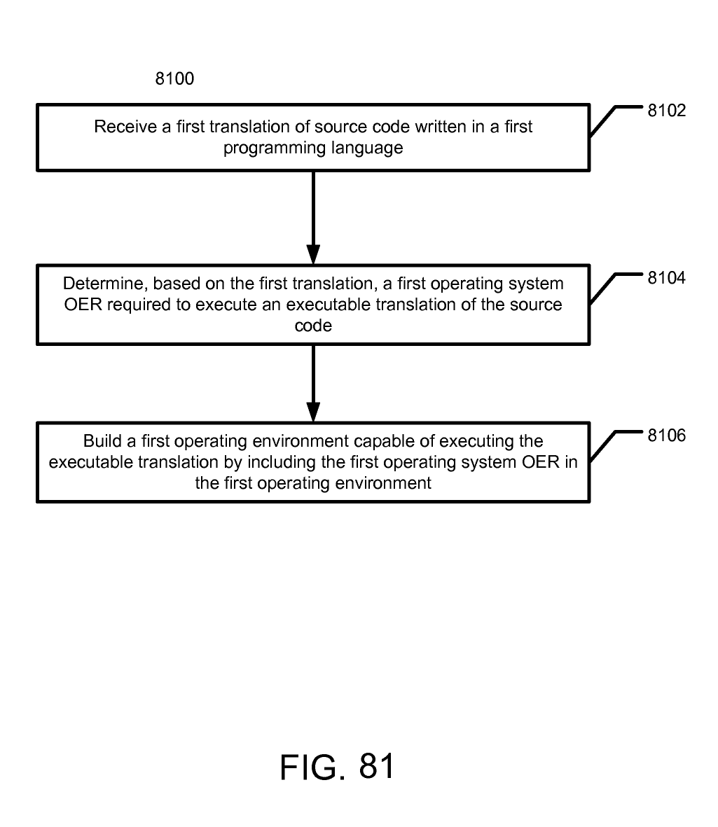

FIG. 81 shows method 8100. Method 8100 includes receiving a first translation of source code written in a first programming language. See block 8102. Additionally, method 8100 includes determining, based on the first translation, a first operating system OER required to execute an executable translation of the source code. See block 8104. Also, method 8100 includes building a first operating environment capable of executing the executable translation by including the first operating system OER in the first operating environment. See block 8106.

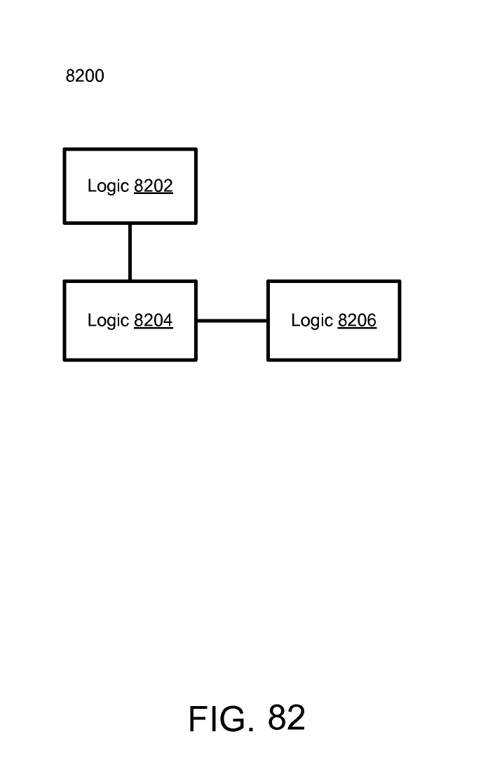

As an option, method 8100 may be implemented based on an arrangement 8200 of logic illustrated in FIG. 82. The arrangement 8200 may include logic 8202 that is included in receiving a first translation of source code written in a first programming language. The arrangement 8200 may also include logic 8204 that is included in determining, based on the first translation, a first operating system OER required to execute an executable translation of the source code. Additionally, the arrangement 8200 may include logic 8206 that is included in building a first operating environment capable of executing the executable translation by including the first operating system OER in the first operating environment.

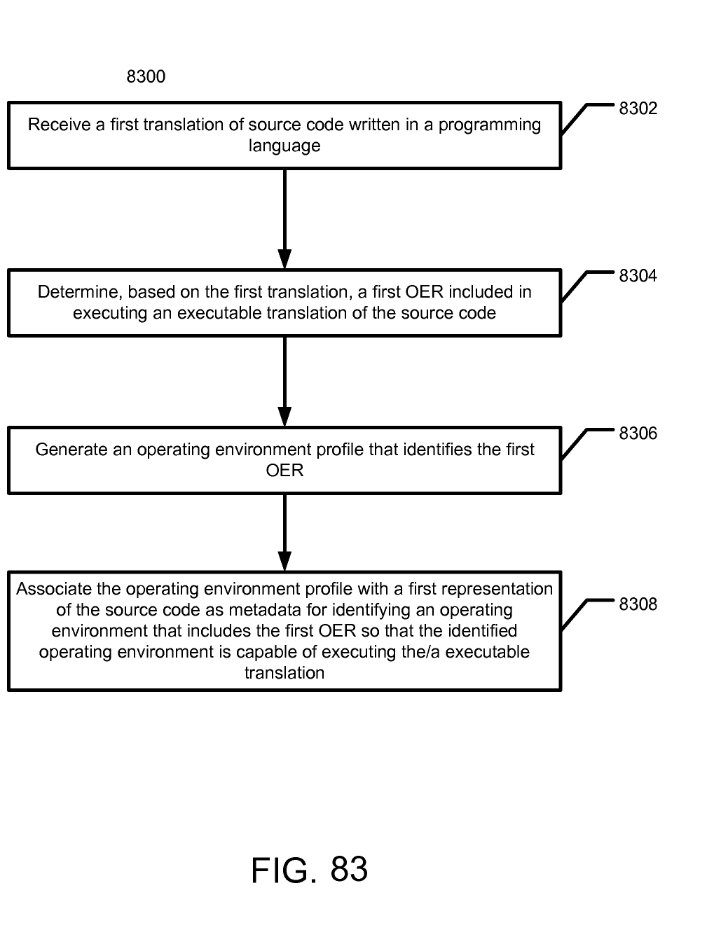

FIG. 83 shows method 8300. Method 8300 includes receiving a first translation of source code written in a programming language. See block 8302. Additionally, method 8300 includes determining, based on the first translation, a first OER included in executing an executable translation of the source code. See block 8304. Also, method 8300 includes generating an OER profile, for an operating environment, that identifies the first OER. See block 8306. Further, method 8300 includes associating the OER profile with a first representation of the source code as metadata for identifying an operating environment that includes the first OER so that the identified operating environment is capable of executing the/an executable translation. See block 8308.

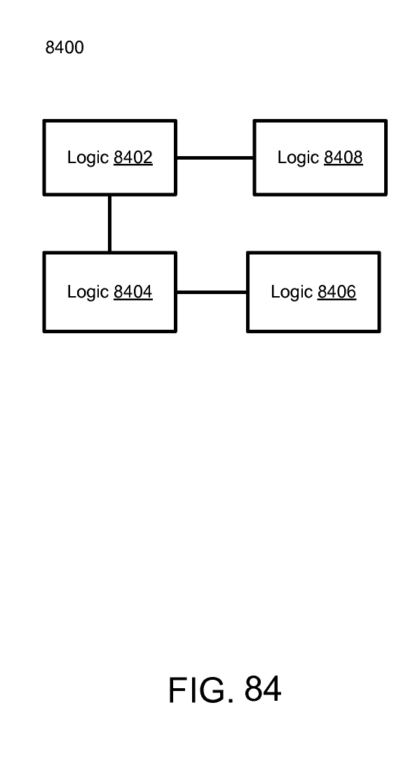

As an option, method 8300 may be implemented based on an arrangement 8400 of logic illustrated in FIG. 84. The arrangement 8400 may include logic 8402 that is included in receiving a first translation of source code written in a programming language. The arrangement may also include logic 8404 that is included in determining, based on the first translation, a first OER included in executing an executable translation of the source code. Additionally, the arrangement 8400 may include logic 8406 that is included in generating an OER profile that identifies the first OER. The arrangement 8400 may further include logic 8408 that is included in associating the OER profile with a first representation of the source code as metadata for identifying an operating environment that includes the first OER so that the identified operating environment is capable of executing the/a executable translation.

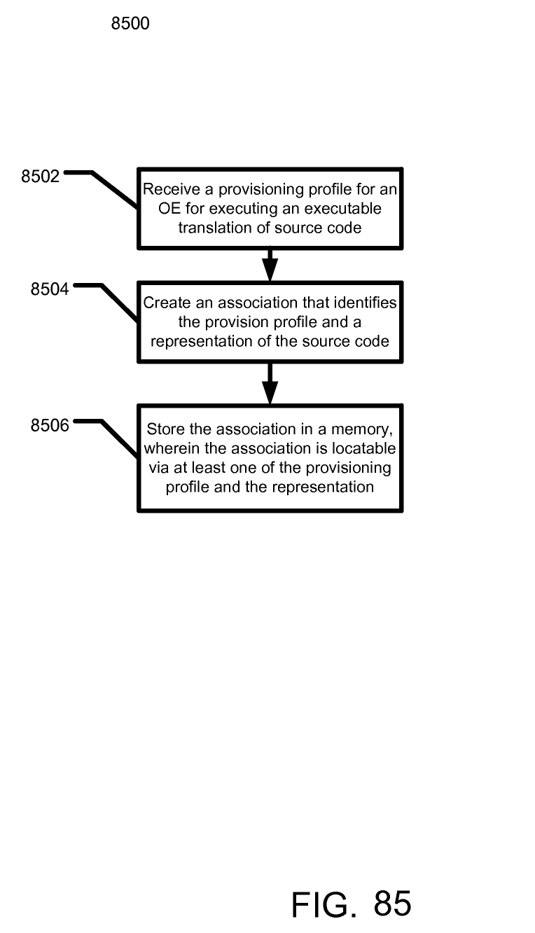

FIG. 85 illustrates one example of a method 8500 that may be performed in performing the method of FIG. 83. The operation in block 8502 may be performed by logic that receives a provisioning profile for an operating environment for executing an executable translation of source code. Block 8504 illustrates an operation that creates an association that identifies the provision profile and a representation of the source code. Logic for creating such an association may be included in a data access component such as data base manager. The operation in block 8506 may be performed by logic that stores, for example, a record and/or an XML element in a memory; such as data base, a processor memory, and/or a flash drive. The record may identify the provisioning profile generated according to the method of FIG. 83 and may identify the representation identified and processed according to the method of FIG. 83. The record may be located by matching either one or both of the identifier of the representation and the identifier of the provisioning profile.

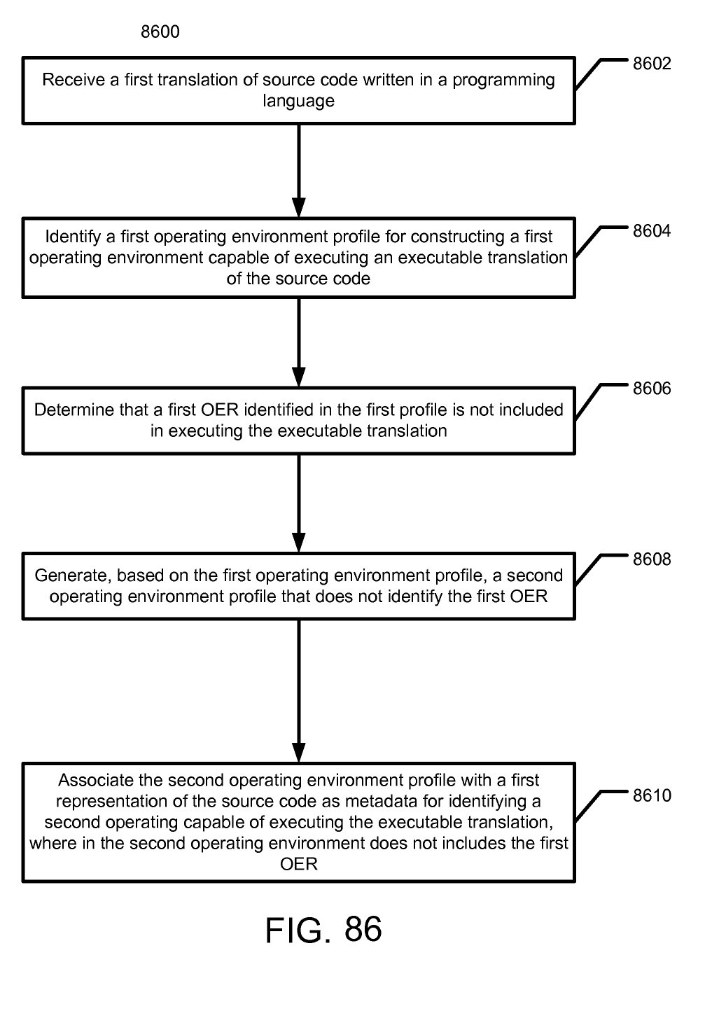

FIG. 86 shows method 8600. Method 8600 includes receiving a first translation of source code written in a programming language. See block 8602. Additionally, method 8600 includes identifying a first OER profile for constructing a first operating environment capable of executing an executable translation of the source code. See block 8604. Also, method 8600 includes determining that a first OER identified in the first profile is not included in executing the executable translation. See block 8606. Further, method 8600 includes generating, based on the first OER profile, a second OER profile that does not identify the first OER. See block 8608. Still further, method 8600 includes associating the second OER profile with a first representation of the source code as metadata for identifying a second operating capable of executing the executable translation, where in the second operating environment does not includes the first OER. See block 8610.

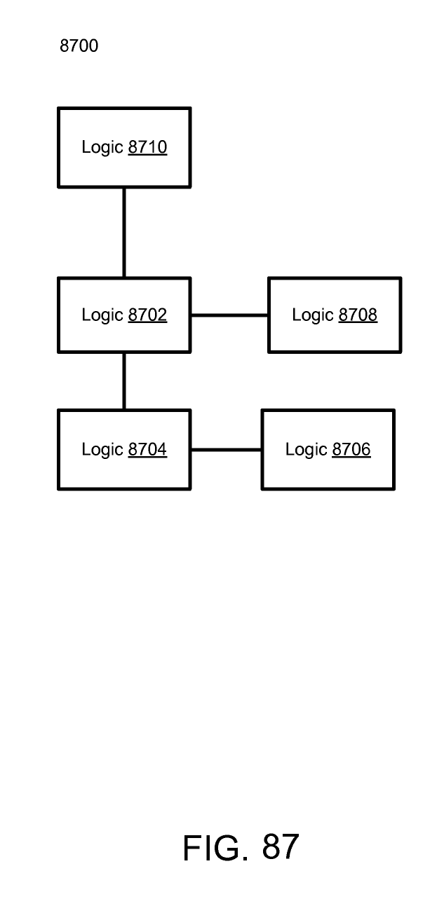

As an option, method 8600 may be implemented based on an arrangement 8700 of logic illustrated in FIG. 87. The arrangement 8700 may include logic 8702 that is included in receiving a first translation of source code written in a programming language. The arrangement 8700 may also include logic 8704 that is included in identifying a first OER profile for constructing a first operating environment capable of executing an executable translation of the source code. Additionally, the arrangement 8700 may include logic 8706 that is included in determining that a first OER identified in the first profile is not included in executing the executable translation. The arrangement 8700 may further include logic 8708 that is included in generating, based on the first OER profile, a second OER profile that does not identify the first OER. Yet further, the arrangement 8700 may include logic 8710 that is included in associating the second OER profile with a first representation of the source code as metadata for identifying a second operating capable of executing the executable translation, where in the second operating environment does not includes the first OER.

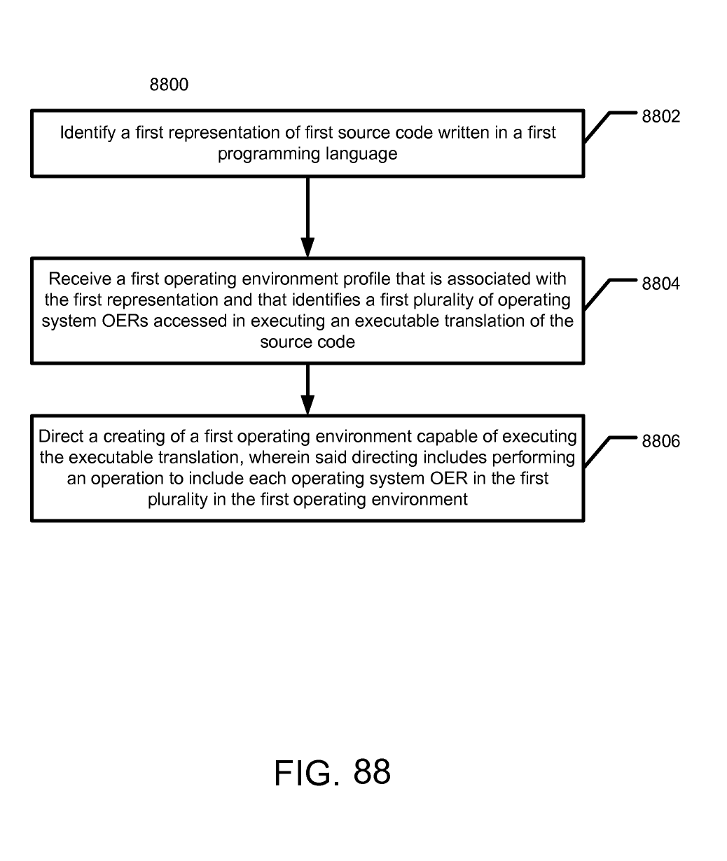

FIG. 88 shows method 8800. Method 8800 includes identifying a first representation of first source code written in a first programming language. See block 8802. Additionally, method 8800 includes identifying a first representation of first source code written in a first programming language. See block 8804. Also, method 8800 includes directing a creating of a first operating environment capable of executing the executable translation, wherein said directing includes performing an operation to include each operating system OER in the first plurality in the first operating environment. See block 8806.

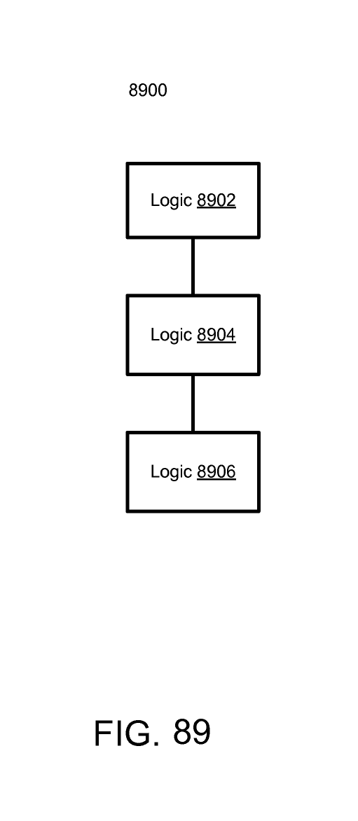

As an option, method 8800 may be implemented based on an arrangement 8900 of logic illustrated in FIG. 89. The arrangement 8900 may include logic 8902 that is included in identifying a first representation of first source code written in a first programming language. The arrangement 8900 may also include logic 8904 that is included in receiving a first OER profile that is associated with the first representation and that identifies a first plurality of operating system OERs accessed in executing an executable translation of the source code. Additionally, the arrangement 8900 may include logic 8906 that is included in directing a creating of a first operating environment capable of executing the executable translation, wherein said directing includes performing an operation to include each operating system OER in the first plurality in the first operating environment.

The subject matter described in the present disclosure may include additional aspects supported by various adaptations and/or analogs of the arrangements of components such as those illustrated in the drawings. For example, performing the methods described in the present disclosure, any extensions, and/or any other aspects may include one or more of, but is not limited to, calling a function or method of an object, sending a message via a network; sending a message via an interprocess communication mechanism such as a pipe, a semaphore, a shared data area, and/or a queue; and/or receiving a request such as poll and responding to invoke, and sending an asynchronous message.

As disclosed in the present disclosure data according to various aspects that is received and/or otherwise identified may be received and/or identified based on a message transmitted via network, data accessed via a communications interface, a detected user input, a user interface element presented for interacting with a user, interoperating with an invocation mechanism, interoperating with an interprocess communication (IPC) mechanism, accessing a register of a hardware component, generating a hardware interrupt, responding to a hardware interrupt, generating a software interrupt, and/or responding to a software interrupt.

An invocation mechanism includes at least one of a function and/or method call utilizing a stack frame; an interprocess communication mechanism, such as a pipe, a semaphore, a shared data area, a hardware interrupt, a software interrupt; a register of a hardware component, such as an IPU register; a hardware bus, and/or a network message, such as an HTTP request and/or an asynchronous message.

In selecting an operating environment from two or more candidate operating environments, one or more of the candidate operating environments may be a virtual operating environment. One of the one or more candidate operating environments may operate in an operating environment that performs the selecting. Two or more candidate operating environments may be operating environments of a same device. Two or more candidate operating environments may each be operating environments of respective separate devices. A selecting operating environment and at least one candidate operating environment may be operating environments of a same device. The selecting operating environment and one or more candidate operating environments may each be operating environments of respective separate devices. Still further a candidate operating environment may include one or more other candidate operating environments. An operating environment may be included in an operating system. An operating environment may include an operating system. A selecting operating environment may operate in a computing process, which may be isolated from other processes in a host operating environment (e. g. a Linux container). It thus, follows, that an operating environment may operate in one or more threads of a computing process.

OERs may include one or more of a hardware component, a software component, and a data component. Exemplary OERs include a processor, a memory, an input device, an output device, a network interface, and a security feature. Two or more operating environments may each be capable of executing an instruction specified in a particular source code module, but may each include different OERs that change an attribute of executing the instruction that relates to one or more of security, performance, reliability, network bandwidth, power utilization, monetary cost, support, test, user monitoring, user interaction, TBD—to name some examples.

The methods describe in the present disclosure may be adapted to generate and/or otherwise select a minimally complete operating environment with respect to one or more other operating environments for a representation of particular source code.

Any of the various methods that included selecting an operating environment for a representation of source code may include identifying, in response to the selecting, an executable translation of the source code to the selected operating environment to execute. The identifying may be direct and/or indirect.

A file or other data object that includes the source code written in a programming language may include other source code written in another programming language.

An executable translation of source code may include a machine code translation of an instruction and/or operation specified in the source code. The machine code translation is executable by an operating environment when the machine code is loaded into a processor memory defined by an address space of a processor in the operating environment. The process may access a machine code instruction in the machine code translation via an address in the processor memory of the machine code instruction. The machine code instruction may be processed by the processor in a computing process created by the operating environment that includes an execution context for processing the machine code instruction. Further, the machine instruction may be processed by the processor in a thread in the computing process. The thread may be created by the operating environment. The thread may provide an execution context for processing the machine code instruction.

Determining that an OER is accessed in executing an instruction and/or operation specified in source code may include finding a reference to the OER, detecting an identifier of the OER in metadata for a representation of the source code, based on a previous executing of an instruction specified in the source code, based on information provided by a user, based on data received from another node, based on a trace log, based on a physical location, based on a power state of an operating environment and/or a power state associated with executing the instruction, based on a security attribute of the operating environment and/or a security attribute associated with executing the instruction, based other software, hardware, and/or data included in the operating environment, and the like. Data processed in determining that an OER is accessed and/or not accessed may be manufacturer data, distributor data, reseller data, service provider data, support data, warranty data, data from another instance of the operating environment, administrative data, and the like.

In various aspects of the subject matter, an OER may be accessed and/or otherwise made accessible for executing an instruction specified in source code and/or otherwise for performing an operation specified in source code based on one or more of an operative coupling, a communicative coupling, a changing of a security attribute, a changing of a power state of a component, a moving of the OER from a location in memory to another location in a memory, receiving the OER via a network, a loading of a code library, a loading of a data library, sending a command, creating the OER or a portion thereof, a translating of data to the OER, a translating from one content type to another content type, preventing another executable from performing an operation, blocking access to an alternative OER, and creating configuration data and/or metadata included in accessing the OER—to name some examples.

An OER may be an addressable entity and/or may include an address entity. An OER may be accessed via an addressable entity. As such, an OER may be and/or may include one or more of a variable, a constant, a function, a subroutine, a procedure, a module, a method, a class, an object, a scoped code block, an instruction identified by a label according to the programming language of the source code, and the like. Alternatively or additionally, determining whether an OER is accessed or not in an executing of an instruction and/or in a performing of an operation specified in source code may be based on locating and/or otherwise identifying an unresolved reference in a representation of the source code and/or based on locating and/or otherwise identifying a symbol in metadata such as a symbol table, a configuration file, and/or provisioning profile, where the metadata is metadata for a representation of the source code. Further still, determining whether an OER is accessed or not in an executing of an instruction and/or in a performing of an operation specified in source code may be based an attribute that includes and/or is included in one or more of a tag, a phrase, a symbol, a symbolic expression, a condition, a logical expression, a mathematical expression, and an annotation included in and/or otherwise associated with a representation of the source code.

Executing an instruction specified in source code and/or performing an operation specified in the source code may include executing, directing, and/or otherwise providing for an allocating an address space of an instruction-processing unit (processor) to define a processor memory, storing a machine code translation of the source code in the processor memory including storing a machine code instruction included in the machine code translation in a location defined by an address in the address space, and/or configuring the processor, based on the address, to access the machine code instruction at the location to execute the machine code instruction.

A representation of source code may include an identifier of the source code, an identifier of a translation of the source code, the source code, a translation of the source code, a device that includes another representation of the source code, a location in a memory that includes another representation of the source code, a provisioning profile for creating an executable translation of the source code in a processor memory, a provisional profile for creating a translation translatable by a loader to an executable translation, configuration data for an installer including install logic to install a copy of the source code and/or a translation of the source code in a persistent memory of an operating environment, a manifest including data included in building at least one of an installable image of a translation of the source code and a device including a stored copy of a translation of the source code, and data valid according to a schema that is associated with processing the data by an instruction specified in the source code.

A representation of an operating environment may include an identifier of the operating environment, a device included in the operating environment, an identifier of a device included in providing the operating environment, an identifier of a host operating environment for the operating environment, a provisioning profile for creating an operating instance of the operating environment, configuration data for an installer including logic to install a copy of the operating environment in a memory device, a manifest including data for building at least one of an installable image of the operating environment and a device including a stored copy of the operating environment, an attribute of the operating environment

According to an aspect of the subject matter of the present disclosure, modifying information may identify a location of a translation of an addressable entity in a translation of source code and/or in the source code. The location may be identified based on a format, a syntax, a grammar, and/or a vocabulary defined by the programming language of the source code and/or the representation language of the translation. Modifying information may identify an attribute of an addressable entity. An attribute may be defined by the programming language of the source code and/or the representation language of the translation. More particularly, the attribute may be an attribute specified by and/or in a “modify indicator” specified to identify modifiable code. In an aspect, an attribute, and thus a modify indicator, may be specified at least in part by a user according to the programming language of the source code and/or the representation language of the translation of the source code. Exemplary attributes include a tag, a phrase, a symbol, a symbolic expression, a condition, a logical expression, a mathematical expression, and/or an annotation.

A language of a translation may define a name space for addressable entity identifiers. A portion of the name space may include identifiers for identifying modifiable addressable entities according to the language. A first translated addressable entity may be identified in a first translation of source code from a portion of a name space defined by the programming language of the source code, where the portion is defined for identifying modifiable addressable entities.

Translating a first translation to a second translation modifying a modifiable addressable entity may include identifying a location, in the first translation, including some or all of a first translation of a modifiable addressable entity, and not translating the some or all of the first translation of the addressable entity in the location to a second translation of the addressable entity. In still another aspect, modifying an addressable entity may include translating an intermediate translation of a first translation that includes an intermediate translation of a modifiable addressable entity. In the aspect, the intermediate translation of the addressable entity may be removed in the translating. Logic may be written to track a location of an addressable entity during translation to a modified translation to modify the translated addressable entity to generate the modified translation.

Modifying an addressable entity may include determining that a modify condition identified by translation configuration information is met based on modifying information for a modifiable addressable entity. In response to determining that the modify condition is met, the addressable entity may be modified from a second translation of source code specified in a programming language. Logic may be generated from source code to evaluate a variety of modify conditions based on various types of modifying information.

Exemplary attributes that a modify condition may be based on include a tag, a phrase, a symbol, a symbolic expression, a condition, a logical expression, a mathematical expression, and/or an annotation. For example, a user may specify a mathematical expression as an attribute of a modify indicator. The expression may include a variable. A value for the variable may be identified in translation configuration information. Given the value, the expression may be evaluated by logic that produces a result. A determination whether to modify an addressable entity or not from a translation may depend on the result.

A modify condition may be based on at least one of translation configuration information and modifying information that includes and/or otherwise identifies a type of an addressable entity. The type may be defined by and/or definable in at least one of a programming language of source code and a first representation language of a first translation of the source code. The type may be included in the translation configuration information and/or the modifying information for matching. A modify condition may include and/or otherwise identify a matching criterion based on a type. A type may be an input for evaluating a matching condition.

A modify condition may be based on at least one of translation configuration information and modifying information that includes and/or otherwise identifies a reserved keyword. The keyword may be defined by and/or definable in at least one of a programming language of source code and a first representation language of a first translation of the source code. The keyword may be included in the translation configuration information and/or the modifying information for matching. A modify condition may include and/or otherwise identify a matching criterion based on a keyword. A keyword may be an input for evaluating a matching condition. A keyword may be reserved by a language and/or may be specified based on information received from a user.

A modify condition may be based on at least one of translation configuration information and modifying information that includes and/or otherwise identifies some or all of an identifier in an identifier space. The identifier space may be defined by and definable in at least one of a programming language of source code and/or a first representation language of a first translation of the source code. The identifier may be included in the translation configuration information and/or the modifying information for matching. A modify condition may include and/or otherwise identify a matching criterion based on an identifier in an identifier space. An identifier in an identifier space may be an input for evaluating a matching condition.

As described above, a first representation language for translating to a second representation language, as well as the second representation language, may include assembler language, an object code language, a byte code language, a high-level programming language, and/or a machine code language. A representation language may include a machine code language and/or may include a language translatable into a machine code language. The second translation may be a machine code translation. Translating the first translation to the second translation may include storing the machine code translation in a processor memory defined by an address space of a processor for executing a machine code instruction in the machine code translation by the processor.

A first translation of source code for translating into a second translation of the source code, as well as the second translation, may include an unresolved symbolic reference for resolving by a linking process, may be relocatable or not, may include position independent code (PIC) or not, and/or may have attributes of translations not generated according to the subject matter described in the present disclosure.

A first translation may include a second addressable entity translated from source code specifying the second addressable entity in a programming language. The second addressable entity may include a reference to a modifiable addressable entity. Modifying the modifiable addressable entity in a modified translation generated from the first translation may include changing, replacing, and/or excluding some or all of the second addressable entity from the second translation.

Alternatively or additionally, the first translation of the modifiable addressable entity may include a reference to another addressable entity. Modifying the addressable entity may include modifying some or all of the other addressable entity. The other addressable entity may be included in another program component.

In a further aspect, an unresolved reference to an addressable entity in the second translation may be detected. The reference may be unresolved as a result of modifying the modifiable addressable entity. The addressable entity for resolving the unresolved reference may be stored in a location in the processor memory identified by a referencing address to resolve the unresolved reference. That is, the referenced addressable entity may be stored in a location it would not have been stored in when the modifiable addressable entity is not modified.

Translating to a translation may include allocating an address space of an instruction-processing unit (processor) in an operating environment to define a processor memory. The translation may be stored in the processor memory by copying and/or mapping the translation into the process memory. Storing the translation may include storing a machine code instruction in the translation in a location in the processor memory defined by an address in the address space. The processor may be configured, for example by an instruction, to access the machine code instruction at the location, based on the address, and to execute the machine code instruction.

As has been described above, generating a translation may include modifying an instruction and/or a data entity represented in the translation in response to modifying an addressable entity. The instruction and/or data entity may be modified in a previous translation prior to translating the modified instruction and/or data entity. The instruction and/or data entity may be modified in the translation.

In various aspects of the subject matter of the present disclosure, a modify indicator may be defined by a programming language and/or may be definable according to the programming language. A modify indicator may include and/or otherwise may identify an attribute that is at least one of defined by the programming language and specified according to the programming language based on information received from a user. The attribute may identify a tag, a phrase, a symbol, a symbolic expression, a condition, a logical expression, a mathematical expression, and/or an annotation.

Modifying an addressable entity may include determining that a modify condition identified by translation configuration information is met based on modifying information. The addressable entity may be modified in response to determining that the modify condition is met. The modify condition may be based on an attribute of the addressable entity. The attribute may be defined by the programming language and/or specified by a user according to the programming language. The attribute may include and/or may be included in a tag, a phrase, a symbol, a symbolic expression, a condition, a logical expression, a mathematical expression, and/or an annotation. Further, the modify condition may include and/or identify a matching criterion based on the attribute.

In various aspects, a modify indicator may be included in a declaration of, a definition of, and/or a reference to an addressable entity. As described the modify indicator may be defined by a programming language and/or may be definable according to the programming language. The code written in the programming language may specify the addressable entity as modifiable in the absence of an indicator indicating otherwise.

Metrics for determining measures of performance cost may be based on power, processor cycles, disks revolutions, time such as access time, monetary costs such leased processing time from a cloud computing provider, noise pollution, light pollution, carbon output (direct and/or indirect), a source of energy for a particular operating environment, battery utilization and/or recharging cost, recycling costs of an OER, a security risk, and/or a privacy requirement—to name just a few examples. Exemplary metrics for measuring a performance cost include metrics for power, monetary metrics, time metrics, kinetic or stored energy metrics, heat metrics, resistance metrics based on mechanical and/or electrical resistance, metrics for measuring various energy and/or power consuming activities and/or operations, light metrics, movement metrics, mass metrics, and weight metrics, and opportunity cost metrics

A performance cost may be determined and/or expressed according to any metric, directly and/or indirectly, that provides an indication of a cost of performing one or more instructions and/or one or more operations specifiable in source code. For example, a performance cost may be expressed as a measure of energy associated with accessing an OER in performing the one or more instructions. The accessing may be via an energy consuming component, such as an electronic component, in an operating environment. A metric for determining a performance cost in terms of electrical power may be determined by monitoring a rate of electrical energy utilized over the time period by a hardware component that is included in accessing an OER in performing the one or more instructions. For example, a flow of electricity to a network interface adapter may be monitored, for OERs where processing the OERs includes sending and/or receiving data via a network. Some of the data may be included in the OERs. The metric may represent the cost, for example, in kilowatt-hours, in transmission time, in bandwidth utilization, in latency, and/or in monetary units. An operating environment may include and/or may otherwise interoperate with a sensor and monitoring logic to determine and/or otherwise identify a measure of performance cost for accessing a particular OER in performing a particular one or more instructions.

A measure of performance cost may be based on a change in at least one of a receiver of energy, in a monetary cost of energy, in an organization providing energy, in a rate of energy utilization, in a utilization time of an energy source, in a user, in a geospatial location, in heat, in light, and/or in a change in a component for at least one of storing, transmitting, and receiving energy. A measure of performance cost may be determined and/or expressed based on any metric, directly and/or indirectly, that provides an indication of a cost associated with executing an instruction and/or an operation specified in source code. A measure of performance cost may be based on a metric for measuring an energy cost in terms of electrical energy. The energy cost may be determined and/or expressed based on at least one of volts, watts, amps, a measure of electrical energy, a measure of stored energy, a measure of mechanical resistance, a measure of electrical resistance, a measure of time, a count of a particular event, a measure of monetary cost, a measure of heat, a measure of light, a measure of distance, a measure of mass, a measure of size, and a measure of weight. A change in an energy source may be based on a change in at least one of a cost of energy, a receiver of energy, a provider of energy, a rate of energy utilization, a period of time, a specified time, a user, a geospatial location, heat, light, and a component for at least one of storing, transmitting, and receiving energy. A performance cost may include and/or otherwise may be based on a cost of generating a machine code translation for a specified operating environment.

A selection criterion may be specified, received, and/or identified based on one or more of a user, a group, a legal entity, a role identifying an access right, a selectable operating environment, a device included in processing the selection criterion, an attribute of a component (hardware and/or software) accessed in performing one or more particular instructions specified in source code, a network, a networking protocol, a specified metric, a particular measure based on the metric, a power provider, a hosting center, an ambient condition, a detected user input, a geospatial attribute, and the operation—to name a few examples.

Whether a selection criterion is met may be based on a cost for accessing an OER included in performing the one or more instructions specified in the source code. A cost may be based on power, environmental impact, safety/health, an addressable entity specified in the source code that specifies the one or more instructions, a measure of at least one of a monetary cost, heat, OER utilization (e.g., memory used, CPU cycles, network bandwidth, threads utilized, semaphores utilized, pipes utilized, sockets utilized, etc.), a measure of time, an employee benefit cost, and a legal liability. Further, a cost may be based on a measure of at least one of a monetary cost, heat, OER utilization (e.g., memory used, CPU cycles, network bandwidth, threads utilized, semaphores utilized, pipes utilized, sockets utilized, etc.), a measure of time, an employee benefit cost, and an associated potential legal liability. A cost may be based on a measure of monetary cost, heat, OER utilization such as memory utilization, CPU cycles, network bandwidth utilization, secondary memory accesses, graphics memory updates, thread utilization, semaphore utilization, pipe utilization, socket utilization, a measure of time, an employee benefit cost, an associated legal liability, and the like. A cost may include a credit and/or a debit. Such a measure may include a count, a plurality of at least one of a discrete value, a range of values, a mean, a mode, a median, and a measure of dispersion, a measure of variance, a maximum, a minimum, a percentage, and a threshold—to name some examples. A performance cost may be and/or may be based on a measure of power quality and/or energy efficiency of one or both of energy consuming OER and an OER operating as an energy source.

A selection criterion may specify a threshold that must be met. Alternatively or additionally, determining whether a selection criterion is met may include determining whether a match exists. Determining whether a match exists may include detecting an exact match, a best match, and/or a partial match. Determining whether a match exists may include determining whether a value is included in a set of acceptable values. In an aspect, more than one operating environment may meet a selection criterion. Selecting one of the operating environments to perform a particular operation may include determining that an operating environment that meets the selection criterion is at least one of a best selection, a random selection, and a next selection based on, for example, a specified order of multiple operating environments that meet the selection criterion.

Examples of attributes that may be accessible in an operating environment for evaluating a selection criterion and/or for determining a performance cost include an error attribute, a cost attribute, a security attribute, a performance attribute, a user attribute, a group attribute, an attribute of a component included in an executing of the one or more instructions (a processor, for example), a geospatial attribute, an ambient condition, a time attribute (date/duration), a count of accesses.

A policy and/or a criterion for selecting an operating environment may be based on at least one of a user, a group, a legal entity, a role identifying an access right, a device hosting at least one selectable operating environment, an attribute of a component of an operating environment included in an executing of the one or more instructions, a network, a networking protocol, a measure of power, a monetary cost, a measure of environmental impact, a safety and/or health measure, a power provider, a hosting center, an ambient condition, a detected user input, a geospatial attribute, a software module, a service provider, and the like. A selection criterion may be based on a cost for accessing an executable translation of the operation specified in source code by an operating environment.

A selection criterion may be evaluated and/or otherwise identified based on electrical energy, money, time, kinetic energy, chemical energy, heat, mechanical resistance, electrical resistance, magnetism, a count of an energy consuming activity, light, movement, mass metric, and/or weight. Selection information identifying a selection criterion may be received from at least one of an accessible OER, an energy consuming component, a user, and a remote node via a network, to name a few sources. Determining that a selection criterion is met may include a comparison based on a performance cost, a calculation based on a performance cost, and an evaluation of an expression based on a performance cost.

A cost and/or data for determining a cost may be determined and/or otherwise may be detected for an operating environment by including monitoring logic that collects data. The data may be included in determining one more performance costs based on one or more metrics. For example an operating environment may include processor monitoring logic that is included in determining and/or otherwise detecting a performance cost for performing an operation specified in source code. For example, a performance cost for accessing an OER may be determined. Exemplary OERs accessible via a processor in an operating environment include a machine code instruction and a data item for processing by one or more machine code instructions translated from the source code. An access with respect to processor may be defined to include a read of a processor memory location, a write to a processor memory location, and/or a processing of an instruction loaded into processor. Various types of accesses may be defined more particularly by distinguishing accesses that include processor cache hits and/or misses, page table hits and/or misses, and/or context switches. Detecting a performance cost may include determining and/or otherwise identifying a statistical measure of energy and/or time based on a number of accesses of one or more types of OERs.

An operating environment may also include cache cost monitoring logic that is included in detecting a performance cost for accessing an OER included in a cache in performing the one or more instructions specified in the source code. Exemplary caches include a processor cache, a data base cache, a file system cache, and/or a browser cache. A performance cost metric may be defined in terms of operations performed by the cache. An OER may be defined in terms of data and/or services accessible via the cache. One or more measures of performance cost may be determined for accessing a cache and/or for accessing an OER via a cache in performing the one or more instructions in source code in source code represented for processing.

In another example, an operating environment may also include hard drive cost monitoring logic that is executed in detecting a performance cost for accessing a data entity and/or service via a hard-drive component providing at least a portion of persistent secondary storage. Other types of data storage devices supporting persistent data storage media may be monitored in other aspects and adaptations of cost monitoring logic. As with a processor and a cache, an access, of an OER via a data storage device such as a hard drive, may be defined based on one or more operations performed by the data storage device and/or may be defined based on one or more operations performed by components interoperating with the data storage device. An OER may be defined in terms of data and/or services accessible via the data storage device. One or more measures of performance cost may be determined for an access to an OER included in and/or otherwise accessible via a data storage device.

In still another example, an operating environment may also include registry cost monitoring logic included in detecting a performance cost for accessing an OER included in a registry such as an operating system registry for storing configuration data and/or a lightweight directory access protocol (LDAP) registry for storing various types of information including address book entries, digital certificates, and/or user identifiers. Other exemplary registries include domain name system (DNS) databases and universal description discovery and integration (UDDI) registries. Again, an access is defined in terms of operations performed by the registry and/or in terms of operations performed by components interoperating with the registry. OERs may be defined in terms of data and/or services accessible via a registry. One or more measures of a performance cost may be determined.

In yet another example, an operating environment may also include a browser cost monitoring logic that is executed in detecting a performance cost for performing one or more instructions specified in source code represented. A browser may access OERs via a variety of energy consuming components in an operating environment performing the instructions in an operating environment in or provided by a browser as well as OERs accessed in executing the one or more instructions via components in nodes in other operating environments. Browser cost monitoring logic may interoperate with other cost monitoring logic directly and/or indirectly in detecting a performance cost of performing the one or more instructions specified in the source code.

Cost monitoring logic may be provided for an output component such as a display device, an input component such as a keyboard, and/or a network component such as a network interface component. A particular metric for determining a performance cost for executing an instruction that accesses an OER may be selected and/or otherwise identified based on one or more attributes of an OER, an instruction included in accessing the OER, a program component for performing some or all of the instruction, a hardware component accessed in executing the instruction, a user, an organization, and/or a task—to name a few examples. For example, a performance cost may be measured by counting occurrences of an energy consuming activity, such as disk read operations. From another perspective a metric based on disk reads may be a direct measure of a utilization cost resulting from processing one or more OERs stored in a hard drive

A metric such as a count of machine code instructions executed by a processor may be specified and/or determined for executing a particular instruction. A processor based metric may be selected for measuring a performance cost for accessing an OER stored in a physical processor memory. In another aspect, in executing an instructions an application or process may access an OER in a display device to present a user interface to a user. A metric for measuring heat and/or light generated by the display device in accessing the OER may be specified. The display device OER may include a data storage component, a screen, and/or a light emitting component.

Cost monitoring logic, in an aspect, may determine and/or otherwise may detect a performance cost based on metadata provided in and/or with source code, a translation of the source code, an OER, a program component accessed in performing an instruction specified in source code, and/or a hardware component included in performing the instruction. A performance cost may be predetermined and located by cost monitoring logic in and/or associated with one or more instructions specified in source code, an OER, a program component, and/or a hardware component. Cost monitoring logic may access a table and/or other structure including predefined values for measures of performance costs according to one or more metrics such as a temperature based metric for measuring a change in temperature of a hardware component and/or for measures of a time based performance costs represented in US dollars.

Cost monitoring logic may look up and/or may otherwise identify a predefined value for a performance cost for an instruction translated from source code for a type of OER, a size of an OER, a power source, a hardware component, and/or a program component included in performing the one or more instructions specified in source code. The predefined value may be a performance cost and/or may be an input for determining a performance cost expressed according to an identified metric. For example, a predefined value may be multiplied by a measure of time that an OER is accessed. In an aspect the measure may be based on an access by a program component, via an energy consuming component, in executing the one or more instructions, to produce a time based metric such as kilowatt-hours or disk reads per minute. In another aspect, cost monitoring logic may determine a performance cost by calculating a measure of cost according to the specified metric and/or may interoperate with a sensor, such as a thermometer, in measuring a cost of, for example, accessing an OER in performing one more instructions specified in source code. Cost monitoring logic may include and/or otherwise may access one or more measurement components in determining a performance cost according to one or more metrics.

A cost monitoring logic may operate in an application. The cost monitoring logic may determine a performance cost for OERs accessed by the application in executing one more instructions. The application may be a program component or may include more than one program components. The OERs may include OERs provided by the application to other applications, subsystems, and/or components operating in an operating environment executing an instruction and/or an operation specified in source code. Alternatively or additionally, one more OERs may be provided by and/or otherwise accessed via another operating environment included in and/or otherwise provided by one or more devices.

In an example, an application may process an image and/or a video to present as a desktop background. Cost monitoring logic may determine a performance cost for executing one more instructions where the executing includes accessing an OER included in a display device to present the image and/or the video via the display. For example, cost monitoring logic may be configured with and/or otherwise may determine a measure based on a count of display refreshes over a specified period of time to determine a performance cost for accessing an OER in the display to present the image and/or the video.

One or more OERs, accessed in executing instructions, translated from source code, in an operating environment of a node, may include data stored by another node. Cost monitoring logic may determine a performance cost for transmitting a request for receiving the data and/or for receiving some or all of the data in a message from the other node via a network adapter in the operating environment hosting the application. For example, cost monitoring logic may be configured with and/or otherwise may determine a measure based on a count of bytes in an OER and/or in an encoded translation of the OER exchanged via the network.

Cost monitoring logic may measure and/or otherwise detect one or more performance costs based on one or more specified metrics. A performance metric for executing instructions translated from source code may be an energy metric associated with accessing a database table and/or an OER in a database table may be based on a measure of network latency, a lease cost for a network connection, a count of bytes and/or bits communicated, a power cost for operating network interface adapter, and/or a cost for encoding and/or decoding data for communicating via the network, to name a few examples.

Cost monitoring logic may detect information for determining a performance cost for processing one or more instructions translated from source code that accesses an OER one time and/or may detect multiple costs over a time period. For example, cost monitoring logic may determine a count of instances and/or one or more durations of time in which a voltage level and/or amperage level meets a specified threshold condition. The determined information may be a measure of power quality and/or energy efficiency of one or both of energy consuming component and energy source. A performance cost may be measured based on power quality and/or energy efficiency.

Cost monitoring logic may operate in and/or may otherwise interoperate with a network application agent such as a web page and/or script in a browser. A network application agent may be received by a browser included in an application operating in user node. The network application agent may be received by a user node from a network application operating in an application provider node. Cost monitoring logic and/or an analog may operate in the application provider node operating in the network application, such as a web service. Alternatively or additionally, other cost monitoring logic may operate in the network application agent in the browser in the user node. One or both of the instances of cost monitoring logic may separately or cooperatively determine a performance cost. The performance cost may be determined, for example, for an OER accessed by the network application and/or the network application agent. One or both of the instances of cost monitoring logic may be components in a cost monitor system distributed between the network application agent and the network application. OERs may include OERs provided by the network application agent to the browser and/or extensions of the browser. The OERs may further include OERs provided to other nodes in network by the network application agent and/or the network application.

Cost monitoring logic operating in user node and cost monitoring logic operating in application provider node may determine a performance cost for performing an operation that includes accessing one or more OERs accessed via network. Transmitting OER data may include encoding, decoding, filtering, translating, and/or transforming some or all of the data in an OER. One or more energy consuming components may be included in accessing the OER. For example, an OER may be compressed prior to transmitting via network. The cost monitoring logic operating in the browser may be configured to determine a metric based on a type of physical layer network included in a network; based on an encoding, decoding, and/or other transformation; based on a manufacturer and/or type of network interface component; and/or based on network throughput data and/or on other network attributes and/or metadata. The measure may be a performance cost for transmitting a web document via a network via a modem, a performance cost for retrieving image data in the document from a hard drive, a performance cost for decoding data received via the network, and/or a performance cost for transmitting data over a secure network connection. One or both of the instances of cost monitoring logic may be configured with and/or otherwise configured to identify a predefined performance cost according to a metric selected by a developer of the browser and/or the network application.

Network cost monitoring logic may measure and/or otherwise may detect one or more performance costs based on one or more specified metrics. An performance metric associated with accessing the database table and/or an OER in the database table may be based on a measure of network latency, a lease cost for a network connection, a count of bytes and/or bits communicated, a power cost for operating network interface adapter, and/or a cost for encoding and/or decoding data for communicating via the network, to name a few examples.

A performance cost may be measured according to a time based metric. Logic that measures and/or otherwise detects idle time periods may be included in an operating environment. Such logic may detect periods measured based on various types of time metrics and may interoperate with various components for measuring time. Time may be measured in regular increments as is typical, but may also be measured by the occurrence of events that may be irregular over a given period as compared to time measured by a processor clock. For example, time may be measured in instructions executed by a processor, input events detected by one or more user input devices, and/or bytes received via from one or more network applications and/or from one or more data storage media. Various adaptations and analogs of idle monitoring logic and/or hardware may detect and/or identify an idle period based on an absolute measure of time. For example a period may be detected based on a timer expiration of a timer set with a specified duration in milliseconds, seconds, minutes, hours, days, and/or weeks. Alternatively or additionally, a period may be detected based on a relative measure of time, for example by counting and comparing events that occur in time for one addressable entity with events associated with another entity (addressable or not).

Source code representations may be associated with other metadata, as described above, in addition to and/or instead of a symbol table. For example, a hardware profile for a device that provides and/or otherwise may be included in an operating environment may identifier hardware OERs and software OERs such as drivers and/or firmware such as BIOS logic. Software OERs, data OERs, and/or hardware OERs may be identified by a provisioning profile for an operating environment or a portion thereof. Logic may be included in an OER detector to parse and/or direct processing of such metadata to identify an OER included in executing a translation of an instruction specified in source code. The source code and/or the translation may be associated with one or more profiles that describe and/or otherwise identify OERs or attributes of OERs accessed in performing instructions specified in the source code by executing a translation of the instructions. For example, an output profile such as a color space profile may identify one or more attributes of an output device, an input profile that describes attributes of one or more input devices, a network profile may identify a type of network interface and/or a protocol.

Data identifying OER(s) in an operating environment may be accessed from operating system provisioning profiles and/or virtual machine profiles known to those skilled in the art for installing and configuring operating system images such as in a cloud computing environment. Logic may be generated from source code written to identify metadata associated for example with a script or an object code file translated from source code by a compiler. The logic may operate to validate the metadata and provide information based on the metadata to an operating environment. Logic may be generated from source code written to identify operating system OERs that are required and/or optional for a particular translation of source code. Such logic may interoperate with other logic that matches an operating environment with a representation of source code based on one or more OERs required or optionally accessed in performing one more instructions specified in the source code.

One or more of a first measure of cost for performing at least one instruction specified in the source code by a first operating environment may be determined and a second measure of cost for performing the at least one instruction by a second operating environment may be determined. In response to identifying the representation of the source code, a determination may be made that an instance of a first OER included in an executing of an executable translation of the source code is accessible in a first operating environment and that no instance of the first OER is accessible in a second operating environment. Moreover, in response to identifying the representation, a determination may be made that an instance of a first OER is accessed by a first operating environment to perform a first instruction specified in the first source code and that no instance of the first OER is accessed by a second operating environment to perform the first instruction

Selecting an operating environment according to the methods described in the present disclosure may include categorizing and/or ranking the operating environments. An operating environment may be selected from a group of operating environments based on the ranking and/or categorization. In another aspect, in response to selecting an operating environment, a translation of the source code may be identified to the selected operating environment to execute an instruction and/or operation specified in the source code.

I claim:

1. A method comprising:
identifying a first representation of first source code written in a first programming language;
determining at least one of a first measure of cost for performing at least one instruction specified in the first source code by a first operating environment and a second measure of cost for performing the at least one instruction by a second operating environment; and
selecting, based on at least one of the first measure and the second measure, one of the first operating environment and the second operating environment to perform the at least one instruction,
wherein performing at least one of the preceding actions comprising the method includes execution of an instruction by a processor.

2. The method of claim 1 wherein at least one of the first measure of cost and the second measure of cost is includes and/or is otherwise based on at least one of a monetary measure, a measure of energy, a measure of heat, an operate environment resource (OER) utilization measure, a measure of time a measure of an employee benefit cost, an estimate of an associated liability, a measure of input received, a measure of input repetition, an employee benefit costs, a legal liability costs, a distribution costs, marketing costs, a sales costs, rental costs, an environmental costs, an access to an OER, a specified period, an average, a median, a mean, a mode, a metric of variance, a metric of fit, a metric of dispersion, a metric of entropy, a metric of probability, a metric of significance, a time, power, a network protocol, a data transmission medium, a data storage medium, a data storage schema, an encryption mechanism, a metric of safety, a user, a group, a/role, an addressable entity, at least one of the first operating environment and the second operating environment, a hardware component a software component, a price, a measure of power, a provider of at least one of the first operating environment and the second operating environment, a provider of at least one of the first translation and the source code, reliability, trust, credit worthiness, geospatial location of at least one of the first and second operating environment, a power provider, a hosting center, leaser of device, a measure of OER utilization, memory utilization, CPU cycles, network bandwidth utilization, secondary memory accesses, graphics memory updates, thread utilization, semaphore utilization, pipe utilization, socket utilization, a measure of time, an employee benefit cost, an associated potential legal liability, a user, a group, a legal entity, a role identifying an access right, a device hosting at least one of the first operating environment and the second operating environment, an addressable entity specified in the first source code, an attribute of a component included in at least one of the first operating environment and the second operating environment, an reference to an addressable entity external to the source code and translations thereof, a network, a networking protocol, a power provider, a hosting center, an ambient condition, a detected user input, a geospatial attribute, an addressable entity that accesses an addressable entity in an executable translation of the first source code, a service provider,

3. The method of claim 1 wherein at least one of the first measure and the second measure includes at least one of a credit and a debit.

4. The method of claim 1 wherein the determining includes sending a request via a network, receiving an asynchronous message, establishing a subscription, receiving sensor data, receiving data identifying a metric, receiving a measure, and determining a measure based on a metric.

5. The method of claim 1 wherein at least one of the first measure and the second measure is based on at least one of a first OER Set for an executable translation, of the source code, that is executable by the first operating environment and a second OER Set for an executable translation of the source code executable by the second operating environment.

6. The method of claim 1 wherein at least one of the first measure and the second measure is based on at least one of a first OER Container for an executable translation of the source code executable by the first operating environment and a second OER Container for an executable translation of the source code executable by the second operating environment.
